(19) United States
(12) Patent Application Publication
(10) Pub. No.: US 2015/0149523 A1
(43) Pub. Date: May 28, 2015

(54) NETWORK SYSTEM, CONSTANT CONNECTION METHOD, COMMUNICATION METHOD,ELECTRONIC DEVICE, CONSTANT CONNECTION SERVER, APPLICATION SERVER, AND PROGRAM

(71) Applicant: SHARP KABUSHIKI KAISHA, Osaka (JP)

(72) Inventors: Tomoyuki NAKAMURA, Osaka (JP); Hitoshi NISHIKAWA, Osaka (JP); Hirofumi FURUKAWA, Osaka (JP); Akira TOJIMA, Osaka (JP); Kayo MORINAGA, Osaka (JP)

(21) Appl. No.: 14/555,652

(22) Filed: Nov. 27, 2014

(30) Foreign Application Priority Data
Nov. 27, 2013 (JP) 2013-244543
Nov. 27, 2013 (JP) 2013-244548

(51) Int. Cl. H04L 29/08

(52) U.S. Cl. CPC H04L 67/26; H04L 67/12
USPC 709/201

(57) ABSTRACT

A network system is provided that includes a plurality of electronic devices that becomes associated with identification information; a constant connection server that makes a constant connection with the plurality of electronic devices; and an application server that pushes information to any of the plurality of electronic devices via the constant connection server on the basis of the identification information. Alternatively, a network system is provided that includes a plurality of electronic devices; and a constant connection server that makes a constant connection with the plurality of electronic devices. The constant connection server stores an association between constant connection IDs for specifying the plurality of electronic devices and group IDs for specifying a plurality of groups, and pushes data to at least one of the plurality of electronic devices belonging to a group associated with a group ID being designated.

### BACKGROUND OF THE INVENTION

1. Field of the Invention

The present invention relates to techniques for the constant connection of electronic devices, particularly to a network system for the constant connection of client and server, a constant connection method, an electronic device, a constant connection server, an application server, and a program.

Alternatively, the present invention relates to techniques for the constant connection of electronic devices, particularly to communication techniques that involve constant connections between a server and a plurality of clients.

2. Description of the Related Art

Various techniques for mutually sending data between communications devices are known. For example, JP-A-2010-277492 (Patent Literature 1) discloses an electronic conference server and computer programs. This disclosure is intended to provide real-time processing for an electronic conference system running on web applications, and to manage unsolved problems associated with the operation of an electronic conference system, among others. Specifically, an application server controls a Comet server so that the Comet server remains on hold even with an HTTP request sent from electronic devices. Upon receiving message data from any of the electronic devices, the application server retrieves the necessary data from a conference database, and sends the data to the electronic device of interest via the Comet server, together with the message data. After the data transmission, the application server puts the Comet server on hold again for any incoming HTTP request from electronic devices.

JP-A-2007-157085 (Patent Literature 2) discloses an SIP server sharing module, an SIP message relay system, and programs. According to this disclosure, a message sending group identification unit intercepts the SIP message sent from a terminal, and identifies the client group to which the sender terminal belongs. A group tag associated with the group identified by the message sending group identification unit is inserted into the SIP message by a group tag inserting unit. A group tag deleting unit deletes a group tag from the server transmission SIP message sent from an SIP proxy server. A message receiving group identification unit identifies the client group associated with the group tag deleted by the group tag deleting unit, preventing the server transmission SIP message from being sent to a client terminal not belonging to the group.

However, because Comet requires a new HTTP session for each communication, the same data needs to be exchanged multiple times between client and server. The WebSocket technology, a protocol that runs on TCP (Transmission Control Protocol), has been developed to allow data to be pushed back and forth between communications devices. WebSocket was standardized by internet standards organizations W3C and IETF as a bidirectional communication protocol for web server and web browser. The specification of the WebSocket protocol is described in RFC (Request For Comment) 6455.

However, as it currently stands, a constant connection using the WebSocket protocol involves multicasting of data from a server to a plurality of clients in a constant connection. That is, it has been difficult to push data from a server to a selected client. In other words, in sending data to clients using the current constant connection technology, a server sends data to all the clients that are in a constant connection.

### SUMMARY OF INVENTION

The present invention has been made to provide solutions to the foregoing problems, and the invention, in relation to the constant connection technology, is intended to provide a network system that enables pushing data from a server to a selected client. The invention is also intended to provide a constant connection method, an electronic device, a constant connection server, an application server, and a program.

Alternatively, the present invention is intended to provide a network system that enables pushing data to a designated client from among the clients that are in a constant connection. The invention is also intended to provide a communication method, an electronic device, a constant connection server, and a program.

According to some aspects of the invention, there is provided a network system that includes:

a plurality of electronic devices that becomes associated with identification information;

a constant connection server that makes a constant connection with the plurality of electronic devices; and

an application server that pushes information to any of the plurality of electronic devices via the constant connection server on the basis of the identification information.

As used herein, “constant connection server” is a concept encompassing both hardware as a computer, and software as a service program. Likewise, the term “application server” as used herein is a concept encompassing both hardware as a computer, and software as a service program.

Preferably, the constant connection server is installed in a first computer, and the application server is installed in a second computer.

Preferably, the constant connection server and the application server are installed in one computer.

Preferably, each of the plurality of electronic devices and the constant connection server upon opening a constant connection exchange the identification information by using a protocol that permits a constant connection.

Preferably, the application server issues authentication information to any of the plurality of electronic devices and to the constant connection server, and the constant connection server issues the identification information to the application server and to the any of the plurality of electronic devices on the basis of the authentication information from the application server and the authentication information from the any of the plurality of electronic devices.

Preferably, the network system includes a plurality of application servers as the application server, and each of the plurality of application servers pushes information to any of the plurality of electronic devices via the constant connection server by using the identification information.

Preferably, the constant connection server sends main data and a transaction ID to any of the plurality of electronic devices, the any of the plurality of electronic devices sends the transaction ID to the constant connection server upon receiving the main data, and the constant connection server notifies the application server of the completion of the data transmission to the any of the plurality of electronic devices on the basis of the transaction ID from the any of the plurality of electronic devices.

Preferably, any of the plurality of electronic devices sends main data and a transaction ID to the constant connection server, the constant connection server sends the transaction ID to the any of the plurality of electronic devices upon receiving the main data, and the constant connection server notifies the application server of the completion of the data reception from the any of the plurality of electronic devices on the basis of the transaction ID from the any of the plurality of electronic devices.

According to another aspect of the present invention, there is provided a constant connection method that includes:

opening a constant connection between a plurality of electronic devices and a constant connection server;

associating the plurality of electronic devices with identification information; and

pushing information from an application server to any of the plurality of electronic devices via the constant connection server on the basis of the identification information.

According to another aspect of the present invention, there is provided an electronic device that includes:

a memory that stores identification information;

a communication interface provided to constantly connect to a constant connection server; and

a processor that, by using the communication interface, receives information from an application server via the constant connection server on the basis of the identification information.

According to another aspect of the present invention, there is provided a constant connection server that includes:

a memory that stores identification information associated with a plurality of electronic devices;

a communication interface provided to constantly connect to the plurality of electronic devices and communicate with an application server; and

a processor that, by using the communication interface, pushes information from the application server to any of the plurality of electronic devices on the basis of the identification information.

According to another aspect of the present invention, there is provided an application server that includes:

a memory that stores identification information associated with a plurality of electronic devices;

a communication interface provided to communicate with a constant connection server; and

a processor that, by using the communication interface, pushes information to any of the plurality of electronic devices via the constant connection server on the basis of the identification information.

According to another aspect of the present invention, there is provided a program for use in an electronic device that includes a processor, a memory, and a communication interface. The program causes the processor to perform:

opening a constant connection with a constant connection server via the communication interface;

storing identification information in the memory; and

receiving information from an application server via the constant connection server using the communication interface on the basis of the identification information.

According to another aspect of the present invention, there is provided a program for use in a computer that includes a processor, a memory, and a communication interface. The program causes the processor to perform:

opening a constant connection with a plurality of electronic devices using the communication interface;

storing in the memory identification information associated with the plurality of electronic devices; and

pushing information from an application server to any of the plurality of electronic devices using the communication interface on the basis of the identification information.

According to another aspect of the present invention, there is provided a program for use in a computer that includes a processor, a memory, and a communication interface. The program causes the processor to perform:

storing in the memory identification information associated with the plurality of electronic devices; and

pushing information to any of the plurality of electronic devices via a constant connection server using the communication interface on the basis of the identification information.

As described above, the invention, in relation to the constant connection technology, is intended to provide a network system that enables pushing data from a server to a selected client. The invention is also intended to provide a constant connection method, an electronic device, a constant connection server, an application server, and a program.

According to another aspect of the present invention, there is provided a network system that includes:

a plurality of electronic devices; and

a constant connection server that makes a constant connection with the plurality of electronic devices.

The constant connection server stores an association between constant connection IDs for specifying the plurality of electronic devices and group IDs for specifying a plurality of groups, and pushes data to at least one of the electronic devices belonging to a group associated with a group ID being designated.

Preferably, the association includes the groups in a hierarchy, and the constant connection server pushes data to the electronic devices belonging to a lower group that belongs to an upper group specified by a group ID being designated.

Preferably, any of the plurality of electronic devices sends a group joining request to the constant connection server, and the constant connection server in response to the group joining request adds to the association a combination of the group ID and the constant connection ID associated with the any of the plurality of electronic devices.

Preferably, the network system further includes an electronic device different from the plurality of electronic devices, the electronic device sends information for specifying the electronic device, and a group joining request to the constant connection server, and the constant connection server in response to the information and the group joining request adds to the association a combination of the group ID and the constant connection ID associated with the electronic device.

Preferably, any of the plurality of electronic devices sends a request for removal from group to the constant connection server, and the constant connection server in response to the request for removal from group deletes from the association a combination of the group ID and the constant connection ID associated with the any of the plurality of electronic devices.

Preferably, the network system further includes an electronic device different from the plurality of electronic devices, the electronic device sends information for specifying the electronic device, and a request for removal from group to the constant connection server, and the constant connection server in response to the information and the request for removal from group deletes from the association a combination of the group ID and the constant connection ID associated with the electronic device.

Preferably, any of the plurality of electronic devices sends the group ID and the data to the constant connection server, and the constant connection server pushes the data to at least one of the plurality of electronic devices associated with the group ID.

Preferably, the network system further includes an application server, the application server sends the group ID and the data to the constant connection server, and the constant connection server pushes the data to at least one of the plurality of electronic devices associated with the group ID.

Preferably, the constant connection server upon receiving the group ID and the data notifies the sender of the data of the receipt of a push instruction before pushing the data to the at least one of the plurality of electronic devices.

Preferably, the constant connection server sends a transmission result of the data to the sender of the data after pushing the data to all of at least one of the plurality of electronic devices associated with the group ID.

Preferably, the transmission result contains a list representing the success or failure of the pushing of the data with regard to all of at least one of the plurality of electronic devices associated with the group ID.

Preferably, the transmission result contains a success rate of the pushing of the data to at least one of the plurality of electronic devices associated with the group ID.

Preferably, the constant connection server sends a transmission result of the data to the sender of the data every time the data is pushed to each of at least one of the plurality of electronic devices associated with the group ID.

Preferably, the constant connection server accumulates the transmission result as an externally accessible reference.

Preferably, the constant connection server upon receiving a data push instruction accumulates the instruction as an externally accessible reference.

According to another aspect of the present invention, there is provided a communication method that includes:

opening a constant connection between a plurality of electronic devices and a constant connection server;

storing an association between constant connection IDs for specifying the plurality of electronic devices and group IDs for specifying a plurality of groups in the constant connection server; and

pushing data from the constant connection server to at least one of the plurality of electronic devices belonging to a group associated with a group ID being designated.

According to another aspect of the present invention, there is provided an electronic device that includes:

a communication interface; and

a processor that makes a constant connection with the constant connection server, and sends a group joining request to the constant connection server with the communication interface.

According to another aspect of the present invention, there is provided a constant connection server that includes:

a communication interface provided to constantly connect to a plurality of electronic devices;

a memory that stores an association between constant connection IDs for specifying the plurality of electronic devices and group IDs for specifying a plurality of groups; and

a processor that, by using the communication interface, pushes data to at least one of the plurality of electronic devices belonging to a group associated with a group ID being designated.

According to another aspect of the present invention, there is provided a program for use in an electronic device that includes a processor, a memory, and a communication interface. The program causes the processor to perform:

opening a constant connection with a constant connection server via the communication interface; and

sending a group joining request to the constant connection server with the communication interface.

According to another aspect of the present invention, there is provided a program for use in a computer that includes a processor, a memory, and a communication interface. The program causes the processor to perform:

opening a constant connection with a plurality of electronic devices with the communication interface;

storing in the memory an association between constant connection IDs for specifying the plurality of electronic devices and groups IDs for specifying a plurality of groups; and

pushing data with the communication interface to at least one of the plurality of electronic devices belonging to a group associated with a group ID being designated.

As described above, the invention is intended to provide a network system that enables pushing data to a designated client from among the clients that are in a constant connection. The invention is also intended to provide a communication method, an electronic device, a constant connection server, and a program.

Additional features and advantages of the present disclosure will be set forth in the following detailed description. Alternatively, additional features and advantages will be readily apparent to those skilled in the art from the content of the detailed description or recognized by practicing the subject matter as described herein, including the detailed description, the claims, and the appended drawings. It is to be understood that the foregoing general description concerning the related art and the following detailed description are provided solely for illustrative purposes, and are intended to provide an overview or framework for understanding the nature and character of the inventions as claimed.

### BRIEF DESCRIPTION OF THE DRAWINGS

FIG. 1 is a schematic diagram representing the overall configuration of the network system 1 according to an embodiment.

FIG. 2 is a first schematic diagram briefly representing the operation of opening a constant connection in the network system 1 according to the embodiment.

FIG. 3 is a second schematic diagram briefly representing the operation of opening a constant connection in the network system 1 according to the embodiment.

FIG. 4 is a schematic diagram briefly representing the operation of checking a connection from application server 300 in the network system 1 according to the embodiment.

FIG. 5 is a schematic diagram briefly representing the operation of checking a connection from client 100 in the network system 1 according to the embodiment.

FIG. 6 is a schematic diagram briefly representing the normal information pushing operation from application server 300 in the network system 1 according to the embodiment.

FIG. 7 is a schematic diagram briefly representing the large volume information pushing operation from application server 300 in the network system 1 according to the embodiment.

FIG. 8 is a schematic diagram briefly representing the normal information pushing operation from client 100 in the network system 1 according to the embodiment.

FIG. 9 is a schematic diagram briefly representing the large volume information pushing operation from client 100 in the network system 1 according to the embodiment.

FIG. 10 is a block diagram representing the overall communication configuration of the network system 1 according to the embodiment.

FIG. 11 is a block diagram representing the hardware configuration of client 100 according to the embodiment.

FIG. 12 is a block diagram representing the hardware configuration of constant connection server 200 according to the embodiment.

FIG. 13 is a block diagram representing the hardware configuration of application server 300 according to the embodiment.

FIG. 14 is a block diagram representing the hardware configuration of smartphone 500 according to the embodiment.

FIG. 15 is a sequence diagram representing the data exchange procedures between devices concerning a constant connection in the network system 1 according to the embodiment.

FIG. 16 is a sequence diagram representing details of the procedures for opening a constant connection in the network system 1 according to the embodiment.

FIG. 17 is a sequence diagram representing details of the procedures for closing a constant connection from a client in the network system 1 according to the embodiment.

FIG. 18 is a sequence diagram representing details of the procedures for closing a constant connection from application server 300 in the network system 1 according to the embodiment.

FIG. 19 is a sequence diagram representing details of the procedures for checking a connection from client 100 in the network system 1 according to the embodiment.

FIG. 20 is a sequence diagram representing details of the procedures for checking a connection from application server 300 in the network system 1 according to the embodiment.

FIG. 21 is a sequence diagram representing details of the normal data pushing procedures from application server 300 in the network system 1 according to the embodiment.

FIG. 22 is a sequence diagram representing details of the large volume data pushing procedures from application server 300 in the network system 1 according to the embodiment.

FIG. 23 is a sequence diagram representing details of the normal data pushing procedures from client 100 in the network system 1 according to the embodiment.

FIG. 24 is a sequence diagram representing details of the large volume data pushing procedures from client 100 in the network system 1 according to the embodiment.

FIG. 25 is a schematic diagram representing the WS data structure according to the embodiment.

FIG. 26 is a schematic diagram representing the communication configuration of the network system 1 according to Fifth Embodiment.

FIG. 27 is a schematic diagram representing the communication configuration of the network system 1 according to Sixth Embodiment.

FIG. 28 is a schematic diagram representing the communication configuration of the network system 1 according to Seventh Embodiment.

FIG. 29 is a schematic diagram briefly representing the overall configuration and operation of the network system 1 according to Ninth Embodiment.

FIG. 30 is a schematic diagram representing association DB 221 of group names and group IDs according to Ninth Embodiment.

FIG. 31 is a schematic diagram representing association DB 222 of group IDs and connection IDs according to Ninth Embodiment.

FIG. 32 is a schematic diagram representing association DB 223 with a hierarchical group structure according to Ninth Embodiment.

FIG. 33 is a sequence diagram representing details of the procedures for client 100 joining a group in the network system 1 according to the embodiment.

FIG. 34 is a schematic diagram representing changes in association DB 222 during the group joining procedures according to the embodiment.

FIG. 35 is a sequence diagram representing details of the group joining procedures when a group ID is written into client 100 beforehand according to the embodiment.

FIG. 36 is a sequence diagram representing details of the procedures for joining a group designated by a user according to the embodiment.

FIG. 37 is a sequence diagram representing details of the procedures for adding a client with application server 300 in the network system 1 according to the embodiment.

FIG. 38 is a sequence diagram representing details of the procedures for adding a client with smartphone 500 or an external personal computer in the network system 1 according to the embodiment.

FIG. 39 is a sequence diagram representing details of the procedures for creating a group with application server 300 in the network system 1 according to the embodiment.

FIG. 40 is a sequence diagram representing details of the procedures for creating a group with smartphone 500 or an external personal computer in the network system 1 according to the embodiment.

FIG. 41 is a sequence diagram representing details of the procedures for removing client 100 from a group in the network system 1 according to the embodiment.

FIG. 42 is a schematic diagram representing changes in association DB 222 during the removal procedures from a group according to the embodiment.

FIG. 43 is a sequence diagram representing details of the group removal procedures when a group ID is written into client 100 beforehand according to the embodiment.

FIG. 44 is a sequence diagram representing details of the procedures for removal from a user designated group according to the embodiment.

FIG. 45 is a sequence diagram representing details of the procedures for removing a client from a group with application server 300 in the network system 1 according to the embodiment.

FIG. 46 is a sequence diagram representing details of the procedures for removing a client from a group with smartphone 500 or an external personal computer in the network system 1 according to the embodiment.

FIG. 47 is a sequence diagram representing details of the data transmission procedures from client 100 to a group in the network system 1 according to the embodiment.

FIG. 48 is a sequence diagram representing details of the data transmission procedures from application server 300 to a group in the network system 1 according to the embodiment.

FIG. 49 is a sequence diagram representing details of the data transmission procedures from client 100 to a group in the network system 1 according to Tenth Embodiment.

FIG. 50 is a sequence diagram representing details of the data transmission procedures from client 100 to a group in the network system 1 according to Eleventh Embodiment.

FIG. 51 is a sequence diagram representing details of the data transmission procedures from client 100 to a group in the network system 1 according to Twelfth Embodiment.

FIG. 52 is a sequence diagram representing details of the data transmission procedures from application server 300 to a group in the network system 1 according to Thirteenth Embodiment.

FIG. 53 is a sequence diagram representing details of the data transmission procedures from application server 300 to a group in the network system 1 according to Fourteenth Embodiment.

FIG. 54 is a sequence diagram representing details of the data transmission procedures from application server 300 to a group in the network system 1 according to Fifteenth Embodiment.

FIG. 55 is a schematic diagram briefly representing the overall configuration and operation of the network system 1 according to Sixteenth Embodiment.

FIG. 56 is a schematic diagram representing association DB224 of group names and group IDs according to Sixteenth Embodiment.

FIG. 57 is a schematic diagram representing association DB225 of group IDs and connection IDs according to Sixteenth Embodiment.

FIG. 58 is a schematic diagram briefly representing the overall configuration and operation of the network system 1 according to Seventeenth Embodiment.

FIG. 59 is a schematic diagram representing association DB of group names and group IDs according to Seventeenth and Eighteenth Embodiments.

FIG. 60 is a schematic diagram briefly representing the overall configuration and operation of the network system 1 according to Eighteenth Embodiment.

### DESCRIPTION OF THE PREFERRED EMBODIMENTS

Embodiments of the present invention are described below with reference to the accompanying drawings. In the following descriptions, like elements are given like reference numerals. Such like elements will be referred to by the same names, and have the same functions. Accordingly, detailed descriptions of such elements will not be repeated.

The following describes WebSocket protocol communications as an example of constant connection. It should be noted, however, that the present invention is in no way limited to a constant connection that uses the WebSocket protocol, as long as an application server and a constant connection server can push data to a client at any timing.

It is also noted that the network system 1 of the following embodiments, described as using the HTTP/WebSocket protocol, may also use the HTTPS/WSS protocol that can encrypt communication channels with SSL. That is, the techniques according to the embodiments of the present invention are also applicable to a network system using the HTTPS/WSS protocol.

### First Embodiment

### Overall Configuration of Network System

The overall configuration of the network system 1 according to the present embodiment is described below. FIG. 1 is a schematic diagram representing the overall configuration of the network system 1 according to the present embodiment.

Referring to FIG. 1, the network system 1 includes a plurality of home appliances 100A and 100B disposed in locations such as homes and offices, a constant connection server 200 connected to the home appliances 100A and 100B via a network, and a plurality of application servers 300A and 300B that provide various services concerning the home appliances 100A and 100B. Examples of the home appliances include a vacuum cleaner 100A, an air conditioner 100B, a television, a washing machine, a refrigerator, a rice cooker, an air purifier, a floor heating system, and an IH (Induction Heating) cooking heater. The home appliances may be any communications devices for homes and offices, including, for example, personal computers, audio-video equipment other than television, and an intercom system. The constant connection server 200 and the application server 300 may include servers that reside in the same home, office, building, company, or school where the home appliances are provided.

The home appliances and each server may be connected to each other via lines such as optical fibers, with an optical network unit, a wireless LAN communication access point, and a router optionally connected in between. The means by which the home appliances are connected to the network is not limited, and may be, for example, wireless LAN communications such as IEEE 802.11a/b/g/n/ac, and wired LAN.

In the present embodiment, the vacuum cleaner 100A and the air conditioner 100B become constantly connected to the constant connection server 200. This enables the application server 300A for vacuum cleaner to push data to the vacuum cleaner 100A at any timing via the constant connection server 200. Likewise, the application server 300B for air conditioner can push data to the air conditioner 100B at any timing via the constant connection server 200.

Specifically, in the network system 1 according to the present embodiment, it is not required to directly establish a constant connection between each home appliance and all the relevant application servers providing services to the home appliances. Conversely, there is no need for each application server to directly establish a constant connection with all the associated home appliances.

In the present embodiment, the constant connection server 200 and the application servers 300A and 300B represent different computers. In other words, the constant connection server 200 runs service programs for establishing constant connections with the home appliances. The programs that run on the application servers 300A and 300B include service programs for controlling the home appliances with the information sent to these devices, and service programs for obtaining information from the home appliances and using this information in other electronic devices.

More than one application service program may be installed in a single application server, as will be described in other embodiment. The constant connection server and the application server may be the same computer. For example, a single computer, specifically a server in the form of a device may contain a communications service program for establishing constant connections with the home appliances, and one or more application service programs for controlling the home appliances.

### <Brief Overview of Network System Operation>

The following is a brief overview of the operation of the network system 1 according to the present embodiment. In the following, the home appliances, including the vacuum cleaner 100A and the air conditioner 100B will also be collectively called clients 100. The term“application server 300” will also be used as a collective term for application servers, including the application server 300A for vacuum cleaner, and the application server 300B for air conditioner, that provide various services to clients 100 and users.

### <Brief Overview of the Operation for Opening Constant Connection>

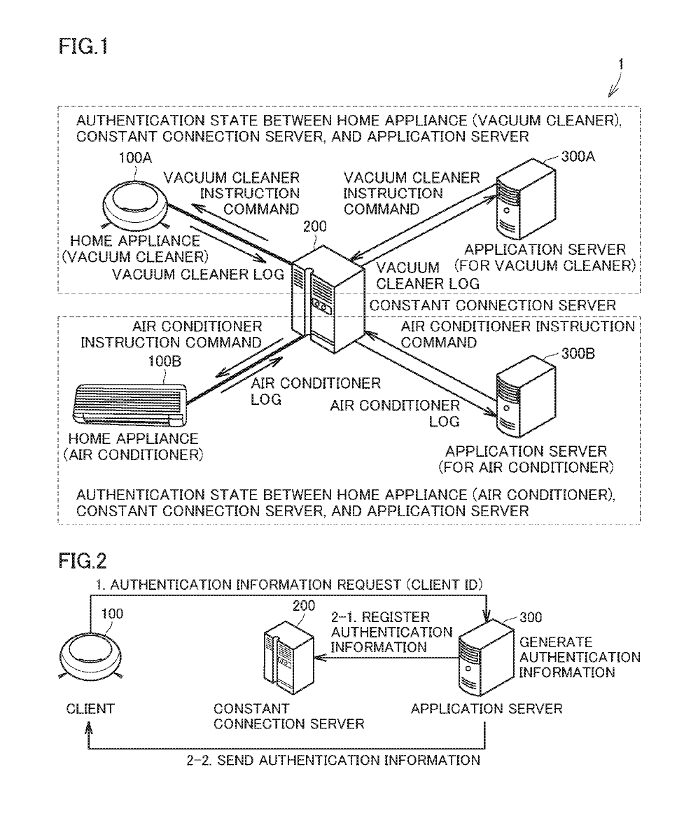

The following is a brief overview of the operation for opening a constant connection in the network system 1. FIG. 2 is a first schematic diagram briefly representing the operation for opening a constant connection in the network system 1 according to the present embodiment. FIG. 3 is a second schematic diagram briefly representing the operation for opening a constant connection in the network system 1 according to the present embodiment.

Referring to FIG. 2, the client 100 requests the application server 300 for authentication information, using the HTTP protocol. In response, the application server 300 generates authentication information, and sends it to the client 100 over the HTTP protocol. The application server 300 also sends the authentication information to the constant connection server 200.

Referring to FIG. 3, the client 100 requests the constant connection server 200 to open a constant connection based on the authentication information, using the HTTP protocol. By using the authentication information from the client 100 and the authentication information from the application server 300, the constant connection server 200 performs an authentication process for the client 100. When authentication is successful, the constant connection server 200 establishes a constant connection with the client 100, using the WebSocket protocol. The constant connection server 200 creates a connection ID unique to the WebSocket connection established between the client 100 and the server 300, and notifies the application server 300 of the connection ID. With the connection ID, the application server 300 is able to push information to the client 100 via the constant connection server 200.

<Brief Overview of the Operation for Checking Connection from Application Server>

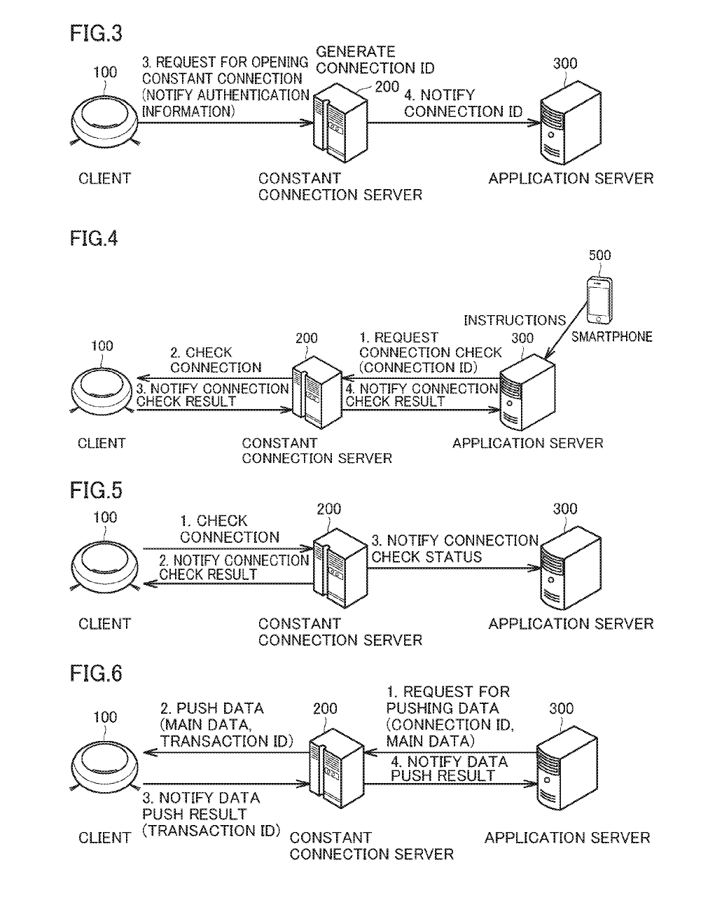

The following is a brief overview of the operation for checking a connection from the application server 300. FIG. 4 is a schematic diagram briefly representing the operation for checking a connection from the application server 300 in the network system 1 according to the present embodiment.

Referring to FIG. 4, the application server 300 requests the constant connection server 200 to check the validity (or condition) of the constant connection with the client 100 (e.g., whether the client 100 and the constant connection server 200 are properly operating). In response to the request, the constant connection server 200 sends connection check data to the client 100 over the WebSocket protocol.

Upon receiving the connection check data, the client 100 sends result notification data to the constant connection server 200 over the WebSocket protocol. Upon receiving the result notification data, the constant connection server 200 notifies the application server 300 that the constant connection with the client 100 is valid. On the other hand, when failed to receive the result notification data, the constant connection server 200 notifies the application server 300 that the constant connection with the client 100 is invalid.

The foregoing configuration has use in the following situations. For example, the application server 300 requests the constant connection server 200 for a connection check upon receiving some instruction from a smartphone 500, or when the smartphone 500 displays an instruction entry screen. The application server 300 accepts the instruction for the home appliance only when the constant connection is valid. On the other hand, when the constant connection is invalid, the application server 300 sends notification to a user via the smartphone 500 that the instruction is unexecutable.

<Brief Overview of the Operation for Checking Connection from Client>

The following is a brief overview of the operation for checking a connection from the client 100. FIG. 5 is a schematic diagram briefly representing the operation for checking a connection from the client 100 in the network system 1 according to the present embodiment.

Referring to FIG. 5, the client 100 sends connection check data to the constant connection server 200 over the WebSocket protocol to determine whether the constant connection with the constant connection server 200 is valid. Upon successfully receiving the connection check data, the constant connection server 200 sends result notification data to the client 100 over the WebSocket protocol. Here, the constant connection server 200 also sends notification to the application server 300 that the constant connection with the client 100 is valid.

<Brief Overview of Normal Information Pushing Operation from Application Server>

The following is a brief overview of a normal information pushing operation from the application server 300 to the client 100. FIG. 6 is a schematic diagram briefly representing a normal information pushing operation from the application server 300 in the network system 1 according to the present embodiment.

Referring to FIG. 6, the application server 300 sends the constant connection server 200 a connection ID for specifying the client 100, and main data to be sent to the client 100. The constant connection server 200 determines whether the main data is larger than a predetermined data volume. When the main data is no larger than the predetermined data volume, the constant connection server 200 sends the main data, and a transaction ID for specifying the current data transmission to the client 100 associated with the connection ID, using the WebSocket protocol.

Upon receiving the main data, the client 100 sends result information indicative of the receipt of the main data, and the transaction ID to the constant connection server 200 over the WebSocket protocol. By using the received result information and the transaction ID, the constant connection server 200 notifies the application server 300 of the result of the data transmission.

<Brief Overview of Large Volume Information Pushing Operation from Application Server>

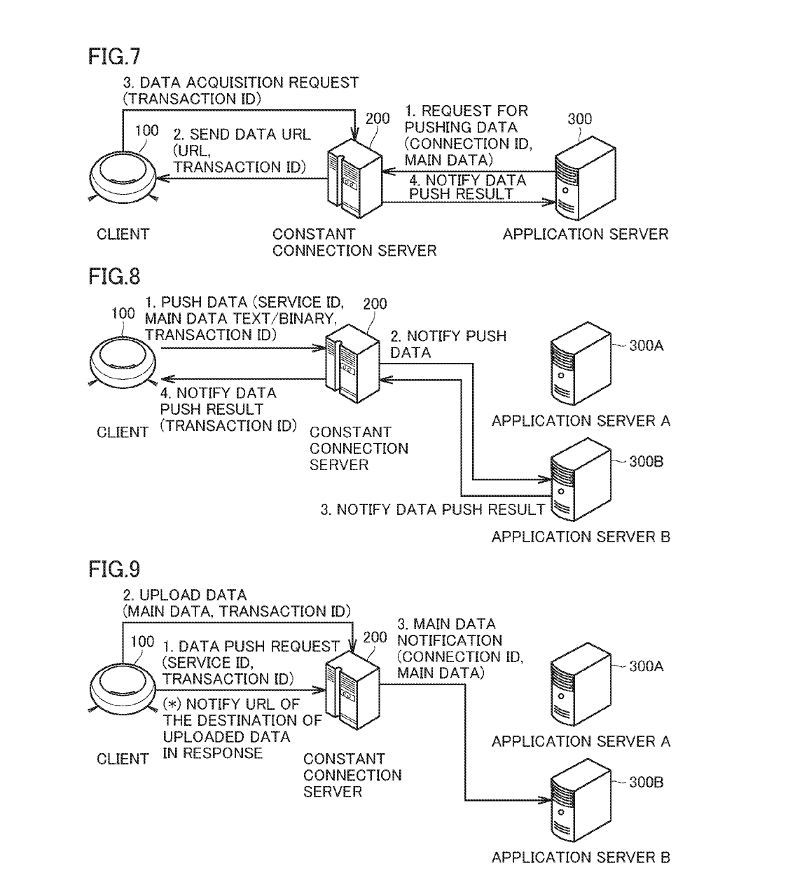

The following is a brief overview of a large volume information pushing operation from the application server 300 to the client 100. FIG. 7 is a schematic diagram briefly representing a large volume information pushing operation from the application server 300 in the network system 1 according to the present embodiment. More specifically, the network system 1 according to the present embodiment has the following functions to prevent large files from occupying the constant connection communications, and to reduce the burden on network resources associated with a constant connection.

Referring to FIG. 7, the application server 300 sends the constant connection server 200 a connection ID for specifying the client 100, and main data to be sent to the client 100. The constant connection server 200 determines whether the main data is larger than a predetermined data volume. When the main data is larger than the predetermined data volume, the constant connection server 200 sends URL information indicative of a data acquisition method, and a transaction ID for specifying the current data transmission to the client 100 associated with the connection ID, using the WebSocket protocol.

Upon receiving the URL information and the transaction ID, the client 100 sends the transaction ID to the constant connection server 200 over the HTTP protocol. By using the transaction ID, the constant connection server 200 sends the main data to the client 100. The client 100 downloads the main data from the storage location associated with the URL information, and sends result information indicative of the receipt of the main data, and the transaction ID to the constant connection server 200. By using the received result information and the transaction ID, the constant connection server 200 notifies the application server 300 of the result of the data transmission.

The determination of data volume may be performed by the application server 300, instead of the constant connection server 200. In this case, the application server 300 sends URL information to the client 100 via the constant connection server 200 when the data volume is larger than the predetermined value. The client 100, using the URL information, downloads data from the constant connection server 200 or the application server 300 over the HTTP protocol.

<Brief Overview of Normal Information Pushing Operation from Client>

The following is a brief overview of a normal information pushing operation from the client 100. FIG. 8 is a schematic diagram briefly representing a normal information pushing operation from the client 100 in the network system 1 according to the present embodiment.

Referring to FIG. 8, the client 100 determines whether the main data to be sent is larger than a predetermined data volume. If it is determined that the main data is no larger than the predetermined data volume, the client 100 sends the constant connection server 200 a service ID for specifying the receiving application server 300, together with main data and a transaction ID for specifying the current data transmission, using the WebSocket protocol.

The constant connection server 200 sends the main data and the associated connection ID of the client 100 to the application server 300B associated with the service ID. Upon receiving the main data, the application server 300B stores the main data in association with the connection ID. The application server 300B then sends result notification indicative of the receipt of the main data to the constant connection server 200. In response to the result notification, the constant connection server 200 sends the transaction ID and the transmission result to the client 100 over the WebSocket protocol.

<Brief Overview of Large Volume Information Pushing Operation from Client>

The following is a brief overview of a large volume information pushing operation from the client 100. FIG. 9 is a schematic diagram briefly representing a large volume information pushing operation from the client 100 in the network system 1 according to the present embodiment.

Referring to FIG. 9, the client 100 determines whether the main data to be sent is larger than a predetermined data volume. When the main data is larger than the predetermined data volume, the client 100 sends the constant connection server 200 a service ID for specifying the receiving application server 300, the data volume, and a transaction ID for specifying the current data transmission, using the WebSocket protocol.

The constant connection server 200 notifies the client 100 of the upload location of the transaction ID and the data over the WebSocket protocol. By using the transaction ID, the client 100 uploads the main data to the upload location over the HTTP protocol.

Upon completion of the upload from the client 100, the constant connection server 200 sends the main data, and the associated connection ID of the client 100 to the application server 300B associated with the service ID. Upon receiving the main data, the application server 300B stores the main data in association with the connection ID. The application server 300B sends result notification indicative of the receipt of the main data to the constant connection server 200. In response to the result notification, the constant connection server 200 sends the transaction ID and the transmission result to the client 100 over the WebSocket protocol.

As described in the foregoing brief overviews of different operations in the network system 1 according to the present embodiment, the client 100 is given a connection ID, and the application server 300, using the connection ID, can push various data to the selected client 100.

In the network system 1 according to the present embodiment, the client 100 and the application server 300 become constantly connected each other via the constant connection server 200. This eliminates the need for exchanging identification ID, and establishing a WebSocket constant connection for each different combination of the client (browser) and the application server (service program). The burden on the network system 1 can thus be reduced from that of related art.

In the network system 1 according to the present embodiment, the client 100 and the constant connection server 200 switch the protocols according to the size of the transmitted data volume, and the communication path using the WebSocket protocol is less likely to be occupied by some of the data sent and received. In other words, it is less likely that sending and receiving of other WebSocket data is obstructed.

The following describes the specific configuration of each component of the network system 1 for realizing the foregoing functions.

### <Network System 1>

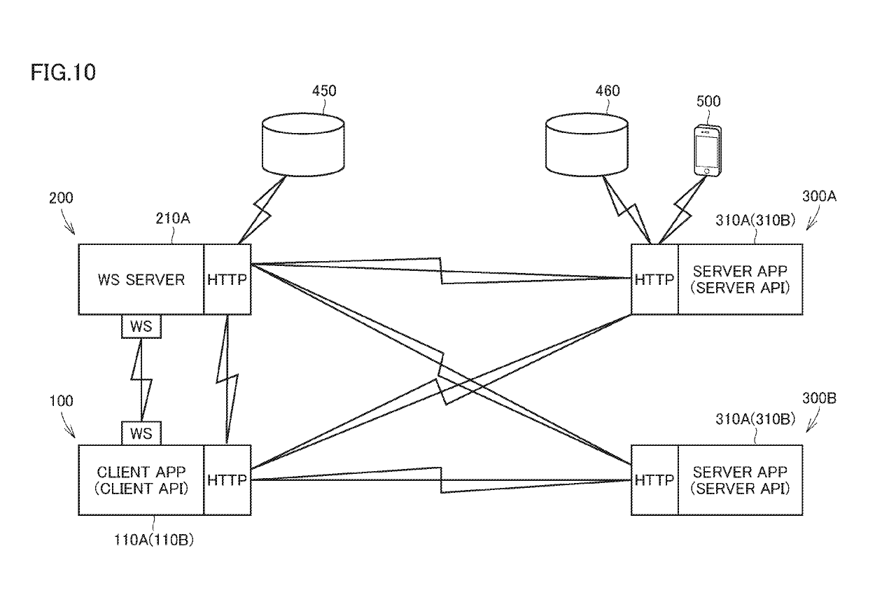

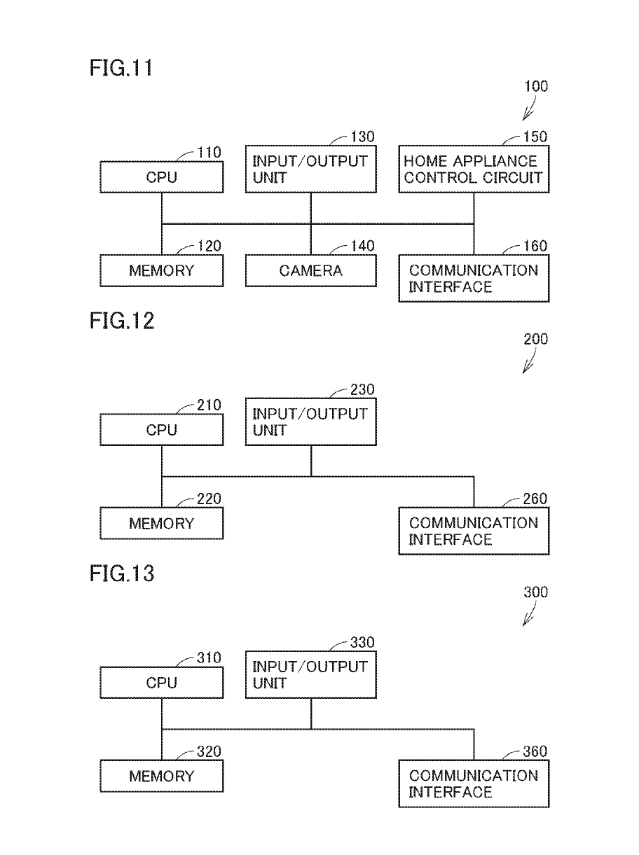

The overall communication configuration of the network system 1 according to the present embodiment is described first. FIG. 10 is a block diagram representing the overall communication configuration of the network system 1 according to the present embodiment.

Referring to FIG. 10, the client 100 may communicate with the constant connection server 200 and the application server 300 over the HTTP protocol, and may constantly connect to the constant connection server 200 over the WebSocket protocol. More specifically, the client 100 contains a client APP 110A and a client API 110B, as will be described later in detail. The client APP 110A controls each part of the client 100. The client API 110B is provided for communications via a communication interface (described later), including communications using the HTTP protocol, and WebSocket protocol communications over the HTTP protocol.

The configuration according to the present embodiment is applicable not only to the HTTP/WebSocket protocol, but to the HTTPS/WSS protocol that can encrypt communication channels with SSL. That is, the network system 1 according to the present embodiment is also applicable to systems based on the HTTPS/WSS protocol.

The constant connection server 200 contains a WS server (constant connection server in the form of software) 210A as a program for controlling the constant connection communications with the client 100 over the WebSocket protocol. The constant connection server 200 may access other database 450, using other protocols. In the present embodiment, the constant connection server 200 can send data to the application server 300 at any timing, using the HTTP protocol.

The network system 1 according to the present embodiment includes a plurality of application servers, 300A and 300B. The application servers 300A and 300B each contain a server APP (application server in the form of software) 310A as a program for providing services to devices such as the client 100 and the smartphone 500, and a server API 310B provided for communicating with the constant connection server 200 over the HTTP protocol.

As an example, the network system 1 includes the application server 300A for controlling the vacuum cleaner 100A, and the application server 300B for controlling the air conditioner 100B. The application servers 300A and 300B may each communicate with the constant connection server 200, other database, the smartphone 500, and other such devices over the HTTP protocol. In the present embodiment, the application servers 300A and 300B can send data to the constant connection server 200 at any timing over the HTTP protocol.

### <Hardware Configuration of Client 100>

The following describes an aspect of the hardware configuration of the client 100. FIG. 11 is a block diagram representing the hardware configuration of the client 100 according to the present embodiment.

Referring to FIG. 11, the main constituting elements of the client 100 include a CPU 110, a memory 120, an input/output unit 130, a camera 140, a home appliance control circuit 150, and a communication interface 160.

The CPU 110 controls each part of the client 100 by running programs stored in the memory 120 or in external storage media. More specifically, the CPU 110 operates as the client APP 110A (see FIGS. 16 to 24) by using APP (application software) data (described later), and as the client API 110B (see FIGS. 16 to 24) by using API (Application Programming Interface) data (described later). In other words, the CPU 110 performs various processes by running programs stored in the memory 120, as will be described later.

The memory 120 is realized by various types of memory, including, for example, RAM (Random Access Memory), ROM (Read-Only Memory), and flash memory. The memory 120 may also be realized by, for example, storage media used with an interface, including, for example, USB (Universal Serial Bus®) memory, CD (Compact Disc), DVD (Digital Versatile Disk), memory card, hard disk, IC (Integrated Circuit) card, optical memory card, mask ROM, EPROM (Erasable Programmable Read Only Memory), and EEPROM (Electronically Erasable Programmable Read-Only Memory).

The memory 120 stores programs run by the CPU 110, data generated after the execution of a program by the CPU 110, input data via the input/output unit 130, APP data operating as a client such as a vacuum cleaner and an air conditioner, and API data for communicating with the constant connection server 200 while exchanging data with the client APP. Specifically, the memory 120 stores information such as the connected device of the constant connection server, the connected device of the application server, service identification code, service authentication token, connection ID, and client identification ID.

The input/output unit 130 is realized by, for example, a button, a touch panel, or a keyboard. The input/output unit 130 receives a user instruction, and enters the instruction to the CPU 110. The input/output unit 130 is also realized by, for example, a display, or a light, and outputs characters and images by using signals from the CPU 110. The input/output unit 130 is also realized by, for example, a speaker, and outputs sound by using signals from the CPU 110.

The camera 140 takes still pictures and videos by using signals from the CPU 110. Specifically, the camera 140 transfers the captured image data to the CPU 110. The CPU 110 sequentially stores the image data in the memory 120.

The home appliance control circuit 150 controls each part (such as a motor) of the client (home appliance) by using signals from the CPU 110.

The communication interface 160 is realized by various communications modules, including, for example, wireless LAN communications (such as IEEE 802.11a/b/g/n/ac), ZigBee®, BlueTooth®, and wired LAN such as Ethernet®. The communication interface 160 is provided for data exchange with other devices over wired communications or wireless communications. The CPU 110 receives programs, control instructions, image data, text data, and other such information from other devices, and sends information such as text data and image data to other devices via the communication interface 160. In the present embodiment, the CPU 110 via the communication interface 160 may constantly connect to the constant connection server 200 over the WebSocket protocol, and may communicate with the application server 300 over the HTTP protocol.

### <Hardware Configuration of Constant Connection Server 200>

The following describes an aspect of the hardware configuration of the constant connection server 200. FIG. 12 is a block diagram representing the hardware configuration of the constant connection server 200 according to the present embodiment. The constant connection server 200 can normally use apache, tomcat, mysql, and other such functions available to common server modules.

Referring to FIG. 12, the main constituting elements of the constant connection server 200 include a CPU 210, a memory 220, an input/output unit 230, and a communication interface 260. The hardware configuration of the constant connection server 200 differs from that of the client 100 in that the home appliance control circuit 150 for controlling each part of the home appliances, and the camera 140 are not provided. Other differences are the operation of the CPU 210, and the data stored in the memory 220. Accordingly, the following describes the operation of the CPU 210, and the data stored in the memory 220, and does not describe other hardware configuration.

The CPU 210 controls each part of the constant connection server 200 by running programs stored in the memory 220 or in external storage media. Specifically, the CPU 210 runs the programs stored in the memory 220, and operates as the WS server 210A (see FIGS. 16 to 24).

The memory 220 stores information such as programs run by the CPU 210, data generated after the execution of a program by the CPU 210, input data via the input/output unit 230, service ID, service name, the URL of the connected device of the application server 300, service authentication token generating information, authentication information (one-time key), and connection ID.

### <Hardware Configuration of Application Server 300>

The following describes an aspect of the hardware configuration of the application server 300. FIG. 13 is a block diagram representing the hardware configuration of the application server 300 according to the present embodiment. The application server 300 can normally use apache, tomcat, mysql, and other such functions available to common server modules.

Referring to FIG. 13, the main constituting elements of the application server 300 include a CPU 310, a memory 320, an input/output unit 330, and a communication interface 360. The hardware configuration of the application server 300 differs from that of the client 100 in that the home appliance control circuit 150 for controlling each part of the home appliances is not provided. Other differences are the operation of the CPU 310, and the data stored in the memory 320. Accordingly, the following describes the operation of the CPU 310, and the data stored in the memory 320, and does not describe other hardware configuration.

The CPU 310 controls each part of the application server 300 by running programs stored in the memory 320 or in external storage media. Specifically, the CPU 310 runs the programs stored in the memory 320, and operates as the server APP 310A (see FIGS. 16 to 24) by using the APP data (described later), and as the server API 310B (see FIGS. 16 to 24) by using the API data (described later).

The memory 320 stores programs run by the CPU 310, data generated after the execution of a program by the CPU 310, input data via the input/output unit 330, APP data operating as the application server 300, and API data for communicating with the constant connection server 200 while exchanging data with the server APP. Specifically, the memory 320 stores information such as the URL of the constant connection server, service ID, service authentication token, authentication information (one-time key) generating information, and connection ID.

### <Hardware Configuration of Smartphone 500>

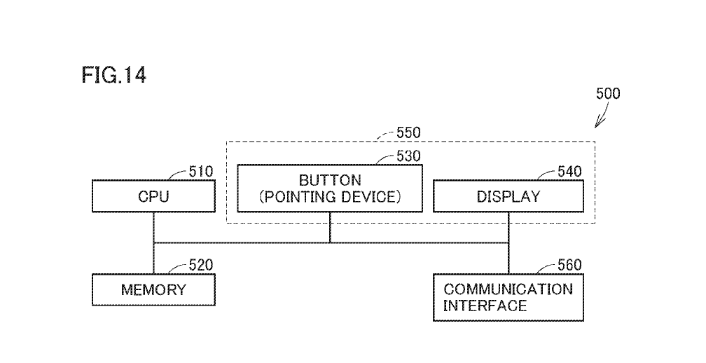

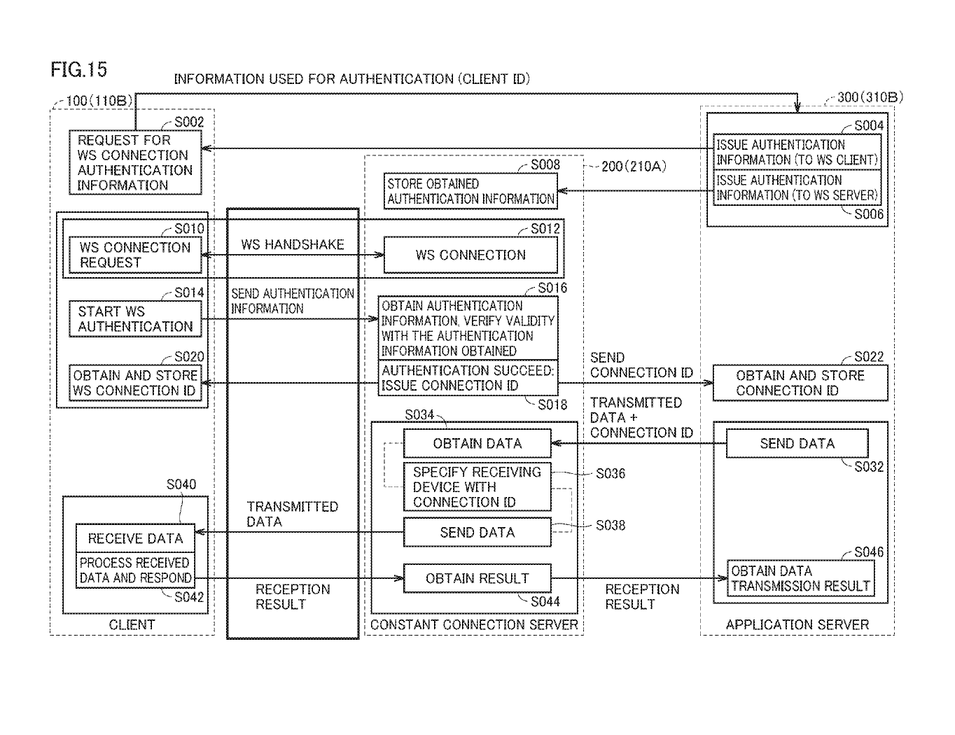

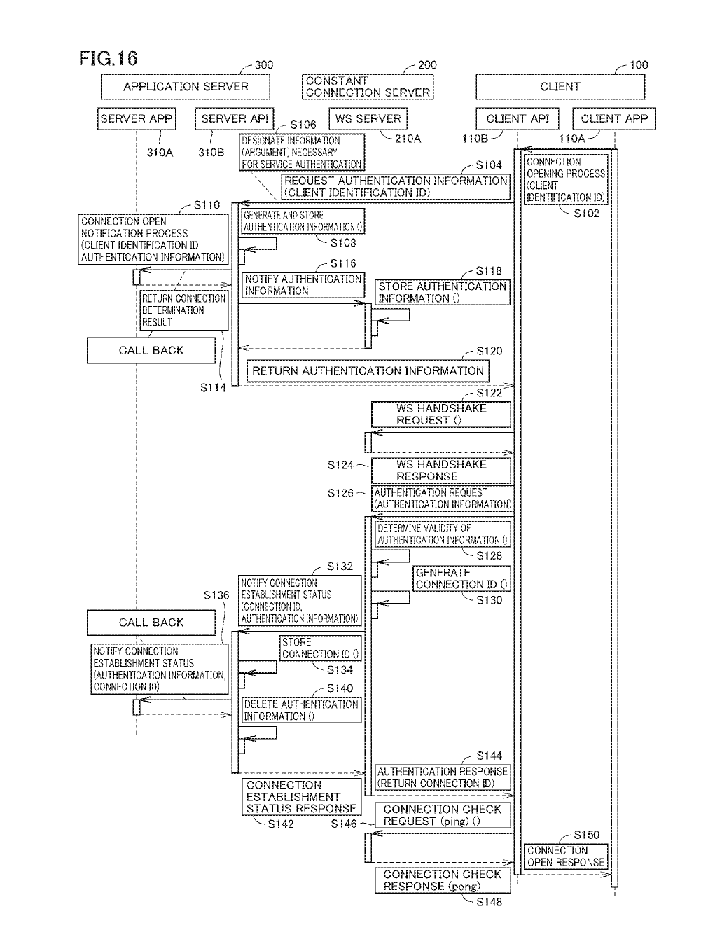

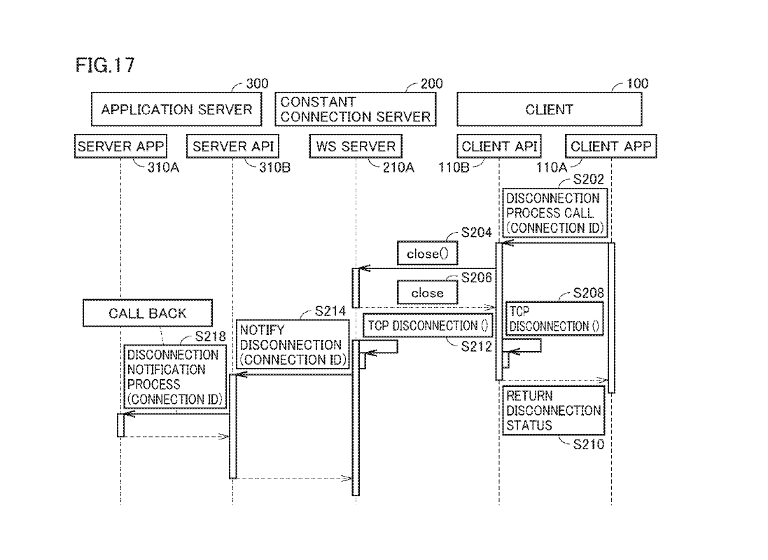

The following describes an aspect of the hardware configuration of the smartphone 500. FIG. 14 is a block diagram representing the hardware configuration of the smartphone 500 according to the present embodiment.

Referring to FIG. 14, the main constituting elements of the smartphone 500 include a CPU 510, a memory 520, a button 530, a display 540, and a communication interface 560. The hardware configuration of the smartphone 500 differs from that of the client 100 in that the home appliance control circuit 150 for controlling each part of the home appliances is not provided. Other differences are the operation of the CPU 510, and the data stored in the memory 520. Accordingly, the hardware configuration will not be described with regard to these components. Note that it is now more common to use a touch panel 550 in place of the button 530 and the display 540.

### <Data Exchange Between Devices Concerning Constant Connection>

The following is a brief overview of the data exchange between devices concerning the constant connection in the network system 1 according to the present embodiment. FIG. 15 is a sequence diagram representing the procedures of the data exchange between devices concerning the constant connection in the network system 1 according to the present embodiment.

Referring to FIG. 15, the client 100 requests the application server 300 for authentication information over the HTTP protocol (step S002). For authentication, the client 100 sends a client ID to the application server 300. The application server 300 responds to the request by sending authentication information to the client 100 over the HTTP protocol (step S004).

The application server 300 sends authentication information also to the constant connection server 200 (step S006). The constant connection server 200 stores the authentication information sent from the application server 300 (step S008).

The client 100 and the constant connection server 200 establish a WebSocket constant connection state, using the HTTP protocol (step S010, step S012). Specifically, the client 100 sends a handshake request to the constant connection server 200 over the HTTP protocol. The constant connection server 200 returns a handshake response. This establishes a valid WebSocket constant connection between the client 100 and the constant connection server 200.

The client 100 sends the authentication information to the constant connection server 200 (step S014). The constant connection server 200 authenticates the client 100 by using the authentication information from the client 100, and the stored authentication information (step S016). When authentication is successful, the constant connection server 200 issues a connection ID for the identification of the client 100 by the application server 300 (step S018). Specifically, the association between the client 100 and the connection ID in the constant connection is stored as connection status administrative information in the constant connection server 200. The constant connection server 200 sends the connection ID to the application server 300 and the client 100. The client 100 receives and stores the connection ID (step S020). The application server 300 also receives and stores the connection ID (step S022).

As required, the application server 300 sends main data to the constant connection server 200, together with the connection ID for specifying the receiving client 100 (step S032). The constant connection server 200 receives the main data and the connection ID from the application server 300 (step S034). The constant connection server 200 refers to the connection status administrative information, and specifies the client 100 on the basis of the connection ID (step S036).

The constant connection server 200 sends the main data to the specified client 100 over the WebSocket protocol (step S038). The client 100 receives the main data (step S040). The client 100 sends the reception result to the constant connection server 200 over the WebSocket protocol (step S042). Upon receiving the reception result, the constant connection server 200 sends it to the application server 300 (step S044). The application server 300 receives the reception result (step S046).

The following more specifically describes the procedures in the network system 1 according to the present embodiment. As described above, the client APP 110A is realized by execution of a program by the CPU 110 of the client 100, and controls the operation of the client 100 (FIGS. 10 and 11). The client API 110B is realized by execution of a program by the CPU 110 of the client 100, and communicates with the constant connection server 200 via the communication interface 160 over the HTTP protocol and the WebSocket protocol.

Referring to FIGS. 10 and 13, the server APP 310A is realized by execution of a program by the CPU 310 of the application server 300, and operates as an application service program. The server API 310B is realized by execution of a program by the CPU 310 of the application server 300, and communicates with the constant connection server 200 via the communication interface 360.

Referring to FIGS. 10 and 12, the WS server 210A is realized by execution of a program by the CPU 210 of the constant connection server 200. The WS server 210A communicates with the application server 300 via the communication interface 260 over the HTTP protocol. In the present embodiment, the WS server 210A communicates with the client 100 via the communication interface 260 over the HTTP protocol and the WebSocket protocol.

### <Details of Procedures for Opening Constant Connection>

The following describes details of the procedures for opening a constant connection in the network system 1 according to the present embodiment. FIG. 16 is a sequence diagram representing details of the procedures for opening a constant connection in the network system 1 according to the present embodiment.

Referring to FIG. 16, the client APP 110A transfers to the client API 110B a request for opening a constant connection with the application server 300 (step S102). Here, the client APP 110A transfers a client ID to the client API 110B.

The client API 110B sends the client ID to the application server 300, and requests authentication information via the communication interface 160 over the HTTP protocol (step S104). The client APP 110A or the client API 110B also sends the application server 300 other information (argument) necessary for service authentication (step S106).

Upon receiving the client ID and the request, the server API 310B generates authentication information (step S108). The server API 310B notifies the server APP 310A of the request to open a connection (step S110). Upon receiving a connection authorization response from the server APP 310A (step S114), the server API 310B sends authentication information to the constant connection server 200 via the communication interface 360 (step S116). The WS server 210A stores the authentication information in the memory 120 (step S118). The server API 310B sends the authentication information to the client 100 via the communication interface 260 (step S120).

The client API 110B sends a handshake request to the constant connection server 200 via the communication interface 160 over the HTTP protocol (step S122). The WS server 210A returns a handshake response to the client 100 via the communication interface 260 (step S124). This opens a WebSocket constant connection between the client 100 and the constant connection server 200.

The client API 110B sends the authentication information to the constant connection server 200 via the communication interface 160 over the WebSocket protocol (step S126). The WS server 210A authenticates the client 100 by using the authentication information previously received from the application server 300, and the current authentication information received from the client 100 (step S128).

When authentication is successful, the WS server 210A issues a connection ID (step S130). The WS server 210A sends the connection ID of the client 100 (connection establishment status) to the application server 300 via the communication interface 260 (step S132). The server API 310B stores the connection ID in the memory 320 (step S134). The server API 310B notifies the server APP 310A of the connection establishment status (step S136). The server API 310B then deletes the authentication information (step S138).

The WS server 210A responds to the authentication request by sending the connection ID to the client 100 via the communication interface 260 over the WebSocket protocol (step S144). The client API 110B stores the connection ID.

The client API 110B requests a connection check via the communication interface 160 over the WebSocket protocol (step S146). Upon receiving the request, the WS server 210A responds to the connection check via the communication interface 260 over the WebSocket protocol (step S148). In response, the client API 110B notifies the client APP 100A that the constant connection is open (step S150).

<Details of Procedures for Closing Constant Connection from Client>

The following describes details of the procedures for closing a constant connection from client in the network system 1 according to the present embodiment. FIG. 17 is a sequence diagram representing details of the procedures for closing a constant connection from client in the network system 1 according to the present embodiment.

Referring to FIG. 17, the client APP 110A transfers to the client API 110B a request for closing the constant connection with the application server 300 (step S202). Here, the client 100 also transfers a connection ID to the client API 110B.

The client API 110B requests the constant connection server 200 to close the constant connection via the communication interface 160 over the WebSocket protocol (step S204). The WS server 210A acknowledges the closure of the constant connection via the communication interface 260 over the WebSocket protocol (step S206).

The client API 110B terminates the constant connection with the constant connection server 200, and the TCP communication with the constant connection server 200 (step S208). The client API 110B notifies the client APP 100A of the termination of the constant connection (step S210).

The WS server 210A terminates the constant connection with the client 100, and the TCP communication with the client 100 (step S212). The WS server 210A notifies the application server 300 via the communication interface 260 that the constant connection is closed (step S214).

In response to the notification, the server API 310B notifies the server APP 310A that the constant connection with the client 100 has been terminated (step S218). Specifically, the server API 310B transfers to the server APP 310A the associated connection ID of the client 100 for which the constant connection has been terminated.

<Details of Procedures for Closing Constant Connection from Application Server>

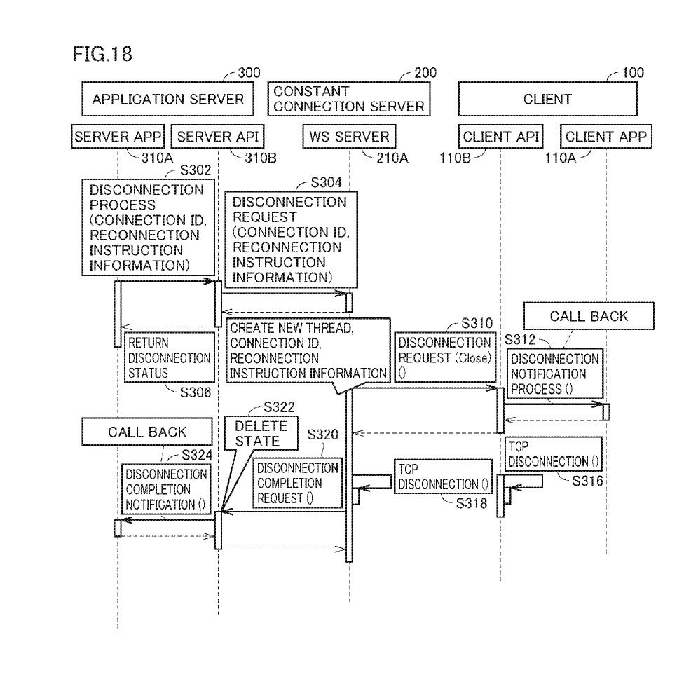

The following describes details of the procedures for closing a constant connection from application server 300 in the network system 1 according to the present embodiment. The application server 300 may close a constant connection with client 100 when updating programs or fixing troubles during maintenance. FIG. 18 is a sequence diagram representing details of the procedures for closing a constant connection from application server 300 in the network system 1 according to the present embodiment.

Referring to FIG. 18, the server APP 310A transfers to the server API 310B a request for closing the constant connection with the client 100 (step S302). Here, the server APP 310A also transfers the connection ID of the client 100 of interest to the server API 310B.

The server API 310B requests the constant connection server 200 to close the constant connection with the client 100 via the communication interface 360 (step S304). The WS server 210A acknowledges the closure of the constant connection via the communication interface 260. The server API 310B notifies the server APP 310A of the termination of the constant connection with the client 100 (step S306).

The WS server 210A requests the client 100 to close the constant connection via the communication interface 260 over the WebSocket protocol (step S310). In response to the request, the client API 110B notifies the client APP 100A of the intension to close the constant connection (step S312). The client API 110B terminates the constant connection with the constant connection server 200, and the TCP communication with the constant connection server 200 (step S316).

The WS server 210A terminates the constant connection with the client 100, and the TCP communication with the client 100 (step S318). The WS server 210A notifies the server API 310B via the communication interface 260 that the constant connection with the client 100 is closed (step S320).

In response to the notification, the server API 310B deletes the connection ID of the client 100 from the connection status administrative information stored in the memory 320 (step S322). The server API 310B notifies the server APP 310A of the completion of the disconnection process (step S324).

<Details of Procedures for Checking Connection from Client>

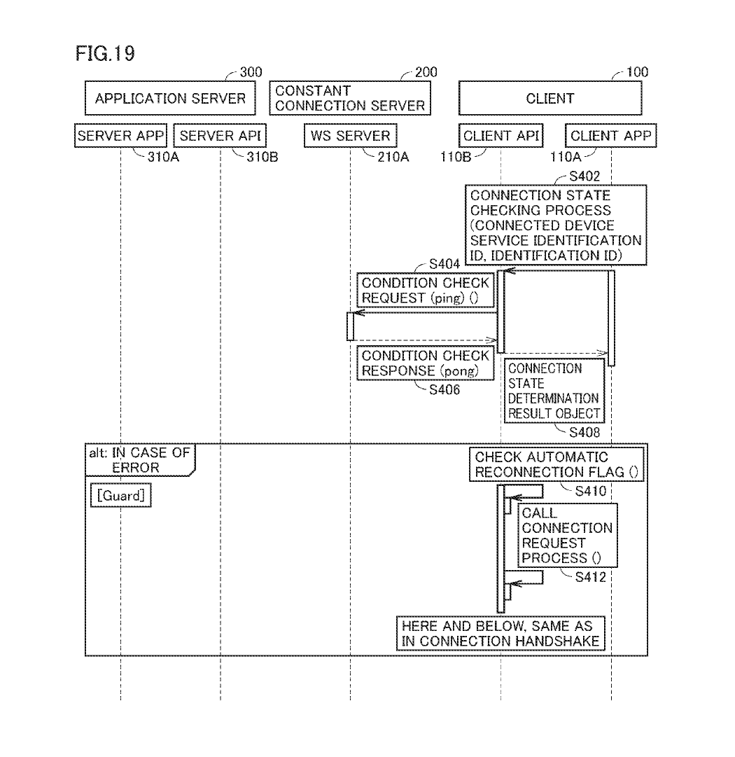

The following describes details of the procedures for checking a connection from client 100 in the network system 1 according to the present embodiment. The client 100 may close the constant connection with the application server 300 when there is no data reception over the constant connection for a certain time period, and when there are user instructions for disabling the constant connection function. FIG. 19 is a sequence diagram representing details of the procedures for checking a connection from client 100 in the network system 1 according to the present embodiment.

Referring to FIG. 19, the client APP 100A requests the client API 110B to check a connection with the constant connection server 200 (step S402). The client API 110B sends a connection check request (ping) to the constant connection server 200 via the communication interface 160 over the WebSocket protocol (step S404).

Upon receiving the connection check request (ping), the WS server 210A sends a connection check response (pong) to the client 100 via the communication interface 260 (step S406). The client API 110B notifies the client APP 100A of the result of connection status determination (step S408).

When the constant connection server 200 does not return a connection check response (pong), the client API 110B checks the automatic reconnection flag, and calls up a process for requesting a constant connection (step S412). The network system 1 then performs the same process used to open a constant connection (see FIGS. 15 and 16).

<Details of Procedures for Checking Connection from Application Server>

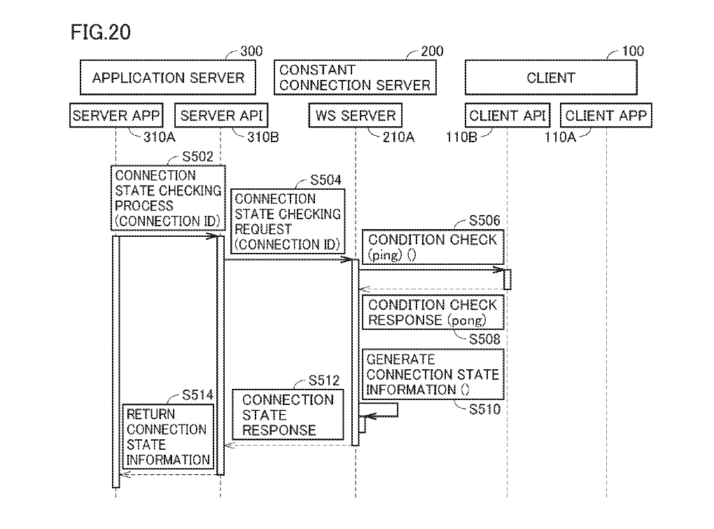

The following describes details of the procedures for checking a connection from application server 300 in the network system 1 according to the present embodiment. FIG. 20 is a sequence diagram representing details of the procedures for checking a connection from application server 300 in the network system 1 according to the present embodiment.

Referring to FIG. 20, the server APP 310A requests the server API 310B to check a connection with the constant connection server 200 and the client 100 (step S502). The server API 310B requests the constant connection server 200 to check a connection with the client 100 via the communication interface 360 (step S504).

The WS server 210A sends a connection check request (ping) to the client 100 via the communication interface 260 over the WebSocket protocol (step S506). Upon receiving the connection check request (ping), the client API 110B sends a connection check response (pong) to the constant connection server 200 via the communication interface 260 over the WebSocket protocol (step S508).

Upon receiving the connection check response (pong), the WS server 210A creates connection status information (step S510). The WS server 210A sends the connection status information to the application server 300 via the communication interface 260 (step S512). The server API 310B transfers the connection status information to the server APP 310A (step S514).

<Details of Procedures for Normal Data Pushing Operation from Application Server>

The following describes details of the procedures for pushing data from application server 300 in the network system 1 according to the present embodiment. Specifically, the data pushing procedures in the network system 1 according to the present embodiment will be separately described for normal (small volume) data pushing operation and large volume data pushing operation from application server 300.

Examples of the small volume data sent from the application server 300 include text files such as commands, and small image/audio/video files (small content for playback). Examples of the large volume data sent from the application server 300 include large image/audio/video files.

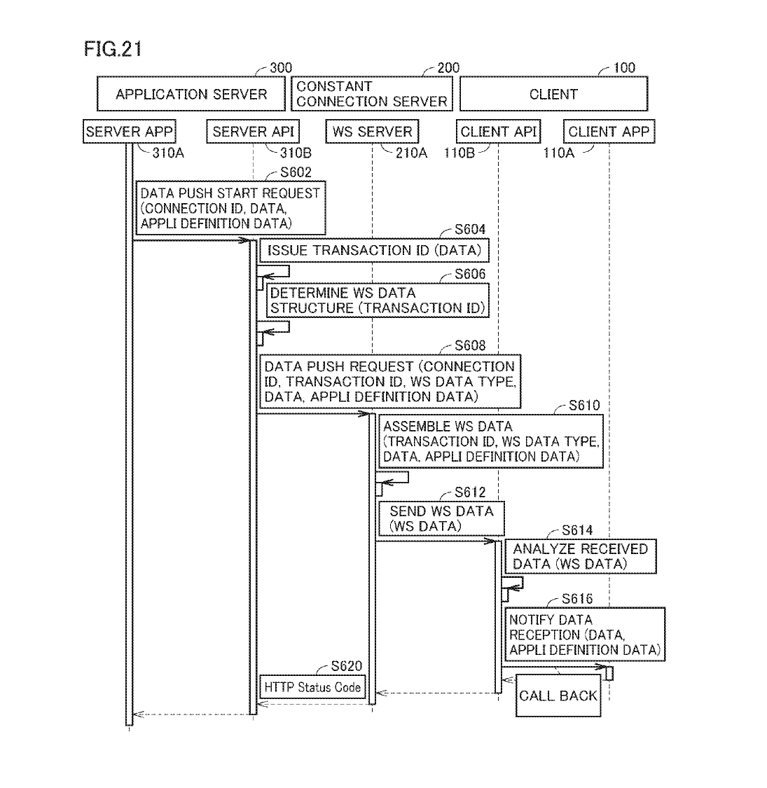

The data pushing procedures from the application server 300 in the network system 1 according to the present embodiment are described below in detail. FIG. 21 is a sequence diagram representing details of the normal data pushing procedures from the application server 300 in the network system 1 according to the present embodiment.

Referring to FIG. 21, the server APP 310A requests the server API 310B to push data (step S602). Specifically, the server APP 310A transfers to the server API 310B a connection ID for specifying the client 100, main data, and data for specifying an application. The server API 310B issues a transaction ID (step S604).

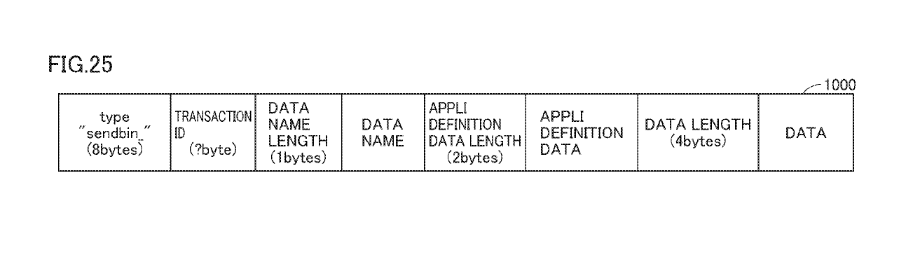

The server API 310B determines the WS data structure (step S606). FIG. 25 is a schematic diagram representing the structure of WS data according to the present embodiment. As shown in FIG. 25, WS data 1000 contains, for example, type “sendbin_” (8 bytes), transaction ID, data length, data name, application definition data length, application definition data, data length, and main data. In the present embodiment, the server API 310B determines whether the main data volume is larger than a predetermined value. Alternatively, the server API 310B determines whether the total data volume to be sent to the client 100 is larger than a predetermined value. The following describes the case where the data volume is no larger than the predetermined value.

The server API 310B requests the constant connection server 200 to push data (step S608). Specifically, the server API 310B sends the connection ID, the transaction ID, the WS data type, the main data, and the data for specifying an application to the constant connection server 200 via the communication interface 360.

The WS server 210A receives the data from the application server 300, and reconstructs the data to accommodate the WebSocket protocol (step S610). The WS server 210A sends the connection ID, the transaction ID, the WS data type, the main data, and the data for specifying an application to the client 100 via the communication interface 260 over the WebSocket protocol (step S612).

The client API 110B receives the data from the constant connection server 200 via the communication interface 160 over the WebSocket protocol. The client API 110B analyzes the received WS data (step S614). The client API 110B transfers the received data to the client APP 100A (step S616).

The client API 110B sends the data with the transaction ID via the communication interface 160 over the WebSocket protocol to notify the constant connection server 200 that the main data has been received by the client 100. The WS server 210A sends the data with the transaction ID via the communication interface 260 to notify the application server 300 that the client 100 has received the main data (step S620).

<Details of Procedures for Large Volume Data Pushing Operation from Application Server>

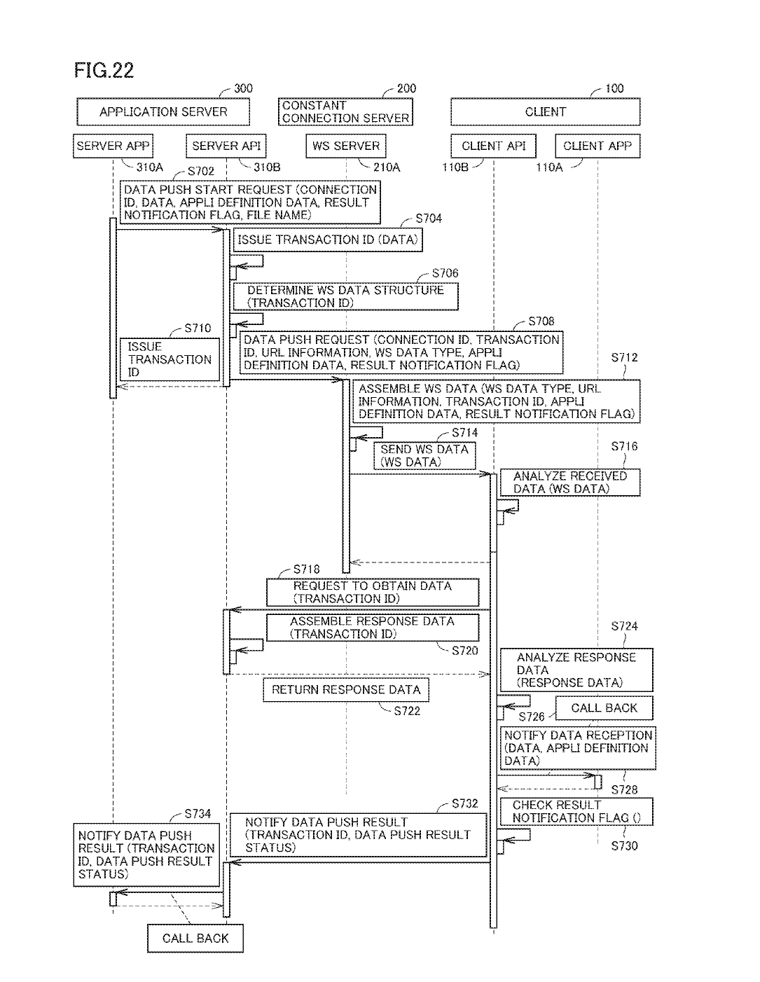

The following describes the procedures for pushing large volume data from application server 300 in the network system 1 according to the present embodiment. FIG. 22 is a sequence diagram representing details of the procedures for pushing large volume data from application server 300 in the network system 1 according to the present embodiment.

Referring to FIG. 22, the server APP 310A requests the server API 310B to push data (step S702). Specifically, the server APP 310A transfers to the server API 310B a connection ID for specifying the client 100, main data, and data for specifying an application. The server API 310B issues a transaction ID (step S704).

The server API 310B determines the WS data structure (step S706). In the present embodiment, the server API 310B determines whether the main data volume is larger than a predetermined value. Alternatively, the server API 310B determines whether the total data volume to be sent to the client 100 is larger than a predetermined value. The following describes the case where the data volume is larger than the predetermined value.

The server API 310B requests the constant connection server 200 to push data (step S708). Specifically, the server API 310B sends the connection ID, the transaction ID, the URL information, the WS data type, the data for specifying an application, and the result notification flag to the constant connection server 200 via the communication interface 360. Here, the server API 310B transfers the transaction ID also to the server APP 310A (step S710).

The WS server 210A receives the data from the application server 300, and reconstructs the data to accommodate the WebSocket protocol (step S712). The WS server 210A sends the connection ID, the transaction ID, the URL information, the WS data type, the data for specifying an application, and the result notification flag to the client 100 via the communication interface 260 over the WebSocket protocol (step S714).

The client API 110B receives the data from the constant connection server 200 via the communication interface 160 over the WebSocket protocol. The client API 110B analyzes the received data (step S716).

By using the received URL information and transaction ID, the client API 110B requests the application server 300 for data via the communication interface 160 over the HTTP protocol (step S718). In response to the request, the server API 310B assembles the data to be the sent to the client 100 (step S720). The server API 310B sends main data to the client 100 via the communication interface 360 over the HTTP protocol (step S722). Specifically, the client API 110B via the communication interface 260 downloads data from the application server 300 at the location indicated by the URL, using the HTTP protocol.

The client API 110B analyzes the received data (step S724). The client API 110B transfers the received data to the client APP 100A (step S726). The client API 110B checks the result notification flag (step S728).

The client API 110B notifies the application server 300 via the communication interface 160 that the data has been received by the client, using the HTTP protocol (step S732). Specifically, the client API 110B sends the transaction ID and a data push result status to the application server 300. The server API 310B transfers the transaction ID and the data push result status to the server APP 310A (step S734).

The foregoing described the case where the application server 300 determines the data size in the manner represented in FIGS. 21 and 22. However, the data size may be determined by the constant connection server 200, as in FIGS. 6 and 7.

Further, instead of the client 100 downloading large volume data from the application server 300 in the manner described with reference to FIG. 22, the client 100 may download the data from the constant connection server 200 or some other Web server, as in FIG. 7. That is, the system may be configured so that the application server 300 sends data to the constant connection server 200 or some other Web server, and the client 100 downloads the data from the constant connection server 200 or some other Web server.

<Details of Procedures for Normal Data Pushing Operation from Client>

The following describes details of the procedures for pushing data from client 100 in the network system 1 according to the present embodiment. Specifically, the data pushing procedures in the network system 1 according to the present embodiment will be separately described for normal (small volume) data pushing operation and large volume data pushing operation from client 100.

Examples of the small volume data sent from the client 100 include text files such as date log, and small image/audio/video files (such as camera image, and audio for voice recognition). Examples of the large volume data sent from the client 100 include text files such as large logs retained for longer than several days, and large image/audio/video files.

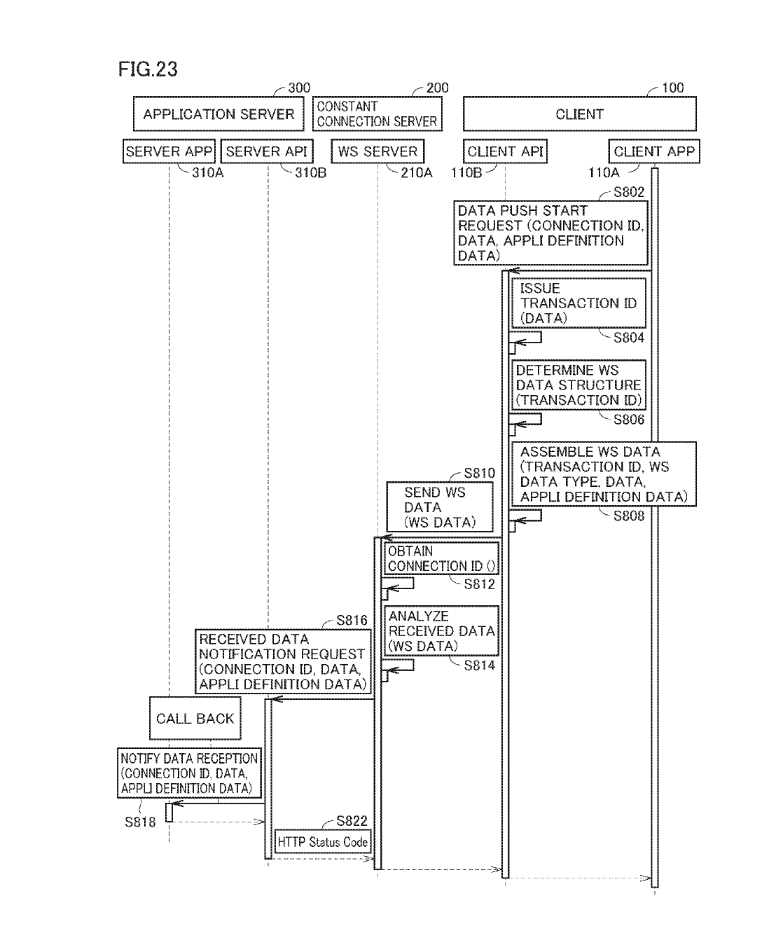

The normal data pushing procedures from the client 100 in the network system 1 according to the present embodiment are described below in detail. FIG. 23 is a sequence diagram representing details of the normal data pushing procedures from the client 100 in the network system 1 according to the present embodiment.

Referring to FIG. 23, the client APP 110A requests the client API 110B to push data (step S802). Specifically, the client APP 110A transfers a connection ID for specifying itself, main data, and data for specifying an application to the client API 110B. The server API 310B issues a transaction ID (step S804).

The client API 110B determines the WS data structure (step S806). In the present embodiment, the client API 110B determines whether the main data volume is larger than a predetermined value. Alternatively, the client API 110B determines whether the total data volume to be sent to the constant connection server 200 is larger than a predetermined value. The following describes the case where the data volume is no larger than the predetermined value.

The client API 110B reconstructs the WS data containing the connection ID, the transaction ID, the WS data type, the main data, and the data for specifying an application to accommodate the WebSocket protocol (step S808). The client API 110B sends the assembled WS data to the constant connection server 200 via the communication interface 160 over the WebSocket protocol (step S810).

The WS server 210A obtains the connection ID from the WS data (step S812). The WS server 210A analyzes the received WS data (step S814). The WS server 210A sends the data sent from the client 100, via the communication interface 260 (step S816). More specifically, the WS server 210A sends the connection ID of the client 100, the main data, and the data for specifying an application to the application server 300 via the communication interface 160 over the HTTP protocol.

The server API 310B transfers the received data to the server APP 310A (step S818). The server API 310B sends the data containing the transaction ID via the communication interface 360 to notify the constant connection server 200 that the application server 300 has received the main data (step S822). The WS server 210A sends the data containing the transaction ID via the communication interface 360 to notify that the application server 300 has received the main data, using the WebSocket protocol.

<Details of Procedures for Large Volume Data Pushing Operation from Client>

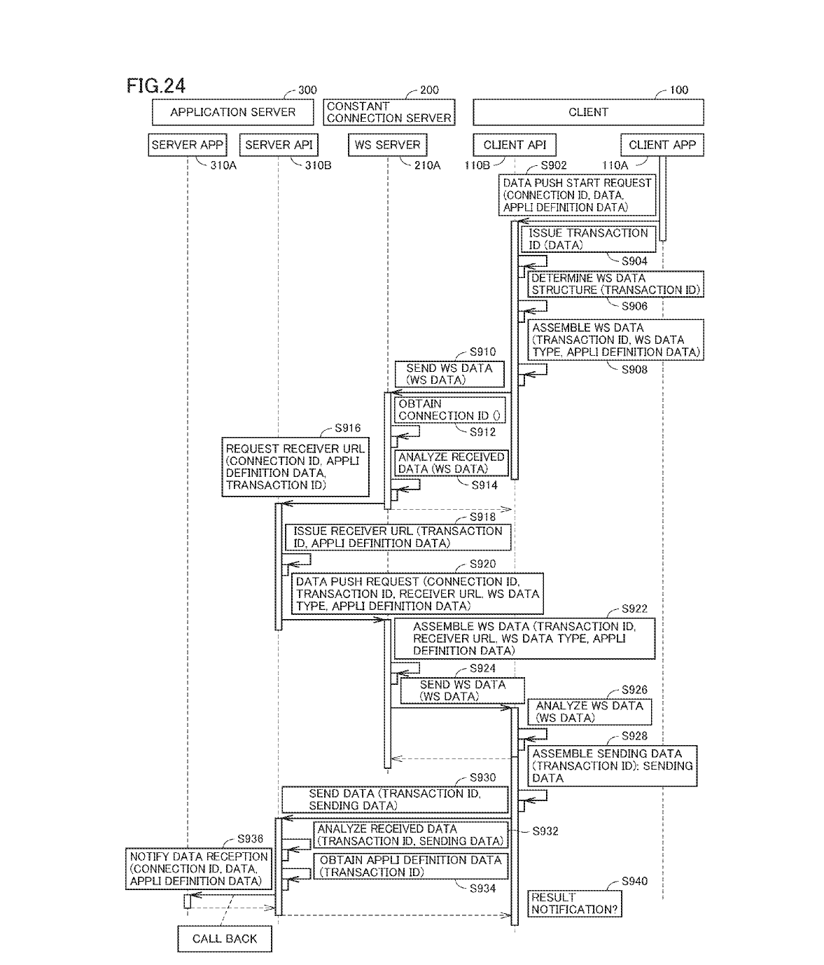

The following describes the procedures for pushing large volume data from client 100 in the network system 1 according to the present embodiment. FIG. 24 is a sequence diagram representing details of the procedures for pushing large volume data from client 100 in the network system 1 according to the present embodiment.

Referring to FIG. 24, the client APP 110A request the client API 110B to push data (step S902). Specifically, the client APP 110A transfers a connection ID for specifying the client 100, main data, and data for specifying an application to the client API 110B. The client API 110B issues a transaction ID (step S904).

The client API 110B determines the WS data structure (step S906). In the present embodiment, the client API 110B determines whether the main data volume is larger than a predetermined value. Alternatively, the client API 110B determines whether the total data volume to be sent to the constant connection server 200 is larger than a predetermined value. The following describes the case where the data volume is larger than the predetermined value.

The client API 110B reconstructs the WS data containing the connection ID, the transaction ID, the WS data type, the data for specifying an application, and the data volume to accommodate the WebSocket protocol (step S908). The client API 110B sends the assembled WS data to the constant connection server 200 via the communication interface 160 over the WebSocket protocol (step S910).

The WS server 210A obtains the connection ID from the received WS data (step S912). The WS server 210A analyzes the received WS data (step S914). The WS server 210A via the communication interface 260 requests the application server 300 for the receiving URL of the main data (step S916). Specifically, the WS server 210A sends the connection ID, the application definition data, and the transaction ID to the application server 300 via the communication interface 260.

In response to the request from the constant connection server 200, the server API 310B issues a URL for uploading (step S918). The server API 310B via the communication interface 360 requests the constant connection server 200 to push data to the client 100 (step S920). Specifically, the server API 310B sends the connection ID, the transaction ID, the receiving URL, the WS data type, and the information for specifying an application to the constant connection server 200 via the communication interface 360 over the HTTP protocol.

The WS server 210A assembles data to accommodate the WebSocket protocol by using the information received from the application server 300 (step S922). The WS server 210A sends the WS data to the client 100 via the communication interface 260 over the WebSocket protocol (step S924).

The client API 110B analyzes the WS data (step S926). The client API 110B assembles sending (uploading) data by using the main data (step S928). By using the URL information, the client API 110B uploads the main data and the transaction ID to the receiving URL of the application server 300 via the communication interface 160 over the HTTP protocol (step S930).

The server API 310B analyzes the received data (step S932). The server API 310B obtains the transaction ID and the main data (step S934). The server API 310B transfers the connection ID, the main data, and the information for specifying an application to the server APP 310A (step S936).

The server API 310B sends the data containing the transaction ID via the communication interface 360 to notify the constant connection server 200 that the application server 300 has received the main data. The WS server 210A sends the data containing the transaction ID via the communication interface 260 to notify that the application server 300 has received the main data, using the WebSocket protocol (step S940).

The foregoing described the case where the client 100 uploads large volume data to the application server 300 in the manner described with reference to FIG. 24. However, the client 100 may upload the data to the constant connection server 200 or some other server, as in FIG. 9. The constant connection server 200 or some other server may then send the data to the application server 300.

The foregoing described the various procedures of the network system 1. The network system 1 according to the present embodiment enables data from the application server 300 to be pushed to a selected client 100 by using a connection ID. The burden on the network system can be reduced because the client 100 and the application server 300 mutually push data via the constant connection server 200. Further, because the protocols are switched according to the transmitted data volume, communications using the WebSocket protocol are less likely to be occupied by some of the data sent and received, and it is less likely that sending and receiving of other Websocket data is obstructed.

### Second Embodiment

The following describes Second Embodiment. In the network system 1 according to First Embodiment, at least one of the client 100 and the constant connection server 200 uses the common HTTP protocol and the WebSocket protocol for different purposes. More specifically, at least one of the client 100 and the constant connection server 200 sends and receives data over the HTTP protocol when the transmitted data volume is larger than the predetermined value, and sends and receives data over the WebSocket protocol when the transmitted data volume is no larger than the predetermined value.

In the present embodiment, however, the protocol is appropriately determined on the basis of the communication speed, not the data volume. The data requiring high communication speeds in the transmitted data from the application server 300 are, for example, command data for which a command needs to be immediately issued (such as in turning on and off an air conditioner), and image/audio/video files that need immediate playback (urgent messages such as an earthquake early warning). On the other hand, the data transmitted by the client 100 require high communication speeds when, for example, image and sound data need to be immediately played at the terminal (smartphone) side.

The following describes the present embodiment in detail. First, the server API 310B in the present embodiment determines in step S606 of FIG. 21 and step S706 of FIG. 22 whether the current communication speed over the WebSocket protocol is below a predetermined value. Alternatively, the server API 310B determines whether the communication speed of the data of interest to be sent over the WebSocket protocol is below a predetermined value.

Specifically, the server API 310B may send a speed check signal (ping) to the client 100 via the communication interface 360, and count the time to receive a response signal (pong) and calculate the communication speed. Alternatively, the server API 310B may cause the WS server 210A to perform the same calculation to find the communication speed.

The sequence beginning with step S608 describes the case where the communication speed is at or greater than the predetermined value. The sequence beginning with step S708 describes the case where the communication speed is below the predetermined value.

Similarly, the client API 110B in the present embodiment determines in step S806 of FIG. 23 and step S906 of FIG. 24 whether the current communication speed over the WebSocket protocol is below a predetermined value. Alternatively, the client API 110B determines whether the communication speed of the data of interest to be sent over the WebSocket protocol is below a predetermined value.

The sequence beginning with step S808 describes the case where the communication speed is at or greater than the predetermined value. The sequence beginning with step S908 describes the case where the communication speed is below the predetermined value.

The embodiment has been described through the case where the application server 300 makes the decision. However, the decision may be made by the constant connection server 200, as with the case of FIGS. 6 and 7.

### Third Embodiment

The following Third Embodiment describes switching of protocols. In the present embodiment, the protocol is appropriately determined on the basis of the transmission time, as follows. The following describes the present embodiment in detail.

First, the server API 310B in the present embodiment determines in step S606 of FIG. 21 and step S706 of FIG. 22 whether the transmission time of the data of interest to be sent over the WebSocket protocol will be longer than a predetermined value. The sequence beginning with step S608 describes the case where the transmission time is no longer than the predetermined value. The sequence beginning with step S708 describes the case where the transmission time is longer than the predetermined value.

Similarly, the client API 110B in the present embodiment determines in step S806 of FIG. 23 and step S906 of FIG. 24 whether the transmission time of the data of interest to be sent over the WebSocket protocol will be longer than a predetermined value. The sequence beginning with step S808 describes the case where the transmission time is no longer than the predetermined value. The sequence beginning with step S908 describes the case where the transmission time is longer than the predetermined value.

The embodiment has been described through the case where the application server 300 makes the decision. However, the decision may be made by the constant connection server 200, as with the case of FIGS. 6 and 7.

### Fourth Embodiment

The following Fourth Embodiment also describes switching of protocols. In the present embodiment, the protocol is appropriately determined on the basis of the frequency of data transmission and reception over the WebSocket protocol. The transmitted data from the application server 300 have high transmission and reception frequency in, for example, condition check data. The transmitted data from the client 100 has high transmission and reception frequency in, for example, condition check data and log data.

The following describes the present embodiment in detail. First, the server API 310B in the present embodiment determines in step S606 of FIG. 21 and step S706 of FIG. 22 whether the frequency of the data sent and received over the WebSocket protocol is greater than a predetermined value. For example, the server API 310B counts the number of times data is sent and received in one minute over the WebSocket protocol between the constant connection server 200 and the client 100. Alternatively, the server API 310B obtains from the WS server 210A the number of times data is sent and received in one minute over the WebSocket protocol between the constant connection server 200 and the client 100. The sequence beginning with step S608 describes the case where the count is no greater than the predetermined value. The sequence beginning with step S708 describes the case where the count is greater than the predetermined value.

Similarly, the client API 110B in the present embodiment determines in step S806 of FIG. 23 and step S906 of FIG. 24 whether the frequency of the data sent and received over the WebSocket protocol is greater than a predetermined value. For example, the client 100 counts the number of times data is sent and received in one minute over the WebSocket protocol between the constant connection server 200 and the client 100. The client 100 determines whether the count is greater than the predetermined value. The sequence beginning with step S808 describes the case where the count is no greater than the predetermined value. The sequence beginning with step S908 describes the case where the count is greater than the predetermined value.

The embodiment has been described through the case where the application server 300 makes the decision. However, the decision may be made by the constant connection server 200, as with the case of FIGS. 6 and 7.

### Fifth Embodiment

Fifth Embodiment is described below. In the network systems 1 according to the foregoing First to Fourth Embodiments, the constant connection server 200 serves as the WS server 210A that controls the sending and receiving of data with the client 100, and the application servers 300 function as the server APP 310A (program), and the server API 310B that generates authentication information.

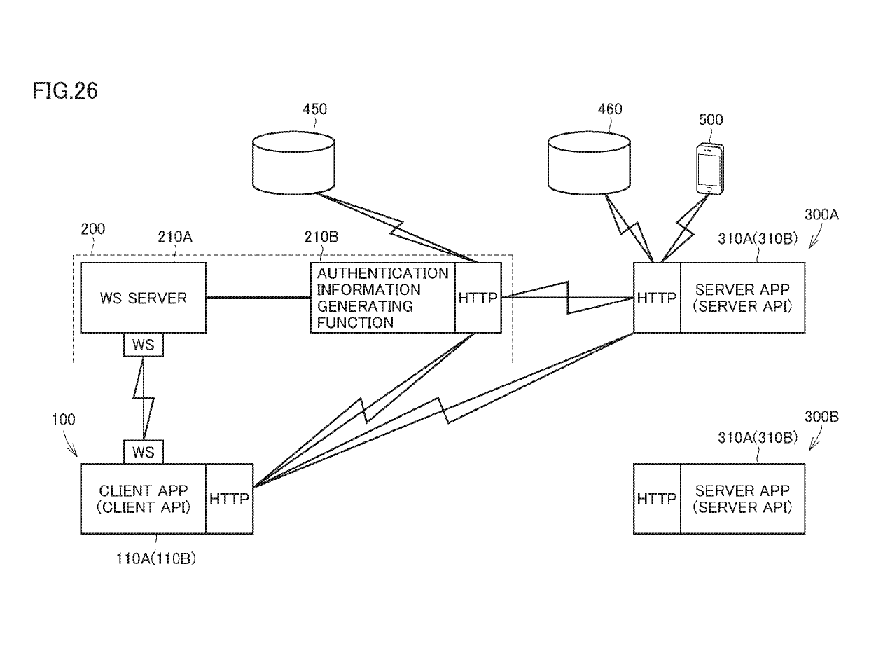

In the present embodiment, however, the constant connection server 200 has an authentication information generating function 210B. FIG. 26 is a schematic diagram representing the communication configuration of the network system 1 according to Fifth Embodiment.

### Sixth Embodiment

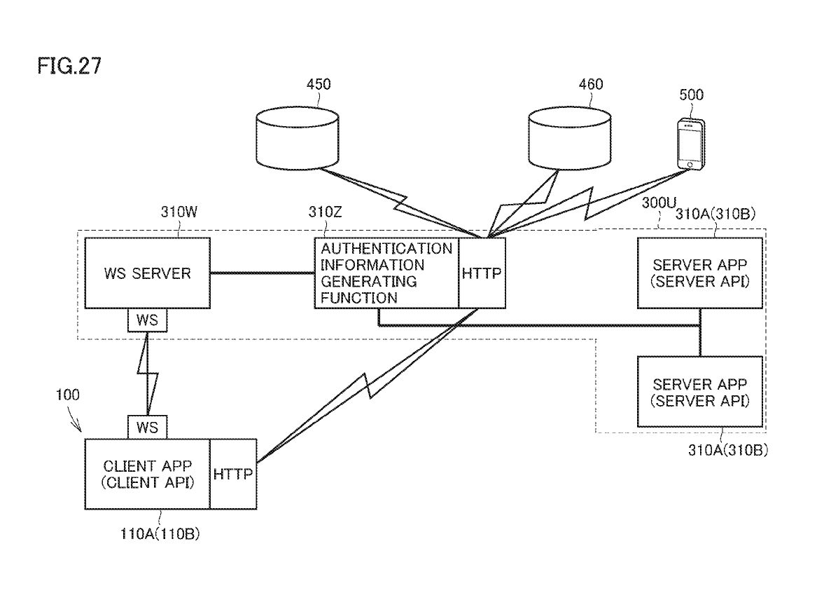

Sixth Embodiment is described below. In the present embodiment, the application server 300U has a WS server 310W function, an authentication information generating function 310Z, and two server functions (two servers APP 310A). FIG. 27 is a schematic diagram representing the communication configuration of the network system 1 according to Seventh Embodiment. In the network system 1 according to the present embodiment, the client 100 has the same configuration as that described in First Embodiment, and will not be described further.

Referring to FIG. 27, the application server 300U has a WS server 310W (program) function for controlling WebSocket protocol communications, an authentication information generating function 310Z, a server APP 310A function (first service program), and an APP 310A function (second service program). The two servers APP 310A can each communicate with other devices such as database and a smartphone 500 over the HTTP protocol. The servers APP 310A can also push information to the client 100 over the WebSocket protocol using the WS server 310W.

### Seventh Embodiment

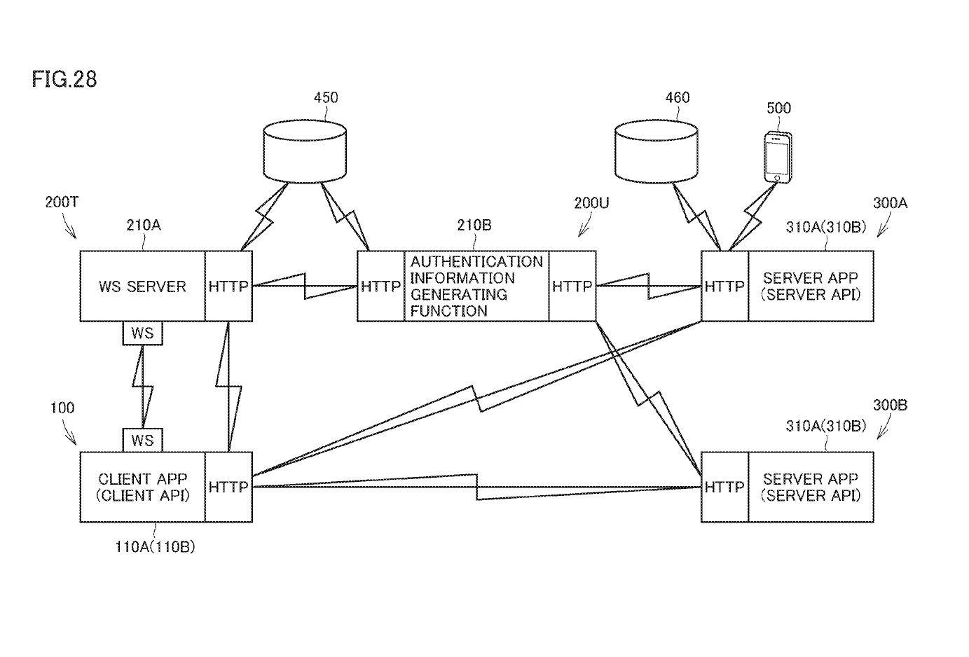

Seventh Embodiment is described below. The present embodiment differs from Fifth and Sixth Embodiments in that the WS server function, the authentication information generating function, and the two server APP functions are installed in different computers. FIG. 28 is a schematic diagram representing the communication configuration of the network system 1 according to Eighth Embodiment.

Referring to FIG. 28, the client 100 may communicate with a constant connection server 200T, an authentication information generating server 200U, and application servers 300A and 300B over the HTTP protocol, and may constantly connect to the constant connection server 200T over the WebSocket protocol. More specifically, the client 100 has client APP 110A and client API 110B. The client APP 110A controls each part of the client 100. The client API 110B communicates via the communication interface 160 over the HTTP protocol, or communicates over the WebSocket protocol on the HTTP protocol.

The constant connection server 200T has a WS server 210A (program) for controlling the constant connection communications with the client 100 over the WebSocket protocol. The constant connection server 200T may access other database 450 over the HTTP protocol.

The authentication information generating server 200U controls communications with the plurality of application servers 300 over the HTTP protocol. In the present embodiment, the constant connection server 200T may send data to the application servers 300A and 300B at any timing via the authentication information generating server 200U over the HTTP protocol.

The network systems 1 according to Second to Seventh Embodiments also include a plurality of application servers, 300A and 300B. The application servers 300A and 300B each include a server APP 310A (program) for providing services to devices such as the client 100 and the smartphone 500, and a server API 310B for communicating with the constant connection server 200 over the HTTP protocol.

For example, the network system 1 includes an application server 300A for controlling a vacuum cleaner 100A, and an application server 300B for controlling an air conditioner 100B. The application servers 300A and 300B may each communicate with devices such as the constant connection server 200, other database, and the smartphone 500 over the HTTP protocol. In the present embodiment, the application servers 300A and 300B may send data to the constant connection server 200 at any timing over the HTTP protocol.

### Eighth Embodiment

In the foregoing First to Fourth Embodiments, the decision whether to send data over the WebSocket protocol or the HTTP protocol is based on one criterion. However, the client 100, the constant connection server 200, and the application server 300 may make the decision according to two or more criteria. In the following, the client 100, the constant connection server 200, and the application server 300 will also be collectively called computers for the sake explanation.

For example, the computer may decide according to the criteria of First and Second Embodiments. The computer may upload or download data over the HTTP protocol when the conditions of First and Second Embodiments are both satisfied. Alternatively, the computer may upload or download data over the HTTP protocol when at least one of the conditions of First and Second Embodiments is satisfied.

Similarly, the computer may decide according to the criteria of First and Third Embodiments, the criteria of First and Fourth Embodiments, the criteria of Second and Third Embodiments, the criteria of Second and Fourth Embodiments, or the criteria of Third and Fifth Embodiments.

Further, the decision by the computer may be based on three or more criteria. The computer may upload or download data over the HTTP protocol when all or some of the conditions are satisfied.

### Ninth Embodiment

### Overall Configuration of Network System

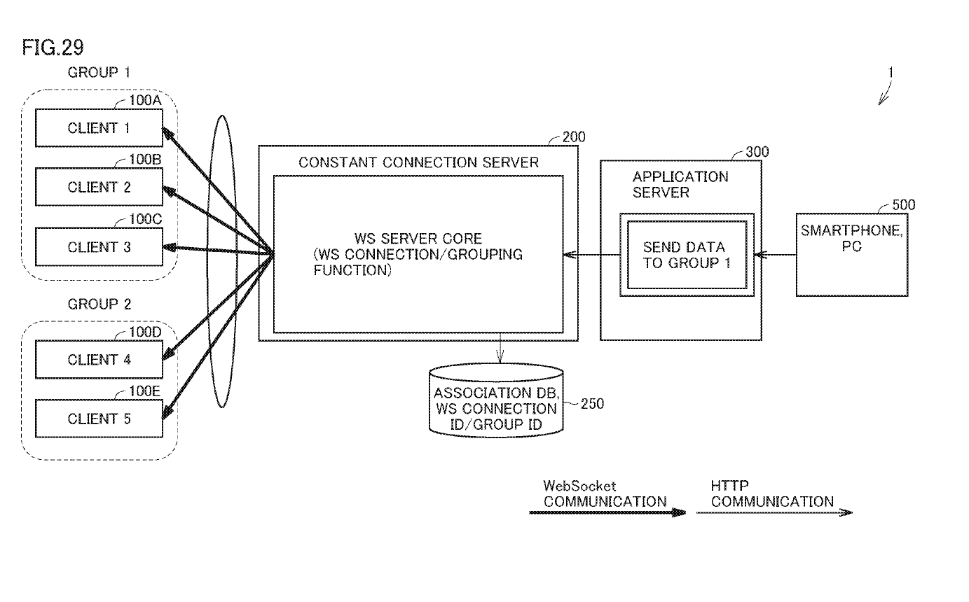

The overall configuration of the network system 1 according to the present embodiment is described below. FIG. 29 is a schematic diagram representing the overall configuration and operation of the network system 1 according to the present embodiment.

Referring to FIG. 29, the network system 1 includes a plurality of clients 100A, 100B, 100C, 100D, and 100E provided in places such as homes and offices. In the following, the clients 100A, 100B, 100C, 100D, and 100E will also be collectively called “clients 100”. The network system 1 also includes a constant connection server 200 that can constantly connect to the clients 100, an application server 300 for providing various services, and a smartphone 500 and/or a personal computer, among others.

Examples of the clients 100 include home appliances such as vacuum cleaners, televisions, air conditioners, washing machines, refrigerators, rice cookers, air purifiers, floor heating systems, IH (Induction Heating) cooking heaters, microwave ovens, and illuminations. The clients may be any communications devices, including, for example, personal computers, audio-video equipment other than television, and an intercom system.

The constant connection server 200 and the application server 300 may include servers that reside in the same home, office, building, company, or school where any of the clients are provided.

The clients 100 and each server may be connected to each other via lines such as optical fibers, with an optical network unit, a wireless LAN communication access point, and a router optionally connected in between. The means by which the clients 100 are connected to the network is not limited, and may be, for example, wireless LAN communications such as IEEE 802.11a/b/g/n/ac, and wired LAN.

In the present embodiment, the constant connection server 200 and the application server 300 are different computers. However, the constant connection server 200 and the application server 300 may be the same computer. For example, a single computer, specifically a server in the form of a device may contain a communications service program for constantly connecting to the clients, and an application service program for controlling the clients. A single application server may contain a plurality of application service programs.

### <Brief Overview of Network System Operation>

The following is a brief overview of the operation of the network system 1 according to the present embodiment. In the present embodiment, the clients 100 are divided into groups. Specifically, data indicative of the grouping are stored in an association DB server connectable to the constant connection server 200, or in the constant connection server 200 itself. The application server 300 provides services on which data from devices such as the smartphone 500 and external personal computers are delivered to the clients 100.

First, the smartphone 500, an external personal computer, or other such device sends the application server 300 a group ID for specifying a group, and main data to be sent to the group. The application server 300 sends the constant connection server 200 the group ID for specifying a group, and the main data to be sent to the group. By referring to the association DB, the constant connection server 200 pushes the main data to the clients 100 associated with the group ID, using the WebSocket protocol.

Alternatively, any of the clients 100 sends the constant connection server 200 a group ID for specifying a group, and main data to be sent to the group. By referring to the association DB, the constant connection server 200 pushes the main data to the clients 100 associated with the group ID, using the WebSocket protocol. Here, the constant connection server 200 may send the main data as log information to the application server 300. The constant connection server 200 also may send the main data to the smartphone 500 via the application server 300.

As described above, in the present embodiment, the smartphone 500, an external personal computer, the application server 300, and the clients 100 can push data to only the clients 100 of the desired group from among the clients 100 constantly connected to the constant connection server 200. The following specifically describes the configuration by which such a function is realized in the network system 1.

### <Hardware Configuration of Client 100>

An aspect of the hardware configuration of the client 100 is the same as the hardware configuration described for the client 100 of First Embodiment with reference to FIG. 11, and will not be described further.

### <Hardware Configuration of Constant Connection Server 200>

An aspect of the hardware configuration of the constant connection server 200 is the same as the hardware configuration described for the constant connection server 200 of First Embodiment with reference to FIG. 12, and will not be described further.

### <Association DB>

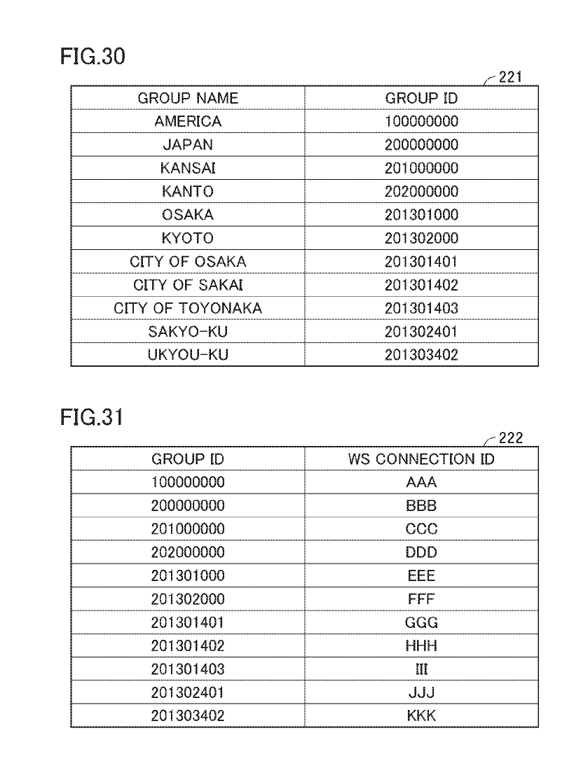

In the present embodiment, the association DB (database) server 250 separately provided from the constant connection server 200 stores an association DB 221 of group names and group IDs, as shown in FIGS. 29 and 30. The association DB 221 may be stored in the memory 220 of the constant connection server 200.

As shown in FIGS. 29 and 31, the association DB server 250 stores an association DB 222 of group IDs and connection IDs. The connection IDs are information for specifying the relationship between the clients 100 and the services provided by the application server 300. The association DB 222 may be stored in the memory 220 of the constant connection server 200.

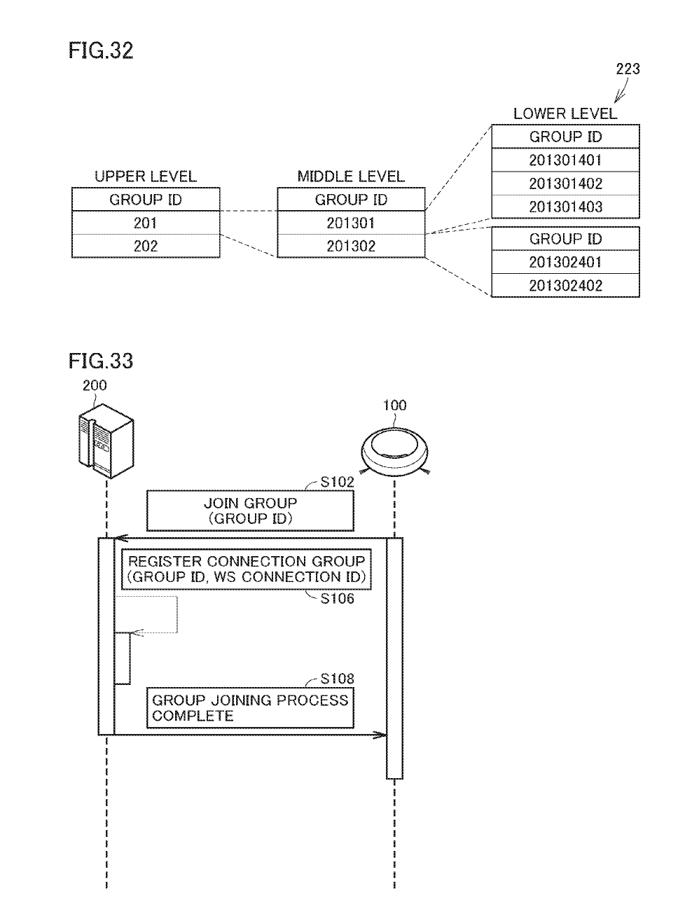

In the present embodiment, the association DB server 250 stores an association DB 223 as a hierarchy of groups, as shown in FIGS. 29 and 32. For example, the association DB 223 stores middle-level group IDs associated with each group ID of the upper level. The association DB 223 also stores lower-level group IDs associated with each group ID of the middle level. Further down the hierarchy, the association DB 223 may also store group IDs associated with each lower-level group ID, though not shown in FIG. 32. The association DB 223 may be stored in the memory 220 of the constant connection server 200.

### <Hardware Configuration of Application Server 300>

An aspect of the hardware configuration of the application server 300 is the same as the hardware configuration described for the application server 300 of First Embodiment with reference to FIG. 13, and will not be described further.

### <Hardware Configuration of Smartphone 500>

An aspect of the hardware configuration of the communications device such as the smartphone 50 and external personal computers is the same as the hardware configuration described for the constant connection server 200 of First Embodiment with reference to FIG. 14, and will not be described further.

### <Data Exchange Between Devices Concerning Constant Connection>

The data exchange between devices concerning the constant connection in the network system 1 according to the present embodiment is the same as the data exchange between devices concerning the constant connection in the network system 1 according to First Embodiment described in FIG. 15, and will not be described further.

The operation of the client 100 in FIG. 15 is realized by the client API 110A. Referring to FIGS. 11 and 15, the client API 110A is realized by the execution of a program by the CPU 110 of the client 100. The client API 110A communicates with the constant connection server 200 via the communication interface 160 over the WebSocket protocol. The client API 110A communicates with the constant connection server 200 and the application server 300 via the communication interface 160 over the HTTP protocol.

Similarly, the operation of the constant connection server 200 in FIG. 15 is realized by the WS server 210A. Referring to FIGS. 12 and 15, the WS server 210A is realized by the execution of a program by the CPU 210 of the constant connection server 200. The WS server 210A constantly connects to the client 100 via the communication interface 260 over the WebSocket protocol. The WS server 210A communicates with the application server 300 via the communication interface 260 over the HTTP protocol.

Similarly, the operation of the application server 300 in FIG. 15 is realized by the server API 310A. Referring to FIGS. 13 and 15, the server API 310A is realized by the execution of a program by the CPU 310 of the application server 300. The server API 310A communicates with the client 100, the constant connection server 200, and other communication devices such as the smartphone 500 via the communication interface 360 over the HTTP protocol.

### <Details of Procedures for Client Joining a Group>

The following describes details of the procedures for a client 100 joining a group in the network system 1 according to the present embodiment. FIG. 33 is a sequence diagram representing details of the procedures for a client 100 joining a group in the network system 1 according to the present embodiment.

Referring to FIG. 33, the client 100 sends a group joining request to the constant connection server 200 (step S102). Specifically, the CPU 110 of the client 100 sends a group joining request to the constant connection server 200 via the communication interface 160 over the WebSocket protocol. The group joining request contains a group ID for specifying a group.

The CPU 110 of the client 100 may send a group joining request to the constant connection server 200 via the communication interface 160 over the HTTP protocol. In this case, the group joining request also contains a connection ID for specifying the client 100.

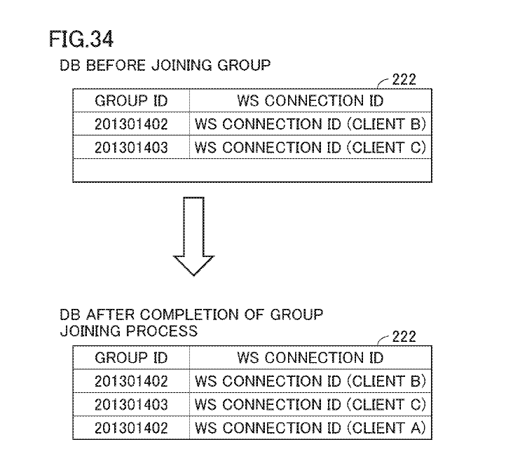

The constant connection server 200 stores the connection ID for specifying the client 100 in the association DB 222 in association with the group ID (step S106). Specifically, as shown in FIG. 34, the CPU 210 adds a combination of the connection ID and the group ID to the association DB 222.

The constant connection server 200 sends the client 100 data indicative of the completion of the group joining process (step S108). Specifically, the CPU 210 sends the data to the client 100 via the communication interface 260 over the WebSocket protocol.

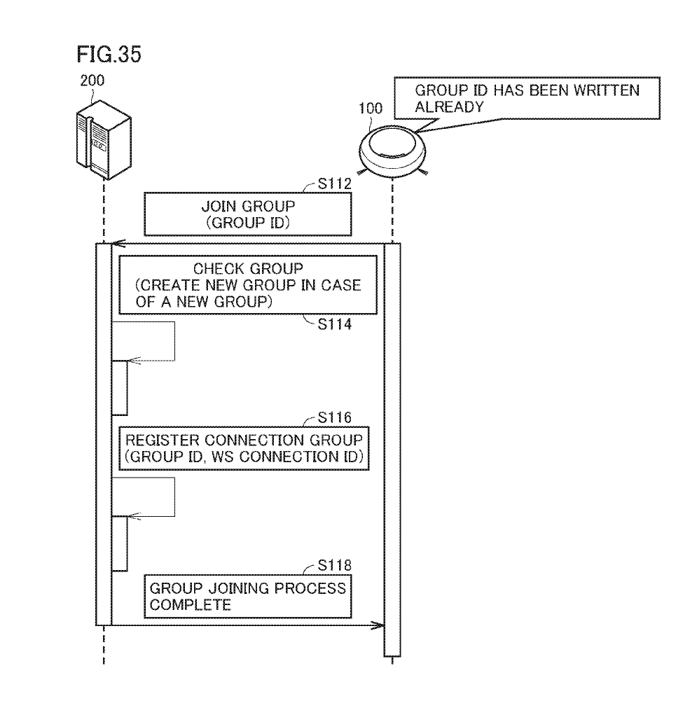

The following more specifically describes the procedures for a client 100 to join a group. The procedures for joining a group when a group ID is previously written into a client 100 are described first. FIG. 35 is a sequence diagram representing details of the procedures for joining a group when a group ID is previously written into a client 100 according to the present embodiment.

Referring to FIG. 35, for example, the client 100 sends a group joining request to the constant connection server 200 upon turning on power (step S112). Specifically, the CPU 110 of the client 100 reads out a group ID from the memory 120 upon turning on power. The CPU 110 then sends a group joining request to the constant connection server 200 via the communication interface 160 over the WebSocket protocol. The group joining request contains the group ID for specifying a group.

The CPU 110 of the client 100 may send a group joining request to the constant connection server 200 via the communication interface 160 over the HTTP protocol. In this case, the group joining request also contains a connection ID for specifying the client 100.

The CPU 210 of the constant connection server 200 determines whether the received group ID is contained in the association DB 222 (step S114). When the received group ID is not contained in the association DB 222, the CPU 110 creates a new group ID, and adds it to the association DB 221 and the association DB 222. The CPU 210 may deny the group joining request when the received group ID is not contained in the association DB 222.

When the received group ID is contained in the association DB 222, the CPU 210 stores the connection ID for specifying the client 100 in the memory 220 in association with the group ID (step S116). Specifically, as shown in FIG. 34, the CPU 210 adds a combination of the connection ID and the group ID to the association DB 222.

The constant connection server 200 sends the client 100 data indicative of the completion of the group joining process (step S118). Specifically, the CPU 210 sends the data to the client 100 via the communication interface 260 over the WebSocket protocol.

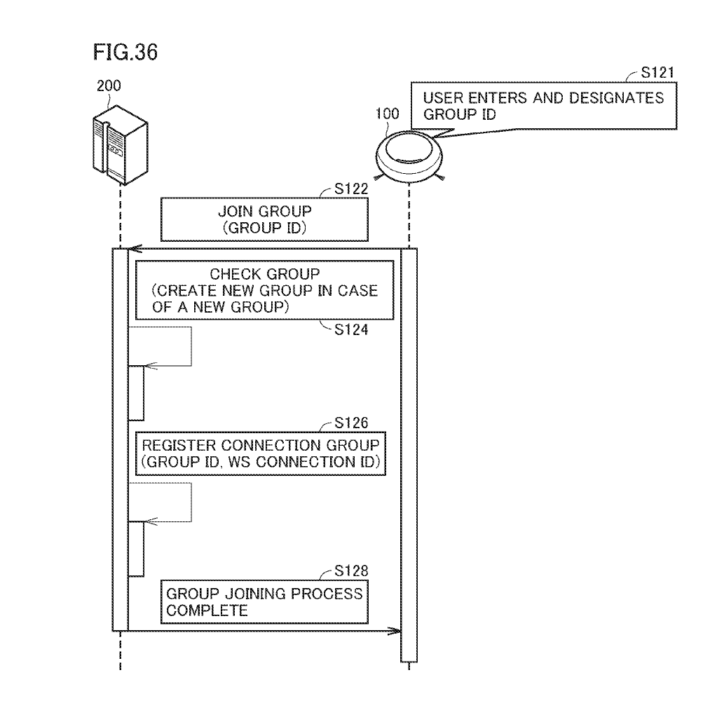

The procedures for joining a group designated by a user are described below in detail. Specifically, the following describes the case where a user is allowed to enter the desired group ID to the client 100. FIG. 36 is a sequence diagram representing details of the procedures for joining a group designated by a user according to the present embodiment.

Referring to FIG. 36, for example, the client 100 accepts entry of a group ID from a user (step S121). Specifically, the CPU 110 accepts entry of a group ID via the input/output unit 130. The CPU 110 sends a group joining request to the constant connection server 200 via the communication interface 160 over the WebSocket protocol (step S122). The group joining request contains the group ID for specifying a group.

The CPU 110 of the client 100 may send a group joining request to the constant connection server 200 via the communication interface 160 over the HTTP protocol. In this case, the group joining request contains a connection ID for specifying the client 100.

The CPU 210 of the constant connection server 200 determines whether the received group ID is contained in the association DB 222 (step S124). When the received group ID is not contained in the association DB 222, the CPU 210 creates a new group ID, and adds it to the association DB 221 and the association DB 222. The CPU 210 may deny the group joining request when the received group ID is not contained in the association DB 222.

When the received group ID is contained in the association DB 222, the CPU 210 stores the connection ID for specifying the client 100 in the association DB 222 in association with the group ID (step S126). Specifically, as shown in FIG. 34, the CPU 210 adds a combination of the connection ID and the group ID to the association DB 222.

The constant connection server 200 sends the client 100 data indicative of the completion of the group joining process (step S128). Specifically, the CPU 210 sends the data to the client 100 via the communication interface 260 over the WebSocket protocol.

<Details of Procedures for Adding Client with Application Server>

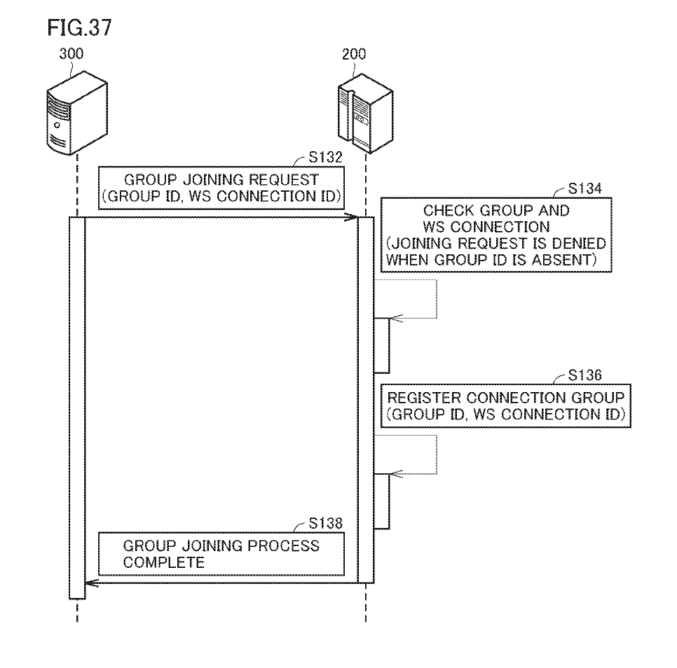

The following describes details of the procedures for adding a client with the application server 300 in the network system 1 according to the present embodiment. FIG. 37 is a sequence diagram representing details of the procedures for adding a client with the application server 300 in the network system 1 according to the present embodiment.

Referring to FIG. 37, the application server 300 sends the constant connection server 200 a request for adding a client 100 to a group (step S132). Specifically, in response to a request from, for example, an administrator or a service application program, the CPU 310 of the application server 300 sends a client joining request to the constant connection server 200 via the communication interface 360 over the HTTP protocol. For example, the client joining request contains a group ID, and the connection ID of the client belonging to the group.

In response to the client joining request, the CPU 210 of the constant connection server 200 determines whether the received group ID is contained in the association DB 222 (step S134). The CPU 210 denies the group joining request when the received group ID is not contained in the association DB 222.

When the received group ID is contained in the association DB 222, the CPU 210 registers a combination of the connection ID and the group ID in the association DB 222, as shown in FIG. 34 (step S136). The constant connection server 200 sends the application server 300 data indicative of the completion of the joining of the client 100 to the group (step S138).

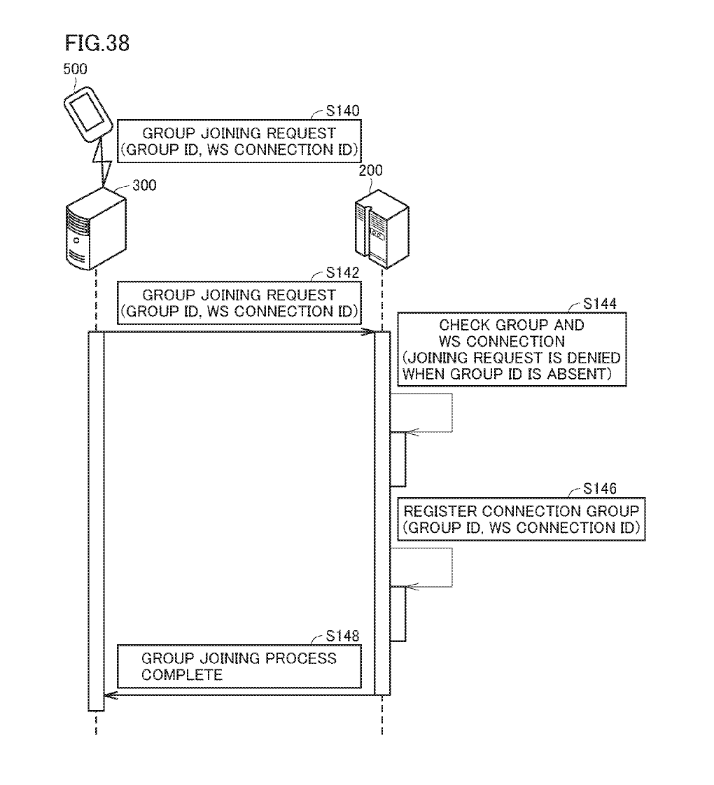

The following describes details of the procedures for creating a group by the smartphone 500 or an external personal computer in the network system 1 according to the present embodiment. FIG. 38 is a sequence diagram representing details of the procedures for adding a client with the smartphone 500 or an external personal computer in the network system 1 according to the present embodiment.

Referring to FIG. 38, in response to a request from a user or an application program, the smartphone 500 or an external personal computer sends the application server 300 a client joining request for adding a client 100 to a group (step S140). The client joining request contains a group ID for specifying a group, and the connection ID of the client belonging to the group.

The application server 300 sends the client joining request to the constant connection server 200 (step S142). Specifically, the CPU 310 of the application server 300 sends the client joining request to the constant connection server 200 via the communication interface 360 over the HTTP protocol.

The CPU 210 of the constant connection server 200 determines whether the group ID contained in the received client joining request is contained in the association DB 222 (step S144). The CPU 210 denies the group joining request when the received group ID is not contained in the association DB 222.

When the received group ID is contained in the association DB 222, the CPU 210 of the constant connection server 200 registers a combination of the group ID and the connection ID of the client belonging to the group in the association DB 221, as shown in FIG. 34 (step S146). The constant connection server 200 sends the application server 300 data indicative of the completion of the joining of the client 100 to the group (step S148).

### <Details of Procedures for Creating New Group>

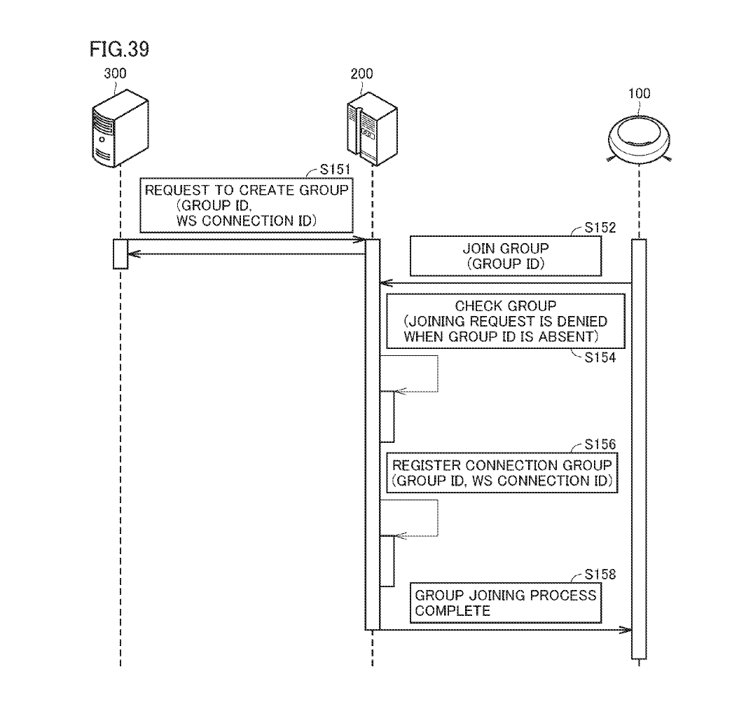

The following describes details of the procedures for creating a group by the application server 300 in the network system 1 according to the present embodiment. FIG. 39 is a sequence diagram representing details of the procedures for creating a group by the application server 300 in the network system 1 according to the present embodiment.

Referring to FIG. 39, the application server 300 sends the constant connection server 200 a request for creating a new group (step S151). Specifically, in response to a request from, for example, an administrator or a service application program, the CPU 310 of the application server 300 sends a group creating request to the constant connection server 200 via the communication interface 360 over the HTTP protocol. For example, the group creating request contains a group name and ID for specifying a new group, and the connection ID of the client that should belong to the new group.

In response to the group creating request, the CPU 210 of the constant connection server 200 adds a combination of the new group name and ID to the association DB 221. The CPU 210 also adds a combination of the new group ID and the connection ID of the client that should belong to the new group to the association DB 222. The CPU 210 notifies the application server 300 via the communication interface 260 that a new group has been successfully created.

In response to a user instruction or a request from the application server 300, the CPU 110 of the client 100 sends a group joining request to the constant connection server 200 via the communication interface 160 over the WebSocket protocol (step S152). The group joining request contains a group ID for specifying the newly created group.

The CPU 210 of the constant connection server 200 determines whether the received group ID is contained in the association DB 222 (step S154). The CPU 210 denies the group joining request when the received group ID is not contained in the association DB 222. When the received group ID is not contained in the association DB 222, the CPU 210 may create a new group ID, and add it to the association DB 221 and the association DB 222.

When the received group ID is contained in the association DB 222, the CPU 210 stores the connection ID for specifying the client 100 in the association DB 222 in association with the group ID (step S156). Specifically, as shown in FIG. 34, the CPU 210 adds a combination of the connection ID and the group ID to the association DB 222.

The constant connection server 200 sends the client 100 data indicative of the completion of the group joining process (step S158). Specifically, the CPU 210 sends the data to the client 100 via the communication interface 260 over the WebSocket protocol.

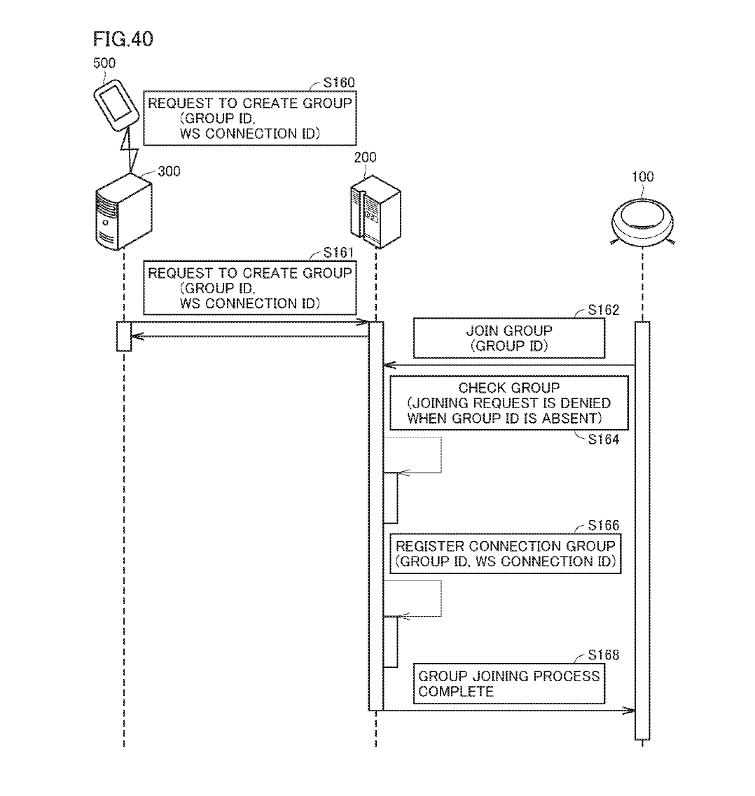

The following describes details of the procedures for creating a group with the smartphone 500 or an external personal computer in the network system 1 according to the present embodiment. FIG. 40 is a sequence diagram representing details of the procedures for creating a group with the smartphone 500 or an external personal computer in the network system 1 according to the present embodiment.

Referring to FIG. 40, in response to a request from a user or an application program, the smartphone 500 or an external personal computer sends the application server 300 a group creating request for creating a new group (step S160). The group creating request contains a group name and ID for specifying a new group, and the connection ID of the client that should belong to the new group.

The application server 300 sends the group creating request to the constant connection server 200 (step S161). Specifically, the CPU 310 of the application server 300 sends the group creating request to the constant connection server 200 via the communication interface 360 over the HTTP protocol. The group creating request contains a group name and ID for specifying a new group, and the connection ID of the client that should belong to the new group.

In response to the group creating request, the CPU 210 of the constant connection server 200 adds a new group ID to the association DB 221. The CPU 210 also adds a combination of the new group ID and the connection ID of the client that should belong to the new group to the association DB 222.

In response to a user instruction or a request from the application server 300, the CPU 110 of the client 100 sends a group joining request to the constant connection server 200 via the communication interface 160 over the WebSocket protocol (step S162). The group joining request contains a group ID for specifying the newly created group.

The CPU 210 of the constant connection server 200 determines whether the received group ID is contained in the association DB 222 (step S164). The CPU 210 denies the group joining request when the received group ID is not contained in the association DB 222. When the received group ID is not contained in the association DB 222, the CPU 210 may create a new group ID, and add it to the association DB 221 and the association DB 222.

When the received group ID is contained in the association DB 222, the CPU 210 stores the connection ID for specifying the client 100 in the association DB in association with the group ID (step S166). Specifically, as shown in FIG. 34, the CPU 210 adds a combination of the connection ID and the group ID to the association DB 222.

The constant connection server 200 sends the client 100 data indicative of the completion of the group joining process (step S168). Specifically, the CPU 210 sends the data to the client 100 via the communication interface 260 over the WebSocket protocol.

<Details of Procedures for Removing Client from Group>

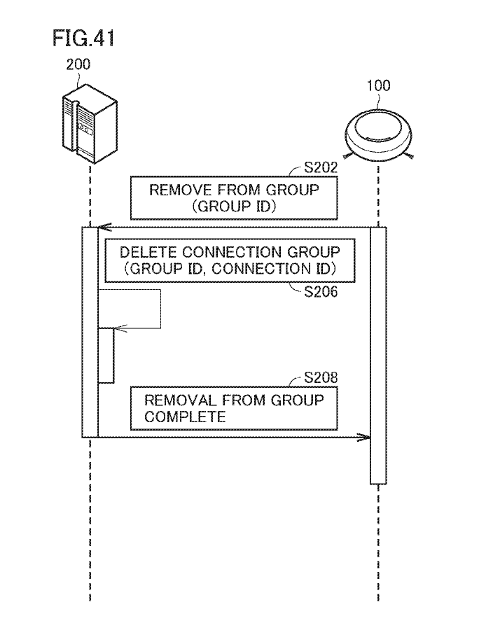

The following describes details of the procedures for removing a client 100 from a group in the network system 1 according to the present embodiment. FIG. 41 is a sequence diagram representing details of the procedures for removing a client 100 from a group in the network system 1 according to the present embodiment.

Referring to FIG. 41, the client 100 sends the constant connection server 200 a request for removal from a group (step S202). Specifically, the CPU 110 of the client 100 sends a request for removal from group to the constant connection server 200 via the communication interface 160 over the WebSocket protocol. The request for removal from group contains a group ID for specifying a group.

The CPU 110 of the client 100 may send the request for removal from group to the constant connection server 200 via the communication interface 160 over the HTTP protocol. In this case, the request for removal from group also contains a connection ID for specifying the client 100.

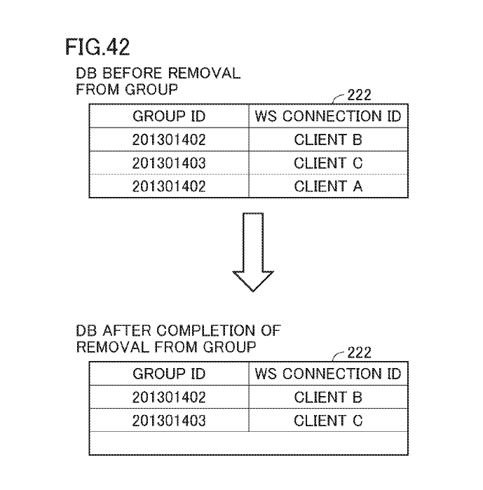

In the constant connection server 200, as shown in FIG. 42, the CPU 210 deletes the combination of the connection ID and the group ID from the association DB 222 (step S206).

The constant connection server 200 sends the client 100 data indicative of the completion of the removal from group (step S208). Specifically, the CPU 210 sends the data to the client 100 via the communication interface 260 over the WebSocket protocol.

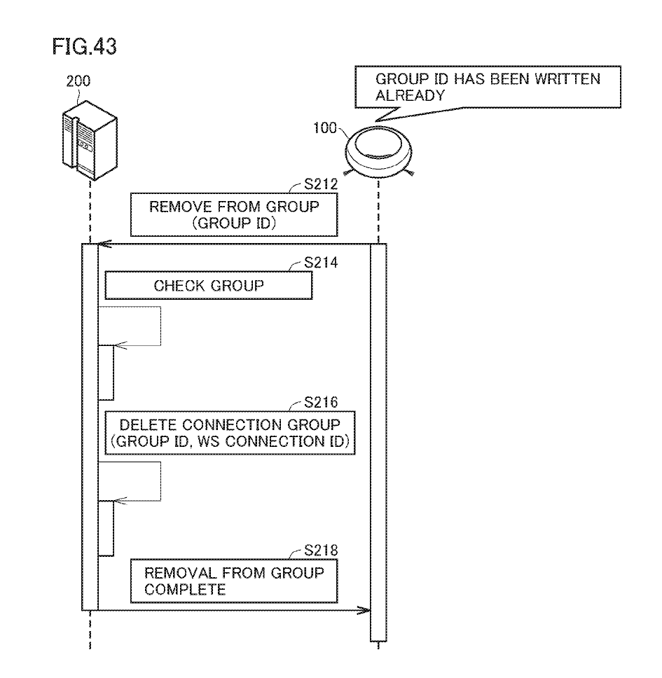

The following more specifically describes the procedures for removing a client 100 from a group. The procedures for removal from a group when a group ID is previously written into the client 100 are described first. FIG. 43 is a sequence diagram representing details of the procedures for removal from a group when a group ID is previously written into the client 100 according to the present embodiment.

Referring to FIG. 43, for example, the client 100 sends the constant connection server 200 a request for removal from a group (step S212). Specifically, the CPU 110 of the client 100 reads out the group ID from the memory 120, for example, upon receiving a reset instruction or a removal instruction from a user via the input/output unit 130. The CPU 110 sends the request for removal from group to the constant connection server 200 via the communication interface 160 over the WebSocket protocol. The request for removal from group contains a group ID for specifying a group.

The CPU 110 of the client 100 may send the request for removal from group to the constant connection server 200 via the communication interface 160 over the HTTP protocol. In this case, the request for removal from group also contains a connection ID for specifying the client 100.

The CPU 210 of the constant connection server 200 determines whether the received group ID is contained in the association DB 222 (step S214). The CPU 110 may deny the request for removal from group when the received group ID is not contained in the association DB 222.

When the received group ID is contained in the association DB 222, the CPU 210 deletes the combination of the connection ID and the group ID from the association DB 222, as shown in FIG. 42 (step S216).

The constant connection server 200 sends the client 100 data indicative of the completion of the removal from group (step S218). Specifically, the CPU 210 sends the data to the client 100 via the communication interface 260 over the WebSocket protocol.

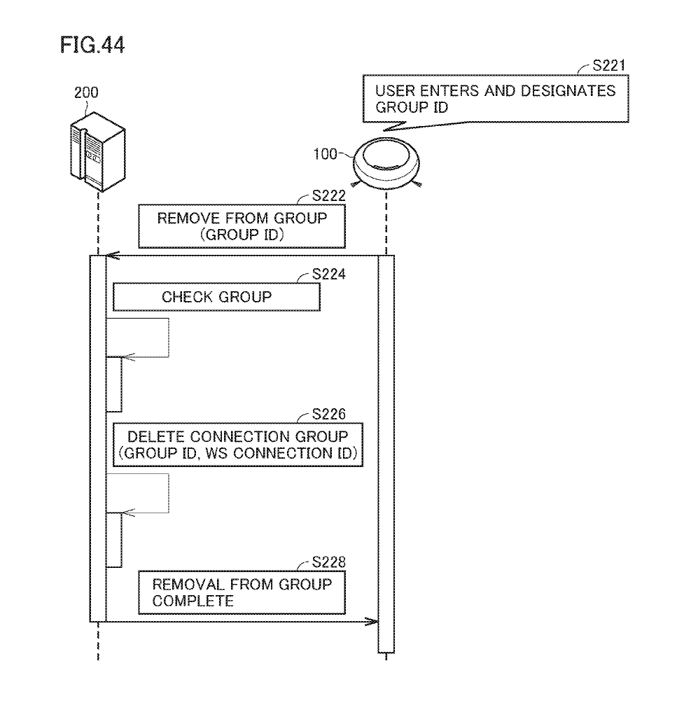

The following describes details of the procedures for removal from a user designated group. FIG. 44 is a sequence diagram representing details of the procedures for removal from a user designated group.

Referring to FIG. 44, for example, the client 100 accepts entry of a group ID from a user (step S221). Specifically, the CPU 110 accepts entry of a group ID via the input/output unit 130. The CPU 110 sends a request for removal from group to the constant connection server 200 via the communication interface 160 over the WebSocket protocol (step S222). The request for removal from group contains the group ID for specifying a group.

The CPU 110 of the client 100 may send the request for removal from group via the communication interface 160 over the HTTP protocol. In this case, the request for removal from group also contains a connection ID for specifying the client 100.

The CPU 210 of the constant connection server 200 determines whether the received group ID is contained in the association DB 222 (step S224). The CPU 210 may deny the request for removal from group when the received group ID is not contained in the association DB 222.

When the received group ID is contained in the association DB 222, the CPU 210 deletes the combination of the connection ID and the group ID from the association DB 222, as shown in FIG. 42 (step S226).

The constant connection server 200 sends the client 100 data indicative of the completion of the removal from group (step S228). Specifically, the CPU 210 sends the data to the client 100 via the communication interface 260 over the WebSocket protocol.

<Details of Procedures for Removing Client with Application Server>

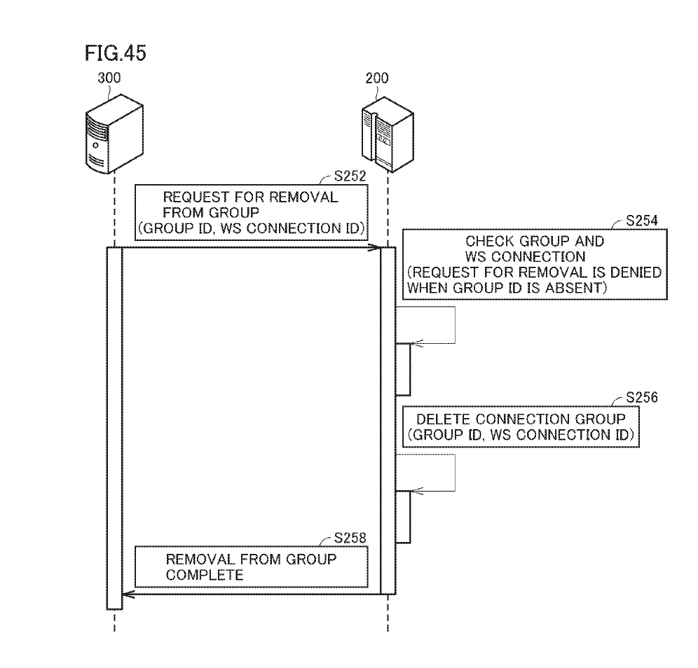

The following describes details of the procedures for removing a client with the application server 300 in the network system 1 according to the present embodiment. FIG. 45 is a sequence diagram representing details of the procedures for removing a client with the application server 300 in the network system 1 according to the present embodiment.

Referring to FIG. 45, the application server 300 sends the constant connection server 200 a request for removing a client 100 (step S252). Specifically, in response to a request from, for example, an administrator or a service application program, the CPU 310 of the application server 300 sends a client removing request to the constant connection server 200 via the communication interface 360 over the HTTP protocol. For example, the client removing request contains a group ID, and the connection ID of the client belonging to the group.

In response to the client removing request, the CPU 210 of the constant connection server 200 determines whether the received group ID is contained in the association DB 222 (step S254). The CPU 210 denies the request for removal from group when the received group ID is not contained in the association DB 222.

When the received group ID is contained in the association DB 222, the CPU 210 deletes the combination of the connection ID and the group ID from the association DB 222, as shown in FIG. 42 (step S256). The constant connection server 200 sends the application server 300 data indicative of the completion of the removal of the client 100 from group (step S258).

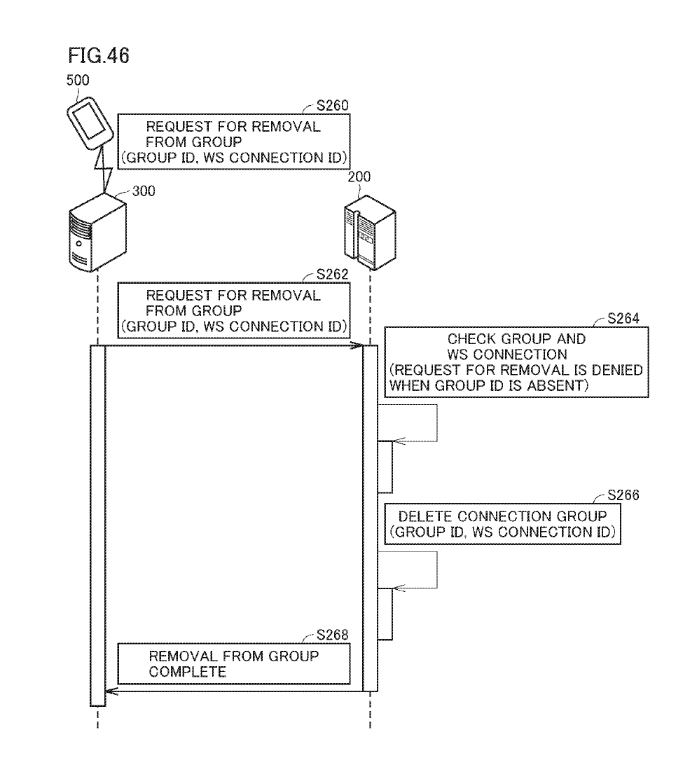

The following describes details of the procedures for removing a client from a group with the smartphone 500 or an external personal computer in the network system 1 according to the present embodiment. FIG. 46 is a sequence diagram representing details of the procedures for removing a client with the smartphone 500 or an external personal computer in the network system 1 according to the present embodiment.

Referring to FIG. 46, in response to a request from a user or an application program, the smartphone 500 or an external personal computer sends the application server 300 a client removing request for removing a client 100 from a group (step S260). The client removing request contains a group ID for specifying a group, and the connection ID of the client belonging to the group.

The application server 300 sends the client removing request to the constant connection server 200 (step S262). Specifically, the CPU 310 of the application server 300 sends the client removing request to the constant connection server 200 via the communication interface 360 over the HTTP protocol.

The CPU 210 of the constant connection server 200 determines whether the group ID contained in the received client removing request is contained in the association DB 222 (step S264). The CPU 210 denies the request for removal from group when the received group ID is not contained in the association DB 222.

When the received group ID is contained in the association DB 222, the CPU 210 of the constant connection server 200 deletes the combination of the group ID and the connection ID of the client belonging to the group from the association DB 221, as shown in FIG. 42 (step S266). The constant connection server 200 sends the application server 300 data indicative of the completion of the removal of the client 100 from group (step S268).

<Details of Procedures for Sending Data from Client to Group>

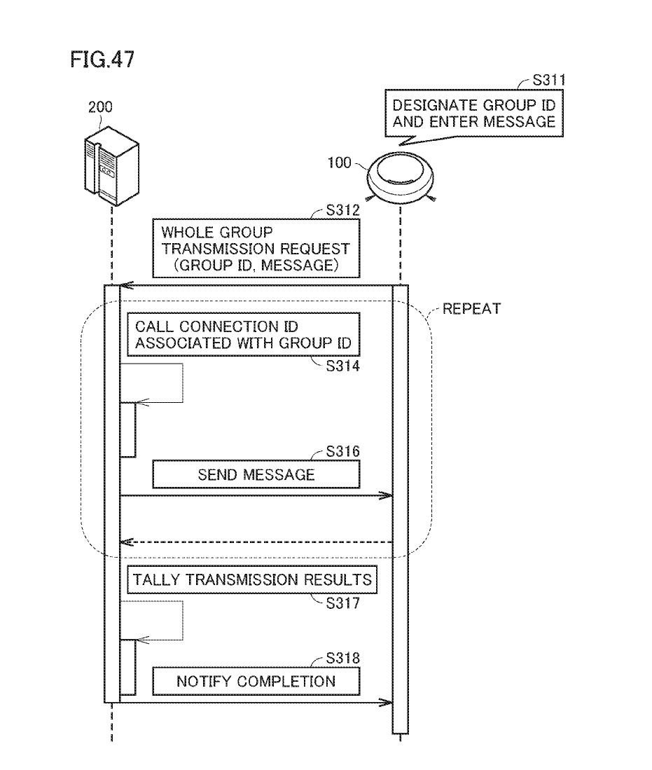

The following describes details of the procedures for sending data from a client 100 to a group in the network system 1 according to the present embodiment. FIG. 47 is a sequence diagram representing details of the procedures for sending data from a client 100 to a group in the network system 1 according to the present embodiment.

Referring to FIG. 47, the client 100 accepts a message from a user (step S311). Specifically, the CPU 110 accepts entry of a message and the designation of a group ID from a user via the input/output unit 130 (step S311). The CPU 110 sends a whole group transmission request to the constant connection server 200 via the communication interface 160 over the WebSocket protocol (step S312). The whole group transmission request contains a group ID and the message.

Aside from accepting a message from a user, for example, the CPU 110 may send a whole group transmission request to the constant connection server 200 at a predetermined time point. Alternatively, the CPU 110 may send a whole group transmission request to the constant connection server 200 in response to a sensor input.

The CPU 110 of the client 100 may send the whole group transmission request to the constant connection server 200 via the communication interface 160 over the HTTP protocol. In this case, the whole group transmission request preferably also contains a connection ID for specifying the client 100.

By referring to the association DB 222, the CPU 210 of the constant connection server 200 sequentially reads out the connection ID associated with the designated group ID (step S314), and sends the message to a client 100 of the same group ID (may or may not be the sender client 100) via the communication interface 260 over the WebSocket protocol (step S316). The CPU 210 repeats the transmission process of steps S314 and S316 for all the clients 100 associated with the group ID.

The CPU 210 tallies the transmission results upon finishing the data transmission process of steps S314 and S316 for all the clients 100 associated with the group ID (step S317). The CPU 210 sends the tally transmission result to the sending client 100 via the communication interface 260 over the WebSocket protocol (step S318).

The transmission result contains information concerning whether the client 100 has successfully received the data. The tally transmission result contains a transmission result list and/or a communication success rate (=the number of clients 100 that successfully received data/the number of clients belonging to the group). In the present embodiment, the constant connection server 200 accumulates the transmission results or the tally transmission result in the memory 220. The storage location of the transmission results or the tally transmission result is not limited to the memory 220 of the constant connection server 200, and the constant connection server 200 may store the transmission results or the tally transmission result in other database (for example, association DB250) or in an external storage such as NAS (Network Attached Storage). This enables the application server 300, the clients 100, and other external devices to refer to the transmission results.

<Details of Procedures for Sending Data from Application Server to Group>

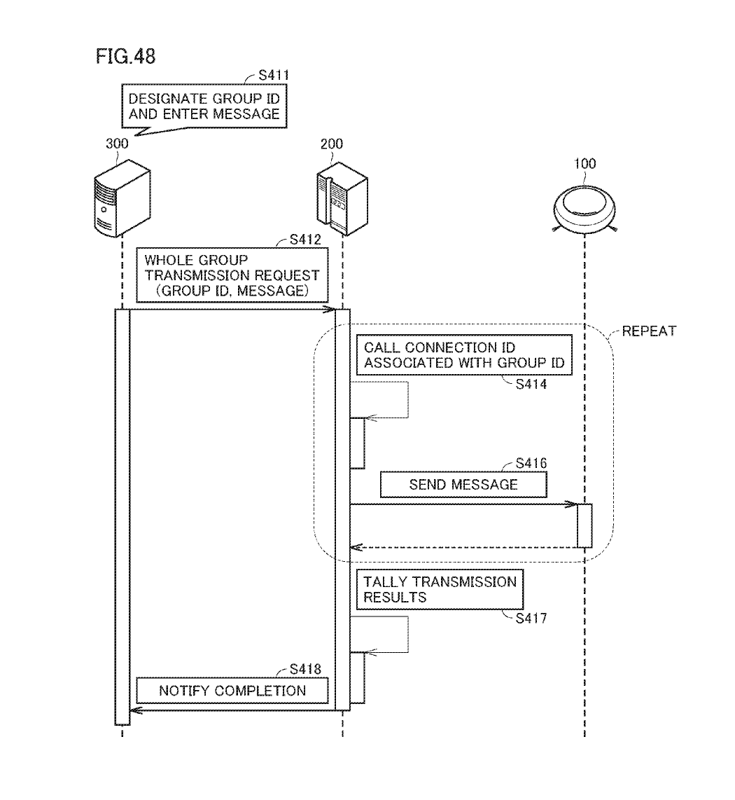

The following describes details of the procedures for sending data from the application server 300 to a group in the network system 1 according to the present embodiment. FIG. 48 is a sequence diagram representing details of the procedures for sending data from the application server 300 to a group in the network system 1 according to the present embodiment.

Referring to FIG. 48, the application server 300 accepts a message from, for example, an administrator, an application program of the application server 300 itself, the smartphone 500, or an external personal computer (step S411). In this example, the CPU 310 accepts a message from an administrator via the input/output unit 330. The CPU 310 sends a whole group transmission request to the constant connection server 200 via the communication interface 360 over the HTTP protocol (step S412). The whole group transmission request contains a group ID and the message.

By referring to the association DB 222, the CPU 210 of the constant connection server 200 sequentially reads out the connection ID associated with the group ID (step S414). The CPU 210 sends the message to the client 100 via the communication interface 260 over the WebSocket protocol (step S416). The CPU 210 repeats the transmission process of steps S414 and S416 for all the clients 100 associated with the group ID.

The CPU 210 tallies the transmission results upon finishing the data transmission process of steps S414 and S416 for all the clients 100 associated with the group ID (step S417). The CPU 210 sends the tally transmission result to the application server 300 via the communication interface 260 over the HTTP protocol (step S418).

The transmission result contains information concerning whether the client 100 has successfully received the data. The tally transmission result contains a transmission result list and/or a communication success rate (=the number of clients 100 that successfully received data/the number of clients belonging to the group). In the present embodiment, the constant connection server 200 accumulates the transmission results or the tally transmission result in the memory 220. The storage location of the transmission results or the tally transmission result is not limited to the memory 220 of the constant connection server 200, and the constant connection server 200 may store the transmission results or the tally transmission result in other database (for example, association DB250) or in an external storage such as NAS (Network Attached Storage). This enables the application server 300, the clients 100, and other external devices to refer to the transmission results.

### Tenth Embodiment

The sending of data from a sending client 100 to a group in Ninth Embodiment involves sending the transmission result from the constant connection server 200 to the sending client 100 after the data has been sent to all the receiving clients 100 belonging to the group. However, in the present embodiment, the constant connection server 200 sends the transmission result to the sending client 100 every time data is sent to the receiving client 100.

The present embodiment has the same configuration as Ninth Embodiment, except for the operation of FIG. 47. Accordingly, the same configuration will not be described.

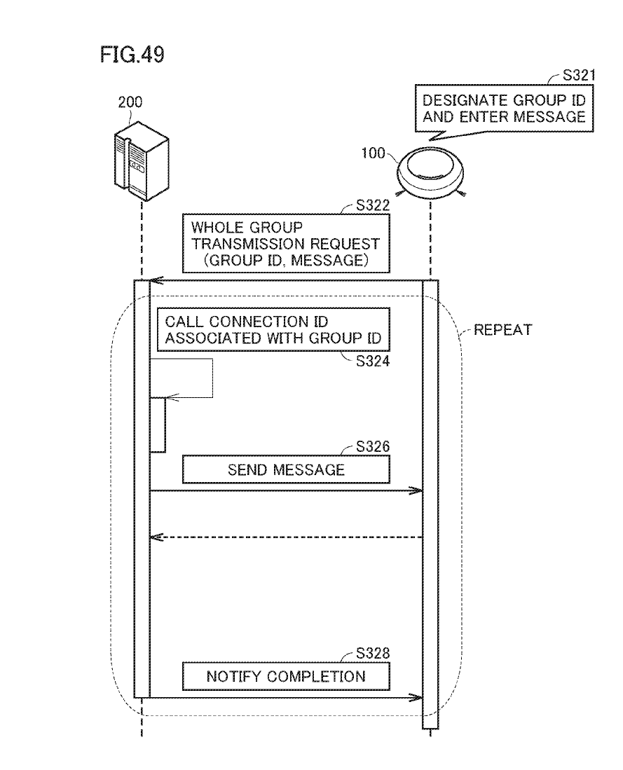

The following describes details of the procedures for sending data from a client 100 to a group in the network system 1 according to the present embodiment. FIG. 49 is a sequence diagram representing details of the procedures for sending data from a client 100 to a group in the network system 1 according to the present embodiment.

Referring to FIG. 49, the client 100 accepts a message from a user (step S321). Specifically, the CPU 110 accepts entry of a user message via the input/output unit 130 (step S321). The CPU 110 sends a whole group transmission request to the constant connection server 200 via the communication interface 160 over the WebSocket protocol (step S322). The whole group transmission request contains a group ID and the message.

By referring to the association DB 222, the CPU 210 of the constant connection server 200 sequentially reads out the connection ID associated with the group ID (step S324). The CPU 210 sends the message to the client 100 via the communication interface 260 over the WebSocket protocol (step S326). The CPU 210 notifies the sending client 100 of the transmission result via the communication interface 260 over the WebSocket protocol (step S328). In the present embodiment, the constant connection server 200 accumulates the transmission results or the tally transmission result in the memory 220. However, the storage location of the transmission results or the tally transmission result is not limited to the memory 220 of the constant connection server 200, and the constant connection server 200 may store the transmission results or the tally transmission result in other database (for example, association DB250) or in an external storage such as NAS (Network Attached Storage). This enables the application server 300, the clients 100, and other external devices to refer to the transmission results.

The CPU 210 repeats the transmission process and the transmission result notification process of steps S324, S326, and S328 for all the clients 100 associated with the group ID.

### Eleventh Embodiment

The sending of data from a sending client 100 to a group in Ninth Embodiment involves sending the transmission result from the constant connection server 200 to the sending client 100 after the data has been sent to all the receiving clients 100 belonging to the group. However, in the present embodiment, the constant connection server 200, in response to a whole group transmission request from the sending client 100, notifies the sending client 100 of the receipt of the request, and sends the transmission result to the sending client 100 after the data has been sent to all the receiving clients 100 belonging to the group.

The present embodiment has the same configuration as Ninth Embodiment, except for the operation of FIG. 47. Accordingly, the same configuration will not be described.

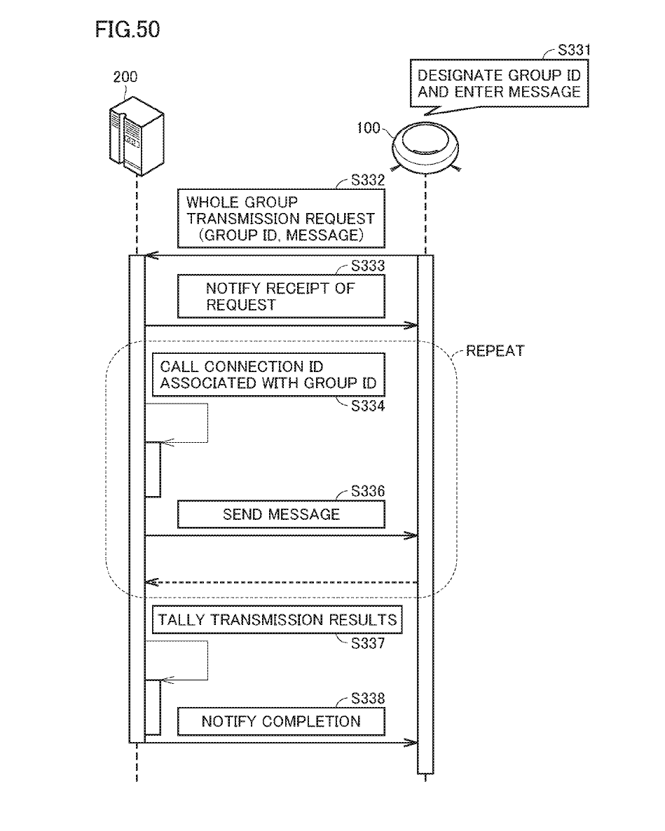

The following describes details of the procedures for sending data from a client 100 to a group in the network system 1 according to the present embodiment. FIG. 50 is a sequence diagram representing details of the procedures for sending data from a client 100 to a group in the network system 1 according to the present embodiment.

Referring to FIG. 50, the client 100 accepts a message from a user (step S331). Specifically, the CPU 110 accepts entry of a user message via the input/output unit 130. The CPU 110 sends a whole group transmission request to the constant connection server 200 via the communication interface 160 over the WebSocket protocol (step S332). The whole group transmission request contains a group ID and the message.

The CPU 210 of the constant connection server 200 notifies the sending client 100 of the receipt of the whole group transmission request via the communication interface 260 over the WebSocket protocol (step S333).

By referring to the association DB 222, the CPU 210 of the constant connection server 200 sequentially reads out the connection ID associated with the group ID (step S334). The CPU 210 sends the message to the client 100 via the communication interface 260 over the WebSocket protocol (step S336). The CPU 210 repeats the transmission process of steps S334 and S336 for all the clients 100 associated with the group ID.

The CPU 210 tallies the transmission results upon finishing the data transmission process of steps S334 and S336 for all the clients 100 associated with the group ID (step S337). The CPU 210 sends the tally transmission result to the sending client 100 via the communication interface 260 over the WebSocket protocol (step S338).

The transmission result contains information concerning whether the client 100 has successfully received the data. The tally transmission result contains a transmission result list and/or a communication success rate (=the number of clients 100 that successfully received data/the number of clients belonging to the group). In the present embodiment, the constant connection server 200 accumulates the transmission results or the tally transmission result in the memory 220. The storage location of the transmission results or the tally transmission result is not limited to the memory 220 of the constant connection server 200, and the constant connection server 200 may store the transmission results or the tally transmission result in other database (for example, association DB250) or in an external storage such as NAS (Network Attached Storage). This enables the application server 300, the clients 100, and other external devices to refer to the transmission results.

### Twelfth Embodiment

The sending of data from a sending client 100 to a group in Ninth Embodiment involves sending the transmission result from the constant connection server 200 to the sending client 100 after the data has been sent to all the receiving clients 100 belonging to the group. However, in the present embodiment, the constant connection server 200, in response to a whole group transmission request from the sending client 100, notifies the sending client 100 of the receipt of the request, and sends the transmission result to the sending client 100 every time data is sent to the receiving client 100.

The present embodiment has the same configuration as Ninth Embodiment, except for the operation of FIG. 47. Accordingly, the same configuration will not be described.

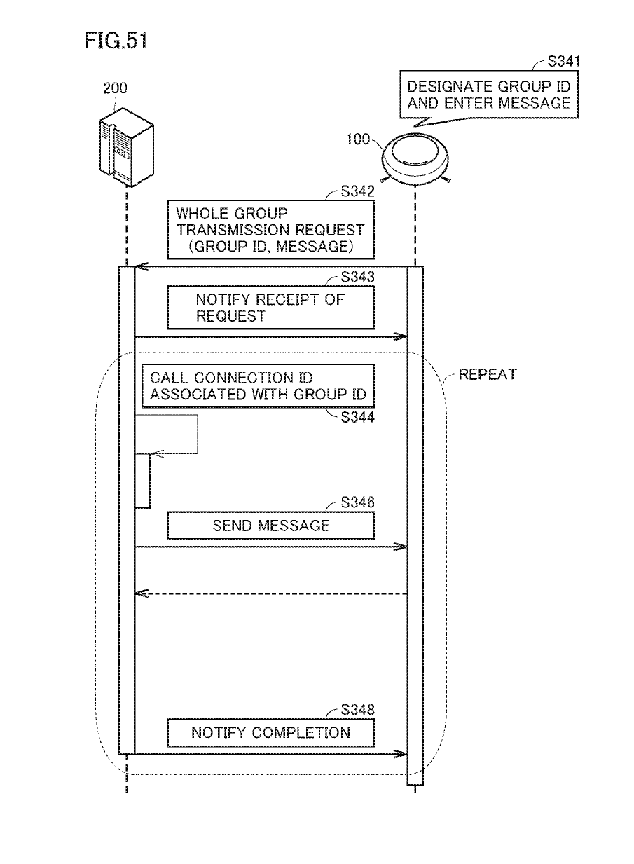

The following describes details of the procedures for sending data from a client 100 to a group in the network system 1 according to the present embodiment. FIG. 51 is a sequence diagram representing details of the procedures for sending data from a client 100 to a group in the network system 1 according to the present embodiment.

Referring to FIG. 51, the client 100 accepts a message from a user (step S341). Specifically, the CPU 110 accepts entry of a user message via the input/output unit 130. The CPU 110 sends a whole group transmission request to the constant connection server 200 via the communication interface 160 over the WebSocket protocol (step S342). The whole group transmission request contains a group ID and the message.

The CPU 210 of the constant connection server 200 notifies the sending client 100 of the receipt of the whole group transmission request via the communication interface 260 over the WebSocket protocol (step S343).

By referring to the association DB 222, the CPU 210 of the constant connection server 200 sequentially reads out the connection ID associated with the group ID (step S344). The CPU 210 sends the message to the client 100 via the communication interface 260 over the WebSocket protocol (step S346). The CPU 210 sends the transmission result to the client 100 via the communication interface 260 over the WebSocket protocol (step S348). In the present embodiment, the constant connection server 200 accumulates the transmission results or the tally transmission result in the memory 220. The storage location of the transmission results or the tally transmission result is not limited to the memory 220 of the constant connection server 200, and the constant connection server 200 may store the transmission results or the tally transmission result in other database (for example, association DB250) or in an external storage such as NAS (Network Attached Storage). This enables the application server 300, the clients 100, and other external devices to refer to the transmission results.

The CPU 210 repeats the transmission process and the transmission result notification process of steps S344, S346, and S348 for all the clients 100 associated with the group ID.

### Thirteenth Embodiment

The sending of data from the application server 300 to a group in Ninth Embodiment involves sending the transmission result from the constant connection server 200 to the application server 300 after the data has been sent to all the receiving clients 100 belonging to the group. However, in the present embodiment, the constant connection server 200 sends the transmission result to the application server 300 every time data is sent to the receiving client 100.

The present embodiment has the same configuration as Ninth Embodiment, except for the operation of FIG. 48. Accordingly, the same configuration will not be described.

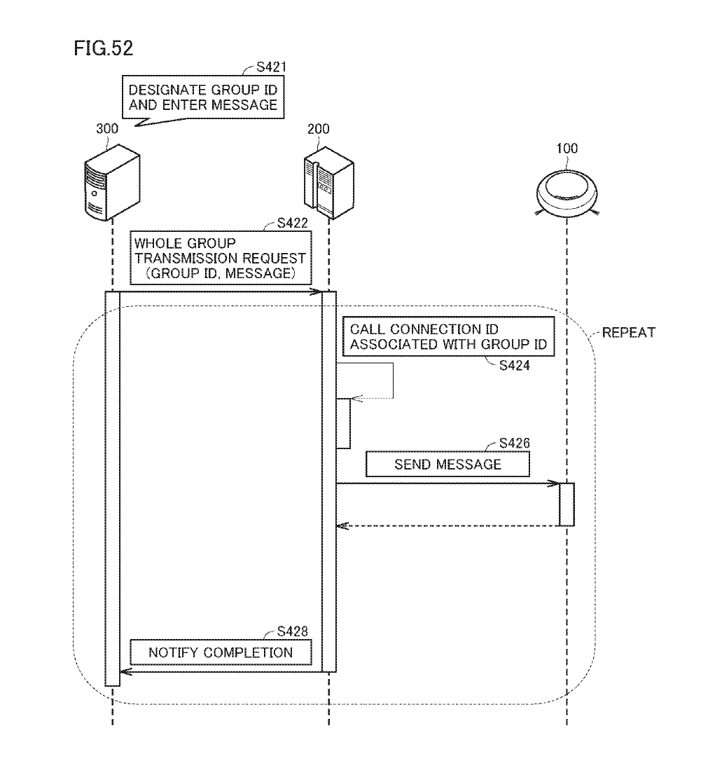

The following describes details of the procedures for sending data from the application server 300 to a group in the network system 1 according to the present embodiment. FIG. 52 is a sequence diagram representing details of the procedures for sending data from the application server 300 to a group in the network system 1 according to the present embodiment.

Referring to FIG. 52, the application server 300 accepts a message from, for example, an administrator, an application program of the application server 300 itself, the smartphone 500, or an external personal computer (step S421). In this example, the CPU 310 accepts a message from an administrator via the input/output unit 330. The CPU 310 sends a whole group transmission request to the constant connection server 200 via the communication interface 360 over the HTTP protocol (step S422). The whole group transmission request contains a group ID and the message.

By referring to the association DB 222, the CPU 210 of the constant connection server 200 sequentially reads out the connection ID associated with the group ID (step S424). The CPU 210 sends the message to the client 100 via the communication interface 260 over the WebSocket protocol (step S426). The CPU 210 sends the transmission result to the application server 300 via the communication interface 260 over the HTTP protocol (step S428). In the present embodiment, the constant connection server 200 accumulates the transmission results or the tally transmission result in the memory 220. The storage location of the transmission results or the tally transmission result is not limited to the memory 220 of the constant connection server 200, and the constant connection server 200 may store the transmission results or the tally transmission result in other database (for example, association DB250) or in an external storage such as NAS (Network Attached Storage). This enables the application server 300, the clients 100, and other external devices to refer to the transmission results.

The CPU 210 repeats the transmission process and the transmission result notification process of steps S424, S426, and S428 for all the clients 100 associated with the group ID.

### Fourteenth Embodiment

The sending of data from a sending application server 300 to a group in Ninth Embodiment involves sending the transmission result from the constant connection server 200 to the sending application server 300 after the data has been sent to all the receiving clients 100 belonging to the group. However, in the present embodiment, the constant connection server 200, in response to a whole group transmission request from the application server 300, notifies the application server 300 of the receipt of the request, and sends the transmission result to the sending application server 300 after the data has been sent to all the receiving clients 100 belonging to the group.

The present embodiment has the same configuration as Ninth Embodiment, except for the operation of FIG. 48. Accordingly, the same configuration will not be described.

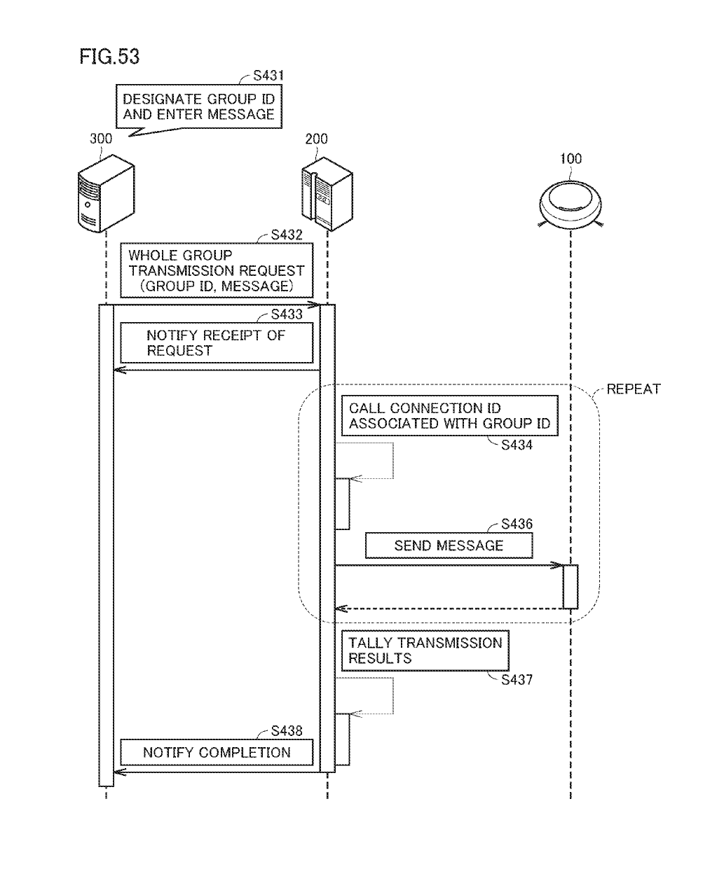

The following describes details of the procedures for sending data from the application server 300 to a group in the network system 1 according to the present embodiment. FIG. 53 is a sequence diagram representing details of the procedures for sending data from the application server 300 to a group in the network system 1 according to the present embodiment.

Referring to FIG. 53, the application server 300 accepts a message from, for example, an administrator, an application program of the application server 300 itself, the smartphone 500, or an external personal computer (step S431). In this example, the CPU 310 accepts a message from an administrator via the input/output unit 330. The CPU 310 sends a whole group transmission request to the constant connection server 200 via the communication interface 360 over the HTTP protocol (step S432). The whole group transmission request contains a group ID and the message.

The CPU 210 of the constant connection server 200 notifies the sending application server 300 of the receipt of the whole group transmission request via the communication interface 260 over the HTTP protocol (step S433).

By referring to the association DB 222, the CPU 210 of the constant connection server 200 sequentially reads out the connection ID associated with the group ID (step S434). The CPU 210 sends the message to the client 100 via the communication interface 260 over the WebSocket protocol (step S436). The CPU 210 repeats the transmission process of steps S434 and S436 for all the clients 100 associated with the group ID.

The CPU 210 tallies the transmission results upon finishing the data transmission process of steps S434 and S436 for all the clients 100 associated with the group ID (step S437). The CPU 210 sends the tally transmission result to the sending application server 300 via the communication interface 260 over the HTTP protocol (step S438).

The transmission result contains information concerning whether the client 100 has successfully received the data. The tally transmission result contains a transmission result list and/or a communication success rate (=the number of clients 100 that successfully received data/the number of clients belonging to the group). In the present embodiment, the constant connection server 200 accumulates the transmission results or the tally transmission result in the memory 220. The storage location of the transmission results or the tally transmission result is not limited to the memory 220 of the constant connection server 200, and the constant connection server 200 may store the transmission results or the tally transmission result in other database (for example, association DB250) or in an external storage such as NAS (Network Attached Storage). This enables the application server 300, the clients 100, and other external devices to refer to the transmission results.

### Fifteenth Embodiment

The sending of data from the application server 300 to a group in Ninth Embodiment involves sending the transmission result from the constant connection server 200 to the application server 300 after the data has been sent to all the receiving clients 100 belonging to the group. However, in the present embodiment, the constant connection server 200, in response to a whole group transmission request from the application server 300, notifies the application server 300 of the receipt of the request, and sends the transmission result to the application server 300 every time data is sent to the receiving client 100.

The present embodiment has the same configuration as Ninth Embodiment, except for the operation of FIG. 48. Accordingly, the same configuration will not be described.

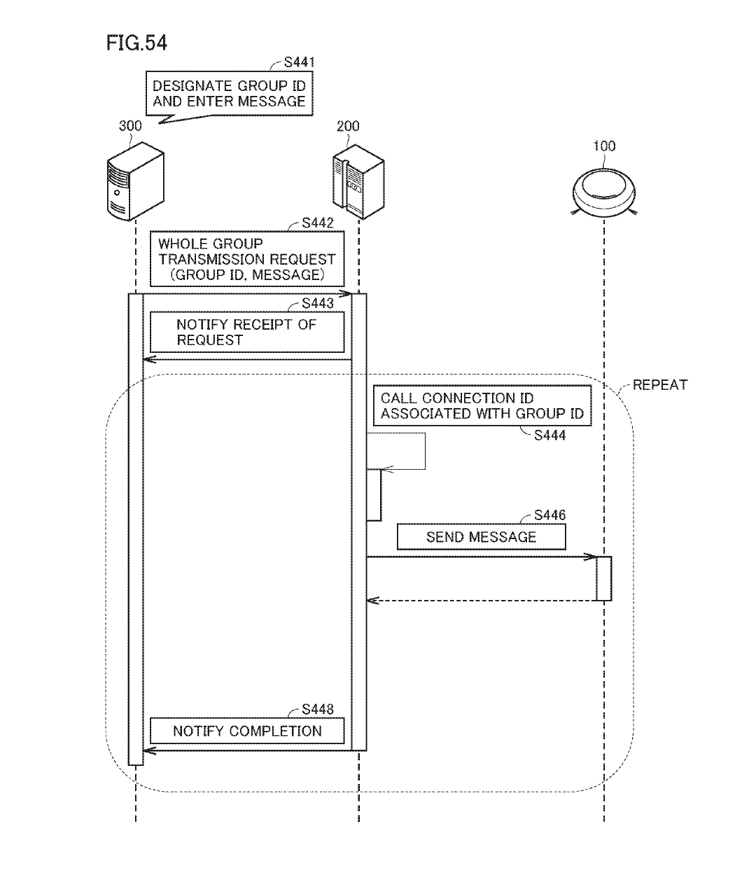

The following describes details of the procedures for sending data from the application server 300 to a group in the network system 1 according to the present embodiment. FIG. 54 is a sequence diagram representing details of the procedures for sending data from the application server 300 to a group in the network system 1 according to the present embodiment.

Referring to FIG. 54, the application server 300 accepts a message from, for example, an administrator, an application program of the application server 300 itself, the smartphone 500, or an external personal computer (step S441). In this example, the CPU 310 accepts a message from an administrator via the input/output unit 330. The CPU 310 sends a whole group transmission request to the constant connection server 200 via the communication interface 360 over the HTTP protocol (step S442). The whole group transmission request contains a group ID and the message.

The CPU 210 of the constant connection server 200 notifies the sending application server 300 of the receipt of the whole group transmission request via the communication interface 260 over the HTTP protocol (step S443).

By referring to the association DB 222, the CPU 210 of the constant connection server 200 sequentially reads out the connection ID associated with the group ID (step S444). The CPU 210 sends the message to the client 100 via the communication interface 260 over the WebSocket protocol (step S446). The CPU 210 sends the transmission result to the application server 300 via the communication interface 260 over the HTTP protocol (step S448). In the present embodiment, the constant connection server 200 accumulates the transmission results or the tally transmission result in the memory 220. The storage location of the transmission results or the tally transmission result is not limited to the memory 220 of the constant connection server 200, and the constant connection server 200 may store the transmission results or the tally transmission result in other database (for example, association DB250) or in an external storage such as NAS (Network Attached Storage). This enables the application server 300, the clients 100, and other external devices to refer to the transmission results.

The CPU 210 repeats the transmission process and the transmission result notification process of steps S444, S446, and S448 for all the clients 100 associated with the group ID.

### Sixteenth Embodiment

The following describes an embodiment in which data is sent to only the home appliances of specific model numbers.

### <Overall Configuration of Network System>

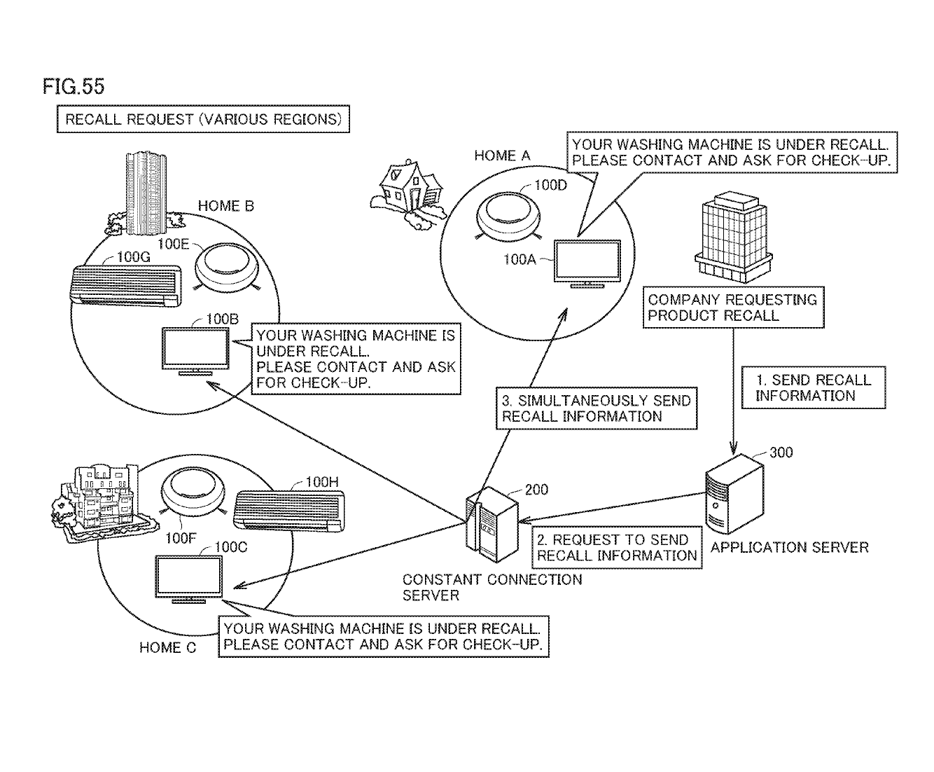

The overall configuration of the network system 1 according to the present embodiment is described below. FIG. 55 is a schematic diagram representing the overall configuration and operation of the network system 1 according to the present embodiment.

Referring to FIG. 55, the network system 1 includes televisions 100A, 100B, and 100C, vacuum cleaners 100D, 100E, and 100F, and air conditioners 1000 and 100H provided in places such as homes and offices. In the following, the clients 100A to 100H will also be collectively called “clients 100”. The network system 1 also includes a constant connection server 200 that can constantly connect to the clients 100, and an application server 300 for providing various services.

Examples of the clients 100 include home appliances such as vacuum cleaners, televisions, air conditioners, washing machines, refrigerators, rice cookers, air purifiers, floor heating systems, IH cooking heaters, microwave ovens, and illuminations. The clients may be any communications devices, including, for example, personal computers, audio-video equipment other than television, and an intercom system.

The constant connection server 200 and the application server 300 may include servers that reside in the same home, office, building, company, or school where any of the clients are provided.

In the present embodiment, the constant connection server 200 and the application server 300 are different computers. However, the constant connection server and the application server may be the same computer. For example, a single computer, specifically a server in the form of a device may contain a communications service program for constantly connecting to the clients, and an application service program for controlling the clients. A single application server may contain a plurality of application service programs.

### <Brief Overview of Network System Operation>

The following is a brief overview of the operation of the network system 1 according to the present embodiment. In the present embodiment, the clients 100 are divided into groups byproduct and/or model number. Specifically, data indicative of the grouping are stored in an association DB server connectable to the constant connection server 200, or in the constant connection server 200 itself. The application server 300 provides services on which data from devices such as the smartphone 500 and external personal computers are delivered to the clients 100.

The smartphone 500, an external personal computer, or other such device sends the application server 300 a group ID for specifying a product or a model number, and a message to be sent to the group. The application server 300 sends the constant connection server 200 the group ID for specifying a group, and the message to be sent to the group. The constant connection server 200 pushes main data to a plurality of clients 100 associated with the group ID. For example, the constant connection server 200 sends a message concerning recall information only to the televisions 100A, 100B, and 100C from among the clients 100 that are in a constant connection.

In this manner, in the present embodiment, the smartphone 500, an external personal computer, the application server 300, and the client 100 can send data only to the desired products or to the home appliances of the desired model numbers from among the clients 100 that are in a constant connection with the constant connection server 200. The following describes the association DB, and the operation of the CPU 210 of the constant connection server 200 for realizing such functions. The other configuration and operation of the network system 1 according to the present embodiment are as described in Ninth Embodiment, and will not be described further.

### <Association DB>

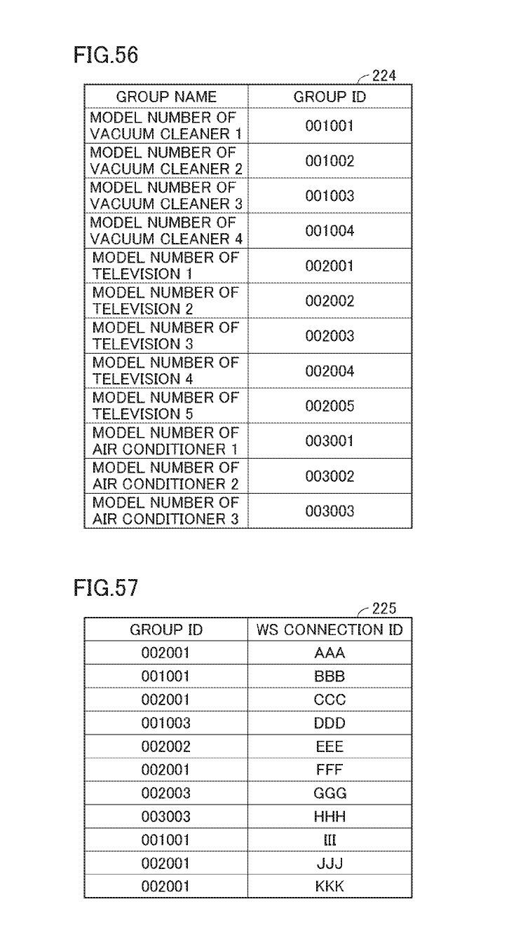

In the present embodiment, the association DB server 250 separately provided from the constant connection server 200 stores an association DB 224 of group names and group IDs, as shown in FIG. 56. The association DB 224 may be stored in the memory 220 of the constant connection server 200.

As shown in FIG. 57, the association DB server 250 separately provided from the constant connection server 200 stores an association DB 225 of group IDs and connection IDs. The connection IDs are information for specifying the relationship between the clients 100 and the services provided by the application server 300. The association DB 225 may be stored in the memory 220 of the constant connection server 200.

Though not shown in the figure, the association DB may contain an association DB as a hierarchy of groups. For example, the association DB may store group IDs of products in an upper level, and group IDs of model numbers in a middle level. In this case, the association DB stores the group IDs of a plurality of model numbers in association with the group ID of each product.

<Details of Procedures for Sending Data from Application Server to Group>

The following describes details of the procedures for sending data from the application server 300 to a group in the network system 1 according to the present embodiment, with reference to FIG. 48.

The application server 300 accepts recall information from, for example, a product maker (step S411). Specifically, the CPU 310 accepts a group ID indicative of a product name or a model number, and a message via the input/output unit 330. The CPU 310 sends a whole group transmission request to the constant connection server 200 via the communication interface 360 over the HTTP protocol (step S412). In this example, the whole group transmission request contains the group ID “002001” for specifying the model number 1 of a television, and the message “Your television is under recall. Please contact for check-up”.

By referring to the association DB225, the CPU 210 of the constant connection server 200 sequentially reads out the connection ID “CCC” associated with the group ID “002001” (step S414). The CPU 210 sends the message to the television 100A having the connection ID “CCC”, via the communication interface 260 over the WebSocket protocol (step S416; see FIG. 55). The CPU 210 repeats the transmission process of steps S414 and S416 for the televisions 100B and 100C having the connection IDs “FFF” and “JJJ” associated with the group ID “002001” (see FIG. 55).

The CPU 210 tallies the transmission results upon finishing the data transmission process of steps S414 and S416 for all the clients 100 associated with the group ID (step S417). The CPU 210 sends the tally transmission result to the sending application server 300 via the communication interface 260 over the HTTP protocol (step S418).

The transmission result contains information concerning whether the client 100 has successfully received the data. The tally transmission result contains a transmission result list and/or a communication success rate (=the number of clients 100 that successfully received data/the number of clients belonging to the group). In the present embodiment, the constant connection server 200 accumulates the transmission results or the tally transmission result in the memory 220. The storage location of the transmission results or the tally transmission result is not limited to the memory 220 of the constant connection server 200, and the constant connection server 200 may store the transmission results or the tally transmission result in other database (for example, association DB250) or in an external storage such as NAS (Network Attached Storage). This enables the application server 300, the clients 100, and other external devices to refer to the transmission results.

### Seventeenth Embodiment

The following describes an embodiment in which data is sent to only the home appliances that are on certain floors of an apartment.

### <Overall Configuration of Network System>

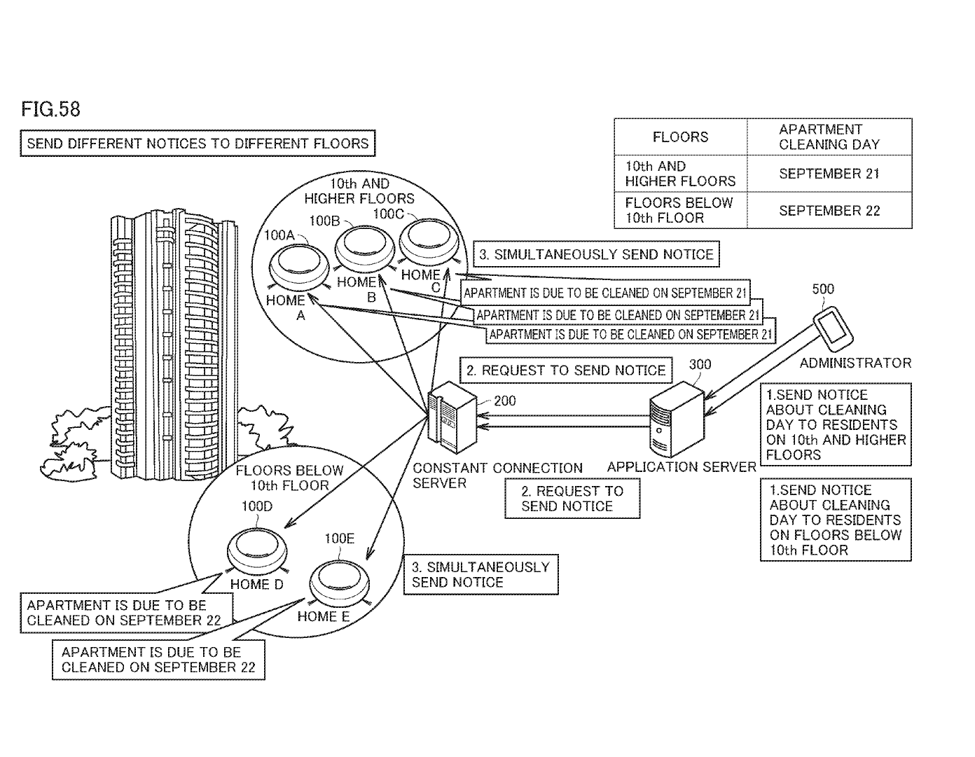

The overall configuration of the network system 1 according to the present embodiment is described below. FIG. 58 is a schematic diagram representing the overall configuration and operation of the network system 1 according to the present embodiment.

Referring to FIG. 58, the network system 1 includes vacuum cleaners 100A to 100E provided in places such as homes and offices. In the following, the clients 100A to 100E will also be collectively called “clients 100”. The network system 1 also includes a constant connection server 200 that can constantly connect to the clients 100, an application server 300 for providing various services, and a smartphone 500 or a personal computer, among others.

Examples of the clients 100 include home appliances such as vacuum cleaners, televisions, air conditioners, washing machines, refrigerators, rice cookers, air purifiers, floor heating systems, IH cooking heaters, microwave ovens, and illuminations. The clients may be any communications devices, including, for example, personal computers, audio-video equipment other than television, and an intercom system.

The constant connection server 200 and the application server 300 may include servers that reside in the same home, office, building, company, or school where any of the clients are provided.

In the present embodiment, the constant connection server 200 and the application server 300 are different computers. However, the constant connection server and the application server may be the same computer. For example, a single computer, specifically a server in the form of a device may contain a communications service program for constantly connecting to the clients, and an application service program for controlling the clients. A single application server may contain a plurality of application service programs.

### <Brief Overview of Network System Operation>

The following is a brief overview of the operation in the network system 1 according to the present embodiment. In this embodiment, a plurality of clients 100 is divided into groups that represent country and region, and these are further divided into smaller subgroups in a hierarchy, from city, apartment to floor. Specifically, data indicative of the grouping are stored in an association DB server connectable to the constant connection server 200, or in the constant connection server 200 itself. The application server 300 provides services on which data from devices such as the smartphone 500 and external personal computers are pushed to the clients 100.

The smartphone 500, an external personal computer, or other such device sends the application server 300 a group ID for specifying floors of an apartment, and a message to be sent to the group. The application server 300 sends the constant connection server 200 the group ID for specifying a group, and the message to be sent to the group. The constant connection server 200 pushes main data to a plurality of clients 100 associated with the group ID. For example, the constant connection server 200 sends the message “Apartment is due to be cleaned on September 21” only to the home appliances that are on the 10th and higher floors from among the clients 100 that are in a constant connection, and the message “Apartment is due to be cleaned on September 22” only to the home appliances that are on the floors below the 10th floor.

In this manner, in the present embodiment, the smartphone 500, an external personal computer, the application server 300, and the client 100 can send data only to the home appliances that are in the rooms of the desired floors from among the clients 100 that are in a constant connection with the constant connection server 200. The following describes the association DB, and the operation of the CPU 210 of the constant connection server 200 for realizing such functions. The other configuration of the network system 1 according to the present embodiment is as described in Ninth Embodiment, and will not be described further.

### <Association DB>

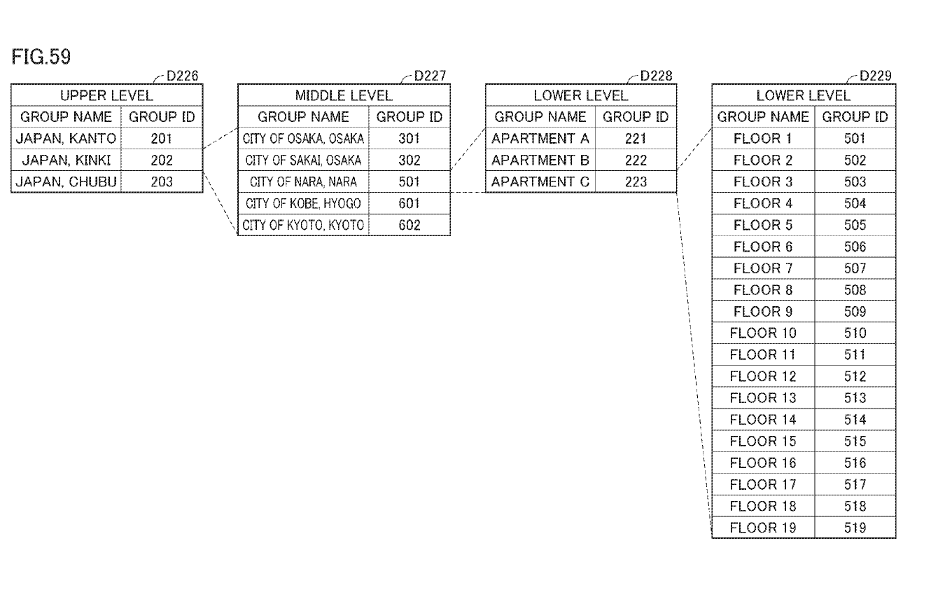

In the present embodiment, as shown in FIG. 59, the association DB server 250 separately provided from the constant connection server 200 stores an association DB226 of group names and group IDs in an upper level, an association DB227 of group names and group IDs in a middle level, and an association DB228 of group names and group IDs in a lower level. Further down the hierarchy, the association DB server 250 stores an association DB229 of group names and group IDs. The association DB 226, 227, 228, and 229 may be stored in the memory 220 of the constant connection server 200.

<Details of Procedures for Sending Data from Application Server to Group>

The following describes details of the procedures for sending data from the application server 300 to a group in the network system 1 according to the present embodiment, with reference to FIG. 48.

The application server 300 accepts a group ID and a message from the smartphone 500 or personal computer of an administrator (step S411). Specifically, from the smartphone 500 of the administrator, the CPU 310 receives via the communication interface 360 a group ID for specifying the Kinki region of Japan, a group ID for specifying the city of Nara in Nara prefecture, a group ID for specifying apartment C, and group IDs for specifying 10th to 19th floors, together with a message.

The CPU 310 sends a whole group transmission request to the constant connection server 200 via the communication interface 360 over the HTTP protocol (step S412). In this example, the whole group transmission request contains the group IDs and the message. The group IDs are “202501223510” to “202501223519” combining the upper-level group ID “202”, the middle-level group ID “501”, the lower-level group ID “223”, and the lower-level group IDs “510” to “519”. The message is the text “Apartment is due to be cleaned on September 21”.

By referring to the association DB, the CPU 210 of the constant connection server 200 sequentially reads out the connection ID associated with the group IDs “202501223510” to “202501223519” (step S414). The CPU 210 sends the message to the vacuum cleaner 100A having the connection ID, via the communication interface 260 over the WebSocket protocol (step S416; see FIG. 58). The CPU 210 repeats the transmission process of steps S414 and S416 for the vacuum cleaners 100B and 100C having the connection IDs associated with the group IDs (see FIG. 58).

The CPU 210 tallies the transmission results upon finishing the data transmission process of steps S414 and S416 for all the clients 100 associated with the group IDs (step S417). The CPU 210 sends the tally transmission result to the sending application server 300 via the communication interface 260 over the HTTP protocol (step S418).

The transmission result contains information concerning whether the client 100 has successfully received the data. The tally transmission result contains a transmission result list and/or a communication success rate (=the number of clients 100 that successfully received data/the number of clients belonging to the group). In the present embodiment, the constant connection server 200 accumulates the transmission results or the tally transmission result in the memory 220. The storage location of the transmission results or the tally transmission result is not limited to the memory 220 of the constant connection server 200, and the constant connection server 200 may store the transmission results or the tally transmission result in other database (for example, association DB250) or in an external storage such as NAS (Network Attached Storage). This enables the application server 300, the clients 100, and other external devices to refer to the transmission results.

### Eighteenth Embodiment

The following describes an embodiment in which data is sent to only the home appliances that are in certain areas.

### <Overall Configuration of Network System>

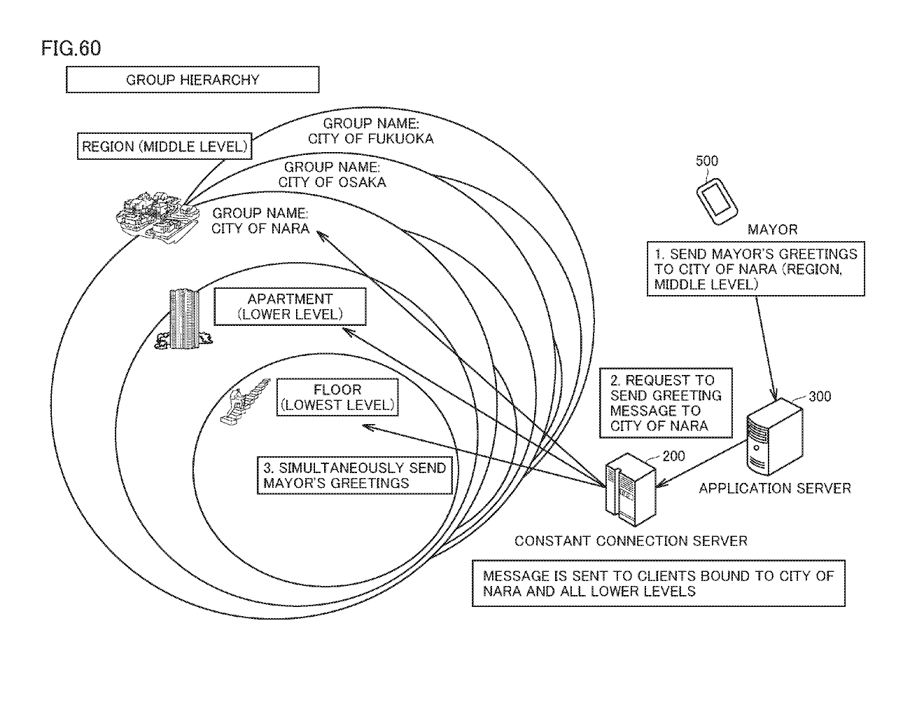

The overall configuration of the network system 1 according to the present embodiment is described below. FIG. 60 is a schematic diagram representing the overall configuration and operation of the network system 1 according to the present embodiment.

Referring to FIG. 60, the network system 1 includes a plurality of clients 100 provided in places such as homes and offices. The network system 1 also includes a constant connection server 200 that can constantly connect to the clients 100, an application server 300 for providing various services, and a smartphone 500 or a personal computer, among others.

Examples of the clients 100 include home appliances such as vacuum cleaners, televisions, air conditioners, washing machines, refrigerators, rice cookers, air purifiers, floor heating systems, IH cooking heaters, microwave ovens, and illuminations. The clients may be any communications devices, including, for example, personal computers, audio-video equipment other than television, and an intercom system.

The constant connection server 200 and the application server 300 may include servers that reside in the same home, office, building, company, or school where any of the clients are provided.

In the present embodiment, the constant connection server 200 and the application server 300 are different computers. However, the constant connection server and the application server may be the same computer. For example, a single computer, specifically a server in the form of a device may contain a communications service program for constantly connecting to the clients, and an application service program for controlling the clients. A single application server may contain a plurality of application service programs.

### <Brief Overview of Network System Operation>

The following is a brief overview of the operation in the network system 1 according to the present embodiment. In this embodiment, a plurality of clients 100 is divided into groups that represent country and region, and these are further divided into smaller subgroups in a hierarchy, from city, apartment to floor. Specifically, data indicative of the grouping are stored in an association DB server connectable to the constant connection server 200, or in the constant connection server 200 itself. The application server 300 provides services on which data from devices such as the smartphone 500 and external personal computers are pushed to the clients 100.

The smartphone 500, an external personal computer, or other such device sends the application server 300 group IDs for specifying, for example, cities, apartments, and floors, and a message to be sent to these groups. The application server 300 sends the constant connection server 200 the group IDs for specifying groups, and the message to be sent to the groups. The constant connection server 200 pushes main data to a plurality of clients 100 associated with the group IDs. For example, the constant connection server 200 sends greetings from mayor only to the home appliances that are in certain areas from among the clients 100 that are in a constant connection.

In this manner, in the present embodiment, the smartphone 500, an external personal computer, the application server 300, and the client 100 can send data only to the home appliances that are in the desired areas from among the clients 100 that are in a constant connection with the constant connection server 200. The following describes the operation of the CPU 210 of the constant connection server 200 for realizing such functions. The other configuration of the network system 1 according to the present embodiment is as described in Ninth Embodiment, and will not be described further. The association DB is the same as that described in Seventeenth Embodiment, and will not be described again.

<Details of Sending Data from Application Server to Group>

The following describes details of the procedures for sending data from the application server 300 to a group in the network system 1 according to the present embodiment.

Referring to FIG. 48, the application server 300 accepts group IDs and a message from the smartphone 500 or personal computer of mayor (step S411). Specifically, the CPU 310 receives the group ID “202” for specifying the Kinki region of Japan, and the group ID “501” for specifying the city of Nara in Nara prefecture, via the communication interface 360. The smartphone 500 or personal computer of mayor may merge the two group IDs, and send a single group ID, “202501”, for specifying the city of Nara in Nara prefecture in the Kinki region of Japan to the application server 300, together with the message.

The CPU 310 sends a whole group transmission request to the constant connection server 200 via the communication interface 360 over the HTTP protocol (step S412). In this example, the whole group transmission request contains the group IDs, and greetings for the people. The group IDs may be the upper-level group ID “202” and the middle-level group ID “501” contained as separate data, or may represent a single group ID, “202501”, combining the upper-level group ID “202” and the middle-level group ID “501”. In this way, the transmission covers all the clients 100 belonging to the groups lower down “202501”.

By referring to the association DB, the CPU 210 of the constant connection server 200 sequentially reads out the connection ID associated with the group ID “202501” (step S414). The CPU 210 sends the message to the client 100 having the connection ID, via the communication interface 260 over the WebSocket protocol (step S416; see FIG. 58). The CPU 210 repeats the transmission process of steps S414 and S416 for the clients 100 having the connection IDs associated with the group ID (see FIG. 58).

The CPU 210 tallies the transmission results upon finishing the data transmission process of steps S414 and S416 for all the clients 100 associated with the group ID (step S417). The CPU 210 sends the tally transmission result to the sending application server 300 via the communication interface 260 over the HTTP protocol (step S418).

The transmission result contains information concerning whether the client 100 has successfully received the data. The tally transmission result contains a transmission result list and/or a communication success rate (=the number of clients 100 that successfully received data/the number of clients belonging to the group). In the present embodiment, the constant connection server 200 accumulates the transmission results or the tally transmission result in the memory 220. The storage location of the transmission results or the tally transmission result is not limited to the memory 220 of the constant connection server 200, and the constant connection server 200 may store the transmission results or the tally transmission result in other database (for example, association DB250) or in an external storage such as NAS (Network Attached Storage). This enables the application server 300, the clients 100, and other external devices to refer to the transmission results.

### Nineteenth Embodiment

In the foregoing embodiments, the constant connection server 200 accumulates the transmission results and the tally transmission result as a reference accessible from external devices such as the application server 300, the client 100, and the smartphone 500.

However, other than the transmission results, the constant connection server 200 may also accumulate the whole group transmission request (data push instruction) from devices such as the application server 300 and the client 100 so that the whole group transmission request can be referred to from external devices such as the application server 300, the client 100, and the smartphone 500.

### Examples of Other Applications

As is evident, the present invention also can be achieved by supplying a program to a system or a device. The advantages of the present invention also can be obtained with a computer (or a CPU or an MPU) in a system or a device upon the computer reading and executing the program code stored in the supplied storage medium (or memory) storing software programs intended to realize the present invention.

In this case, the program code itself read from the storage medium realizes the functions of the embodiments above, and the storage medium storing the program code constitutes the present invention.

Evidently, the functions of the embodiments above can be realized not only by a computer reading and executing such program code, but by some or all of the actual processes performed by the OS (operating system) or the like running on a computer under the instructions of the program code.

The functions of the embodiments above also can be realized by some or all of the actual processes performed by the CPU or the like of an expansion board or expansion unit under the instructions of the program code read from a storage medium and written into other storage medium provided in the expansion board inserted into a computer or the expansion unit connected to a computer.

While the invention has been described in detail, it is to be understood that the foregoing descriptions are provided solely for illustrative purposes and are not intended to limit the invention in any ways. It will be clearly understood that the scope of the invention should be construed as defined in the appended claims.

What is claimed is:

1. A network system comprising:
a plurality of electronic devices that becomes associated with identification information;
a constant connection server that makes a constant connection with the plurality of electronic devices; and
an application server that pushes information to any of the plurality of electronic devices via the constant connection server on the basis of the identification information.

2. The network system according to claim 1,
wherein the constant connection server is installed in a first computer, and
wherein the application server is installed in a second computer.

3. The network system according to claim 1, wherein the constant connection server and the application server are installed in one computer.

4. The network system according to claim 1, wherein each of the plurality of electronic devices and the constant connection server upon opening a constant connection exchange the identification information by using a protocol that permits a constant connection.

5. The network system according to claim 1,
wherein the application server issues authentication information to any of the plurality of electronic devices and to the constant connection server, and
wherein the constant connection server issues the identification information to the application server and to said any of the plurality of electronic devices on the basis of the authentication information from the application server and the authentication information from said any of the plurality of electronic devices.

6. The network system according to claim 1,
wherein the application server is provided as a plurality of application servers, and
wherein each of the plurality of application servers pushes information to any of the plurality of electronic devices via the constant connection server by using the identification information.

7. The network system according to claim 1,
wherein the constant connection server sends main data and a transaction ID to any of the plurality of electronic devices,
wherein said any of the plurality of electronic devices sends the transaction ID to the constant connection server upon receiving the main data; and
wherein the constant connection server notifies the application server of the completion of the data transmission to said any of the plurality of electronic devices on the basis of the transaction ID from said any of the plurality of electronic devices.

8. The network system according to claim 1,
wherein any of the plurality of electronic devices sends main data and a transaction ID to the constant connection server,
wherein the constant connection server sends the transaction ID to said any of the plurality of electronic devices upon receiving the main data, and
wherein the constant connection server notifies the application server of the completion of the data reception from said any of the plurality of electronic devices on the basis of the transaction ID from said any of the plurality of electronic devices.

9. A constant connection method comprising:
opening a constant connection between a plurality of electronic devices and a constant connection server;
associating the plurality of electronic devices with identification information; and
pushing information from an application server to any of the plurality of electronic devices via the constant connection server on the basis of the identification information.

10. An electronic device comprising:
a memory that stores identification information;
a communication interface provided to constantly connect to a constant connection server; and
a processor that, by using the communication interface, receives information from an application server via the constant connection server on the basis of the identification information.

11. A constant connection server comprising:
a memory that stores identification information associated with a plurality of electronic devices;
a communication interface provided to constantly connect to the plurality of electronic devices and communicate with an application server; and
a processor that, by using the communication interface, pushes information from the application server to any of the plurality of electronic devices on the basis of the identification information.

12. An application server comprising:
a memory that stores identification information associated with a plurality of electronic devices;
a communication interface provided to communicate with a constant connection server; and
a processor that, by using the communication interface, pushes information to any of the plurality of electronic devices via the constant connection server on the basis of the identification information.

13. A network system comprising:
a plurality of electronic devices; and
a constant connection server that makes a constant connection with the plurality of electronic devices,
wherein the constant connection server stores an association between constant connection IDs for specifying the plurality of electronic devices and group IDs for specifying a plurality of groups, and pushes data to at least one of the electronic devices belonging to a group associated with a group ID being designated.

14. The network system according to claim 13,
wherein the association includes the groups in a hierarchy, and
wherein the constant connection server pushes data to the electronic devices belonging to a lower group that belongs to an upper group specified by a group ID being designated.

15. The network system according to claim 13,
wherein any of the plurality of electronic devices sends a group joining request to the constant connection server, and
wherein the constant connection server in response to the group joining request adds to the association a combination of the group ID and the constant connection ID associated with said any of the plurality of electronic devices.

16. The network system according to claim 13, further comprising an electronic device different from the plurality of electronic devices,
wherein the electronic device sends information for specifying the electronic device, and a group joining request to the constant connection server, and
wherein the constant connection server in response to the information and the group joining request adds to the association a combination of the group ID and the constant connection ID associated with the electronic device.

17. The network system according to claim 13,
wherein any of the plurality of electronic devices sends a request for removal from group to the constant connection server, and
wherein the constant connection server in response to the request for removal from group deletes from the association a combination of the group ID and the constant connection ID associated with said any of the plurality of electronic devices.

18. The network system according to claim 13, further comprising an electronic device different from the plurality of electronic devices,
wherein the electronic device sends information for specifying the electronic device, and a request for removal from group to the constant connection server, and
wherein the constant connection server in response to the information and the request for removal from group deletes from the association a combination of the group ID and the constant connection ID associated with the electronic device.

19. The network system according to claim 13,
wherein any of the plurality of electronic devices sends the group ID and the data to the constant connection server, and
wherein the constant connection server pushes the data to at least one of the plurality of electronic devices associated with the group ID.

20. The network system according to claim 13, further comprising an application server,
wherein the application server sends the group ID and the data to the constant connection server, and
wherein the constant connection server pushes the data to at least one of the plurality of electronic devices associated with the group ID.

21. The network system according to claim 19, wherein the constant connection server upon receiving the group ID and the data notifies the sender of the data of the receipt of a push instruction before pushing the data to said at least one of the plurality of electronic devices.

22. The network system according to claim 19, wherein the constant connection server sends a transmission result of the data to the sender of the data after pushing the data to all of at least one of the plurality of electronic devices associated with the group ID.

23. The network system according to claim 22, wherein the transmission result contains a list representing the success or failure of the pushing of the data with regard to all of at least one of the plurality of electronic devices associated with the group ID.

24. The network system according to claim 22, wherein the transmission result contains a success rate of the pushing of the data to at least one of the plurality of electronic devices associated with the group ID.

25. The network system according to claim 19, wherein the constant connection server sends a transmission result of the data to the sender of the data every time the data is pushed to each of at least one of the plurality of electronic devices associated with the group ID.

26. The network system according to claim 22, wherein the constant connection server accumulates the transmission result as an externally accessible reference.

27. The network system according to claim 13, wherein the constant connection server upon receiving a data push instruction accumulates the instruction as an externally accessible reference.

28. A communication method comprising:
opening a constant connection between a plurality of electronic devices and a constant connection server;
storing an association between constant connection IDs for specifying the plurality of electronic devices and group IDs for specifying a plurality of groups in the constant connection server; and
pushing data from the constant connection server to at least one of the plurality of electronic devices belonging to a group associated with a group ID being designated.

29. An electronic device comprising:
a communication interface; and
a processor that makes a constant connection with the constant connection server, and sends a group joining request to the constant connection server with the communication interface.

30. A constant connection server comprising:
a communication interface provided to constantly connect to a plurality of electronic devices;
a memory that stores an association between constant connection IDs for specifying the plurality of electronic devices and group IDs for specifying a plurality of groups; and
a processor that, by using the communication interface, pushes data to at least one of the plurality of electronic devices belonging to a group associated with a group ID being designated.
